(19) United States
(12) Patent Application Publication
(10) Pub. No.: US 2026/0330508 A1
(43) Pub. Date: Oct. 22, 2026

(54) HYBRID AI-DRIVEN ADVERTISING & SPONSORSHIP SYSTEM WITH REAL-TIME DECISIONING AND ENFORCEMENT ARCHITECTURE

(71) Applicant: PETER MELI, BOCA RATON, FL (US)

(72) Inventor: PETER MELI, BOCA RATON, FL (US)

(21) Appl. No.: 19/404,365

(22) Filed: Dec. 1, 2025

Related U.S. Application Data
(60) Provisional application No. 63/792,381, filed on Apr. 22, 2025.
(60) Provisional application No. 63/818,574, filed on Jun. 5, 2025.

(51) Int. Cl. G06Q 30/0251; G06Q 30/0207; G06Q 30/0241

(52) U.S. Cl. CPC G06Q 30/0271; G06Q 30/0225; G06Q 30/0277; G06Q 2220/00

(57) ABSTRACT

A behavioral qualification middleware system for digital advertising is disclosed. A middleware interception layer operates between demand-side platforms and programmatic advertising exchanges and evaluates transactions prior to budget commitment. A computation engine aggregates behavioral and contextual signals and applies weighted scoring algorithms to compute a unified metric using linear or nonlinear transformations. Qualification enforcement is performed by an enforcement proxy that applies thresholds to block, authorize, or modulate requests before bid submission, and generates cryptographically while generating verifiable audit records. Post-activation engagement signals are collected by a closed-loop reconciliation system that computes Qualified Attribution Scores to validate predicted outcomes and produce learning signals. A Unity Framework coordinates subsystem behavior by updating scoring parameters and routing learning signals back to the computation engine. The system operates without cookies or personally identifiable information and supports multi-tenant isolation, providing privacy-compliant pre-spend waste prevention through unified scoring, mandatory enforcement, and continuous optimization.

### CROSS-REFERENCE TO RELATED APPLICATIONS AND PRIORITY CLAIMS

This application claims the benefit of U.S. Provisional Patent Application No. 63/792,381, filed Apr. 22, 2025, titled, “Avatar-Driven Advertising & Sponsorship System”, and U.S. Provisional Patent Application No. 63/818,574, filed Jun. 5, 2025, titled, “System and Method for Closed-Loop Behavioral Qualification and Activation Verification of Digital Media Campaigns”, the entire disclosures of the aforementioned patent applications are herein incorporated by reference as if fully stated herein.

### TECHNICAL FIELD

The present invention relates to digital advertising platforms, real-time decisioning systems, and pre-spend enforcement architectures that improve computational efficiency of real-time transaction processing. More specifically, it concerns a unified Behavioral Qualification Score (BQS) driven advertising and sponsorship system that employs hybrid artificial intelligence (AI) routing between large language models (LLMs) and small language models (SLMs) to optimize advertisement delivery, personalization, conflict avoidance, and enforcement across immersive computing environments and multi-tenant platforms, while maintaining privacy-compliant, cookie-free, and PII-free operation.

The invention implements a revolutionary BQS Unity Framework that transforms multiple independent system variables into a single, unified BQS metric that orchestrates all platform decisions, enabling pre-spend qualification and enforcement mechanisms that prevent advertising waste before budget commitment occurs. This BQS-driven architecture improves computer functionality by enabling sub-100 ms qualification decisions through a single metric evaluation rather than complex multi-variable coordination, eliminating redundant transaction processing that characterizes conventional post-spend detection systems.

The system further provides closed-loop verification through signature-based reconciliation that validates BQS-based pre-spend decisions against actual engagement outcomes, continuously refining the BQS computation algorithms without manual intervention. The BQS metric serves as the singular coordination mechanism across all subsystems—from fraud detection to loyalty programs to content personalization. These core technical features—BQS unification, pre-spend enforcement, and closed-loop verification enable multiple coordinated subsystems to collectively ensure waste prevention rather than detection across the digital advertising ecosystem while maintaining compliance with GDPR, CCPA, and emerging privacy regulations.

### BACKGROUND OF THE INVENTION

Digital advertising platforms face increasing complexity in balancing real-time performance requirements with sophisticated content analysis and personalization needs. Current digital advertising platforms suffer from fundamental architectural limitations:

### Post-Spend Detection Architecture (IAS, DoubleVerify, HUMAN)

These platforms function primarily as measurement vendors that provide fraud detection or quality signals after advertising spend has already occurred.
IAS achieves only 60-70% fraud detection rates, with 2-5% false positive rates under typical conditions.
Double Verify offers pre-bid segments, but these are advisory in nature and do not enforce blocking at the transaction layer.
HUMAN (formerly White Ops) emphasizes bot detection but cannot enforce spend prevention at the pre-auction stage.

### Cookie-Dependent Systems (Google DV360, The Trade Desk)

Architecturally reliant on third-party cookies, which are subject to deprecation in 2024.
Inability to maintain frequency capping or attribution continuity without persistent identifiers.
Attribution mechanisms break down without cross-site tracking.
No deployed alternative compliant with privacy regulations has been demonstrated by these systems.

### Fragmented Optimization (Adobe Advertising Cloud, Amazon DSP)

Fraud detection, personalization, and optimization modules operate independently and sequentially, not as an integrated framework.
Local optimizations often degrade global campaign performance.
No known prior art employs a unified scoring mechanism that coordinates all subsystems through a single metric to guarantee convergence toward global efficiency.

### PRESENT INVENTION DISTINCTION

Aspects of embodiments of the present invention overcome these deficiencies through the following technical features:
Mandatory pre-spend enforcement through BQS gating: Requests failing Behavioral Qualification Score (BQS) thresholds are blocked prior to auction entry, with the BQS serving as the single unified metric governing all enforcement decisions.
Ephemeral behavioral fingerprints: Session-based identifiers rotate every 300 seconds, eliminating persistent tracking, cookies, or device IDs while maintaining BQS computation accuracy.
BQS Unity Framework: The revolutionary replacement of multi-variable coordination with a single BQS metric that orchestrates all subsystem behaviors—from fraud detection (BQS anomaly patterns trigger enhanced scrutiny) to personalization (BQS values determine content selection) to enforcement (BQS thresholds gate bid submission)—ensuring all components work in concert through unified scoring rather than isolated optimization.
Integrated sub-200 ms processing: Fraud detection, personalization, qualification, and enforcement are executed within a BQS-unified architecture that guarantees sub-200 ms end-to-end latency, with the single BQS computation eliminating the overhead of coordinating multiple independent scoring systems.

In immersive environments such as virtual reality sports platforms, augmented reality applications, and interactive gaming platforms, users are represented by avatars that carry rich metadata including equipped gear, brand preferences, team affiliations, and loyalty status. Traditional advertising personalization systems fail to leverage this avatar-specific data effectively, missing opportunities for highly relevant sponsorship placements. The present invention addresses this by incorporating avatar metadata directly into BQS computation, enabling avatar-aware qualification scoring.

Furthermore, existing advertising platforms lack sophisticated conflict avoidance mechanisms that can automatically enforce sponsor exclusivity agreements and prevent competing brands from appearing simultaneously. Manual configuration approaches are error-prone and cannot scale to handle dynamic, real-time advertising decisions. The present invention solves this through BQS-weighted conflict resolution, where higher BQS entities receive priority in exclusivity disputes.

Multi-tenant advertising platforms face additional challenges in maintaining data isolation while providing customizable AI pipelines for different client organizations. Current solutions either require separate deployments per tenant (costly and inefficient) or use overly generalized systems that cannot accommodate tenant-specific business logic. The present invention enables per-tenant BQS calibration while maintaining a unified scoring framework, allowing customization without architectural fragmentation.

Most critically, existing systems lack comprehensive enforcement mechanisms that can prevent advertising waste before it occurs. Traditional approaches focus on post-campaign measurement and optimization, allowing fraudulent or low-quality traffic to consume advertising budgets before detection. Current systems do not provide a unified qualification metric that can gate spend, verify outcomes, and continuously optimize based on closed-loop feedback. The BQS serves as this unified metric, enabling pre-spend prevention through a single score evaluation rather than complex multi-system coordination.

The digital advertising industry faces an unprecedented privacy crisis as cookies and device identifiers become obsolete through regulatory pressure (GDPR, CCPA, CPRA) and platform deprecation (Chrome's cookie phase-out, Apple's App Tracking Transparency). Despite this fundamental shift, existing advertising systems remain architecturally dependent on persistent identifiers for targeting, frequency capping, attribution, and fraud detection. Current privacy-preserving solutions either sacrifice functionality (contextual-only targeting), rely on probabilistic methods with high error rates (fingerprinting), or require industry-wide adoption of new standards (unified IDs) that face regulatory scrutiny. No existing system provides comprehensive advertising capabilities—including personalization, loyalty scoring, fraud prevention, and attribution—while operating entirely without cookies, device IDs, or personally identifiable information. The present invention achieves this through BQS-based qualification that derives from ephemeral behavioral signals rather than persistent identifiers, maintaining full functionality while ensuring privacy compliance.

Additionally, current advertising systems operate as collections of independent modules that lack unified coordination and integrated optimization. Existing platforms employ siloed components where fraud detection operates independently from bid optimization, personalization runs separately from enforcement, and loyalty scoring functions in isolation from content selection. This architectural fragmentation prevents holistic optimization because improvements in one subsystem cannot automatically propagate to enhance others. Prior art systems lack a unifying metric that couples subsystem behaviors through a single score, resulting in local optimizations that may degrade overall system performance. For example, aggressive fraud blocking might inadvertently suppress high-value loyal users, or personalization improvements might increase computational latency beyond acceptable thresholds.

The present invention's BQS Unity Framework solves this fundamental limitation by replacing independent scoring systems with a single BQS metric that flows through and coordinates all subsystems. When the BQS computation algorithm improves, every subsystem—from fraud detection to content selection to bid optimization-automatically benefits from the enhancement. This unified scoring mechanism ensures that all optimizations align toward the common goal of waste prevention, eliminating the conflicts that arise when subsystems optimize independently. Without this BQS unification that ensures subsystems work through a single metric rather than in isolation, current platforms cannot achieve the convergent optimization necessary for eliminating the $279.5 billion in annual advertising waste.

There exists a need for an integrated advertising and sponsorship system that can: (1) intelligently route tasks between heavy and lightweight AI models based on BQS-determined complexity to achieve sub-100 ms, and in certain embodiments sub-50 ms, qualification decisions; (2) leverage avatar and user profile data for BQS computation without sacrificing privacy; (3) enforce sponsor exclusivity rules automatically through BQS-weighted priority resolution; (4) support multi-tenant architectures with cryptographically isolated pipelines while maintaining unified BQS scoring; (5) implement real-time pre-spend qualification through BQS gating with closed-loop verification to prevent waste before it occurs; (6) operate entirely without cookies, device IDs, or personally identifiable information while computing accurate BQS values from ephemeral signals; and (7) coordinate all subsystems through the unified BQS metric that ensures convergent optimization toward waste prevention rather than isolated improvements that may conflict with overall objectives.

### SUMMARY OF INVENTION

The present invention provides a comprehensive BQS-unified advertising and sponsorship system that addresses the limitations of conventional approaches through an integrated platform architecture where all subsystems operate through a single Behavioral Qualification Score (BQS) metric to deliver optimized, contextually relevant advertising content while maintaining operational efficiency, compliance, and waste prevention.

At its core, aspects of embodiments of the present invention features a Hybrid LLM/SLM Decisioning System that dynamically routes advertising decision tasks between large language models and small language models based on BQS-determined complexity thresholds. High-BQS requests requiring sophisticated analysis leverage LLM capabilities, while routine low-BQS requests utilize fast SLMs to meet sub-second response requirements, with the BQS serving as the routing determinant.

The system, according to aspects of embodiments of the present invention, incorporates an Avatar/User-Driven Personalization Engine that leverages rich user avatar data including virtual attire, equipment brands, team affiliations, and loyalty status to compute enhanced BQS values. These avatar-informed BQS scores drive highly targeted advertising content delivery, ensuring sponsored messages align with both virtual identity and behavioral qualification levels. Additional aspects of embodiments of the present invention contemplate the following:
A Loyalty-Based Bidding Engine dynamically adjusts sponsor bid values using BQS as the primary weighting factor, creating a marketplace where bid adjustments directly correlate with BQS values. The formula AdjustedBid=BaseBid×(1+LoyaltyMultiplier×BQS/100) demonstrates how the unified BQS metric controls economic optimization.
A sophisticated Conflict Avoidance and Exclusivity Logic that may use BQS-weighted priority resolution to automatically prevent competing sponsors from appearing simultaneously. Higher BQS entities receive preferential treatment in exclusivity disputes, ensuring valuable qualified traffic receives premium sponsor experiences.
A Real-Time Sponsorship Matching System analyzes BQS values alongside contextual factors to dynamically select the most relevant sponsor content for each opportunity. BQS thresholds determine eligibility for premium sponsorships, operating within sub-second timeframes to support live events.
The architecture supports Multi-Tenant Deployment with isolated data stores while maintaining a unified BQS computation framework. Each tenant can customize BQS weighting coefficients and thresholds while benefiting from the platform-wide BQS optimization engine.
IoT Integration capabilities enable the system to incorporate environmental sensor data into BQS calculations, adjusting qualification scores based on weather conditions, crowd density, and other contextual factors for digital out-of-home advertising applications.
Aspects of embodiments of the present invention introduce a comprehensive Enforcement Architecture centered on a BQS Unity Framework that transforms multiple system variables into a single unified metric:
Pre-Spend Qualification Engine: Computes Behavioral Qualification Scores in real-time as the single gating metric for media activation. The BQS incorporates user engagement depth, interaction frequency, conversion proximity, and fraud signals into one unified score that determines qualification status.
Enforcement Proxy: Integrates with demand-side platforms to provide real-time BQS-based gating, where only requests meeting BQS thresholds proceed to auction. The proxy modulates bids based on BQS strength, rewarding higher-quality traffic with enhanced bid values.
Signature-Based Reconciliation System: Enables closed-loop BQS verification by capturing post-activation engagement data and comparing against predicted BQS values. Discrepancies between predicted and actual outcomes feed back to refine BQS computation algorithms, creating continuous metric improvement.
Enterprise Token Service: Provides cryptographically secure authentication tokens that include BQS attestations, enabling downstream systems to verify qualification decisions with Ed25519 signatures.
Policy Compliance and Audit Systems: Ensures all BQS-based decisions are logged in immutable audit trails, demonstrating how the single metric drives compliance with platform terms, advertiser guidelines, and regulatory requirements.
Aspects of embodiments of the present invention contemplates a system which integrates a BQS Unity Coordination Framework that replaces complex multi-variable coordination with elegant single-metric orchestration. The BQS computation equation BQS=f(U, M, E, C)×Weighting Coefficients performs dimensional reduction where:
U represents user engagement (from personalization systems)
M represents model efficiency (from AI routing decisions)
E represents enforcement strictness (from qualification thresholds)
C represents content relevance (from sponsorship matching)

This unified BQS metric propagates through all 26 inventions, ensuring convergent optimization within 3 iterations while maintaining sub-200 ms response times. Aspects of embodiments of the present invention contemplates a system that ensures sub-200 ms end-to-end processing with BQS computation occurring in sub-100 ms, enabling the remaining pipeline operations while meeting programmatic RTB requirements. Certain embodiments achieve sub-50 ms for cached BQS lookups in time-critical scenarios.

Key technical innovations contemplated by aspects of embodiments of the present invention include:
BQS-based task routing between LLM and SLM models optimizing resource utilization
Avatar attribute integration into BQS computation for enhanced qualification accuracy
Dynamic bid adjustment directly proportional to BQS values
BQS-weighted conflict resolution ensuring qualified traffic receives premium experiences
Sub-second BQS matching with contextual awareness
Tenant-customizable BQS calibration within unified framework
IoT-enhanced BQS scoring incorporating environmental context
Pre-spend BQS gating preventing waste before budget commitment
Closed-loop BQS refinement through reconciliation feedback
Cryptographic BQS attestation for verifiable qualification decisions
Comprehensive BQS audit trails demonstrating prevention-based enforcement

The invention operates entirely without personally identifiable information, cookies, or device identifiers, computing BQS values from ephemeral behavioral signals while maintaining GDPR, CCPA/CPRA, PIPL, LGPD, and PIPEDA compliance.

Unlike existing verification vendors (IAS, DV, HUMAN) whose signals remain advisory, this system introduces mandatory BQS-based enforcement. The paradigm shift from reactive detection to proactive BQS-driven prevention addresses the industry's fundamental limitation of fragmented, uncoordinated subsystems. By unifying all components through the single BQS metric, the platform eliminates the $279.5 billion in annual advertising waste through prevention-based architecture where every subsystem optimization automatically enhances overall system performance rather than creating isolated improvements that may conflict with global objectives.

### Economic Impact Analysis; Quantified Economic Impact

Aspects of embodiments of the present invention address industry-reported large-scale digital advertising waste by providing BQS-based mechanisms configured to prevent spend leakage across principal categories commonly identified in industry analyses:

### Fraud:

Including bot traffic, click fraud, and attribution fraud
The invention is configured to prevent such fraud categories through BQS pre-qualification, where anomalous BQS patterns trigger blocking before bid submission, supported by mandatory pre-spend enforcement and cryptographic audit logging

### Invalid Traffic:

Including non-viewable impressions and below-fold or out-of-view placements
The invention is designed to mitigate invalid traffic by incorporating environmental signals into BQS computation, using IoT integration and real-time venue-based validation to adjust qualification scores

### Poor Targeting:

Including misdirected audience reach and untimely ad delivery
The invention is configured to prevent poor targeting through BQS-weighted bidding where higher scores indicate better audience match, combined with avatar-driven BQS enhancement and dynamic BQS thresholding

### Brand Safety Failures:

Including inappropriate adjacency and regulatory or contractual violations
The invention is designed to enforce brand safety through BQS-weighted conflict resolution, where higher BQS entities receive priority in exclusivity disputes, supported by compliance-driven BQS gating mechanisms

### Economic Impact and Industry Transformation

The present invention addresses widely documented inefficiencies in digital advertising where industry analyses indicate substantial portions of advertising spend fail to reach valid, viewable, brand-safe impressions. Various studies report different waste percentages across channels, with invalid traffic rates varying by platform type and measurement methodology. These channel-specific inefficiencies compound when combined with non-viewable impressions, brand-risk placements, and low-quality inventory categories.

Unlike existing verification solutions that detect and report waste after budget commitment, a fundamentally reactive approach with limited effectiveness, the present invention implements mandatory BQS-based pre-spend enforcement at the transaction layer. This paradigm shift from post-spend detection to pre-spend prevention is achieved through the BQS Unity Framework wherein the unified BQS metric incorporates engagement relevance, model routing efficiency, enforcement strictness, and content relevance into a single score that creates a self-optimizing system configured to block unqualified impressions before auction entry. By preventing waste through BQS gating rather than measuring it afterward, the invention is designed to address substantial portions of advertising spend lost to supply chain inefficiencies, invalid traffic, and non-viewable impressions.

The economic transformation enabled by this invention extends beyond waste reduction. By establishing cryptographically verifiable BQS-based qualification and closed-loop BQS verification, the system creates a trust infrastructure designed to support market-wide adoption of quality-first advertising practices. The architecture is configured to enable material waste reduction through pre-spend gating, representing potential recovery of substantial advertising value when deployed at scale. This positions the invention not merely as an incremental improvement but as foundational infrastructure for next-generation digital advertising systems.

Unlike prior art solutions that attempt to mitigate one category of waste in isolation, the present invention applies a unified BQS metric that links all subsystems through a single score. This ensures holistic convergence of fraud suppression, targeting optimization, loyalty scoring, and brand safety enforcement through BQS orchestration. As a result, the system provides simultaneous mitigation across all categories of waste under sub-200 millisecond real-time constraints with BQS computation occurring in sub-100 ms.

### Performance Impact

Strategic Industry Context and Performance Impact The digital advertising industry's persistent inability to solve the waste problem through existing approaches provides critical context for understanding the present invention's technical advantages. Despite significant industry efforts including TAG certification programs (which prevented an estimated $10.8 billion in fraud losses), MRC viewability standards, and deployment of verification vendors, the fundamental waste problem is widely reported, with some studies estimating large portions of spend failing to reach valid impressions.

The MFA Reduction Case Study Industry reports indicate partial success in reducing Made-for-Advertising (MFA) site exposure through post-campaign identification and blacklisting-a reactive approach requiring multiple cycles for improvement. In contrast, the present invention is configured to prevent MFA exposure pre-spend through real-time BQS evaluation, where low-quality MFA sites are designed to generate insufficient BQS values to pass qualification thresholds, enabling protection from first campaign deployment.

Why Existing Verification Vendors Have Not Solved the Problem Current verification solutions operate on a fundamentally flawed architecture: they measure quality after impressions are delivered and budgets are spent. Independent verification vendors primarily measure post-impression quality; pre-bid segments are frequently advisory rather than transaction-enforced and reported detection and false-positive characteristics vary by study, dataset, and period. These solutions share three critical limitations that the present invention overcomes:
Temporal Disconnect: Detection occurs after economic damage is complete
No Enforcement Capability: Findings are advisory, not mandatory
Open-Loop Architecture: No systematic feedback to improve future qualification

### Pre-Spend Enforcement: The Architectural Advantage

Aspects of embodiments of the present invention's BQS-based pre-spend enforcement is designed to operate before budget commitment through mandatory transaction-layer gating. This is achieved through:
Behavioral Qualification Score (BQS) Computation (sub-100 ms): Real-time evaluation configured to generate a unified score before bid submission
BQS Gateway Enforcement (sub-10 ms overhead): Designed to block requests failing BQS thresholds at the network layer
Cryptographic BQS Attestation: Ed25519-signed tokens proving BQS-based qualification
Closed-Loop BQS Verification: Post-engagement reconciliation designed to validate BQS predictions and refine computation algorithms

This architecture is configured to address documented waste categories proactively through BQS gating:
Supply chain inefficiencies: Addressed through BQS-based enforcement
Invalid traffic: Designed to be blocked by insufficient BQS values
Non-viewable impressions: Configured for prevention through BQS quality gating
Brand risk: Filtered through BQS policy thresholds
Low-quality inventory: Designed to be excluded through low BQS scores

The BQS-unified system architecture, according to aspects of embodiments of the present invention, is designed to enable:
Substantial reduction in invalid traffic reaching campaigns through BQS pre-qualification
Improved viewability for BQS-qualified impressions through quality gating
Reduced brand risk exposure through BQS threshold enforcement
Systematic blocking of low-quality inventory failing BQS thresholds

These architectural capabilities are configured to improve the proportion of advertising spend reaching valid impressions through mandatory pre-spend prevention rather than post-spend detection.

### Technical Effects and Industry Advantages

The present invention provides several unexpected technical effects that establish clear advantages over prior art and demonstrate satisfaction of patentability requirements:
Long-Felt Need The persistence of widely reported advertising waste despite decades of industry effort establishes a long-felt need for the present solution. Limited improvements in advertising efficiency over recent years, despite deployment of sophisticated verification vendors and industry standards, demonstrate that incremental approaches have reached their practical limits. Aspects of embodiments of the present invention address this long-standing problem through the fundamental architectural shift of BQS unification that prevents waste rather than detecting it.
Failure of Others The technical approaches of established verification vendors have demonstrably failed to solve the core problem:
Post-impression measurement cannot recover spent budgets
Advisory signals are routinely ignored under competitive pressure
Blacklist-based approaches require multiple cycles to achieve improvement
Cookie-dependent attribution is becoming technically obsolete

Aspects of embodiments of the present invention succeed where others have failed by implementing mandatory BQS-based enforcement at the transaction layer, making waste prevention non-optional through unified scoring rather than advisory.

Unexpected Results The BQS Unity Framework producing convergent optimization across all subsystems through a single metric represents an unexpected technical result. Prior art treated fraud detection, viewability measurement, and brand safety as independent problems requiring separate solutions. The invention's demonstration that these problems can be unified through a single BQS metric incorporating all quality dimensions, with unified BQS optimization designed to prevent more waste than the sum of individual optimizations, constitutes a non-obvious technical insight.

Commercial Success Indicators The potential for commercial success is evidenced by:
Total Addressable Market: A global digital advertising market on the order of ~$800B
Quantifiable Value Creation: Material portions of which various studies characterize as preventable waste
Industry Readiness: Recent regulatory pressure (GDPR, CCPA) and platform changes (cookie deprecation) create urgency for privacy-compliant BQS-based solutions
Network Effects: Each participant improving BQS accuracy for all others through closed-loop feedback

### TECHNICAL ADVANTAGES SUMMARY

Aspects of embodiments of the present invention present, at the very least, the following technical advantages:
BQS-based pre-spend prevention vs. post-spend detection (paradigm shift)
Mandatory BQS enforcement vs. advisory measurement (architectural advantage)
Closed-loop BQS optimization vs. open-loop reporting (continuous improvement)
BQS unification vs. siloed optimization (unified efficiency through single metric)
Privacy-compliant BQS computation vs. cookie-dependent tracking (regulatory alignment)
Sub-100 ms BQS scoring within sub-200 ms pipeline vs. batch analysis (RTB compatibility)
Cryptographic BQS verification vs. trust-based reporting (proof vs. claims
Cross-channel BQS consistency vs. channel-specific solutions (unified platform)

### BRIEF DESCRIPTIONS OF THE DRAWINGS

FIG. 1 illustrates a Hybrid LLM/SLM Decisioning System Architecture according to aspects of embodiments of the present invention.

FIG. 2 illustrates a User Entity-Driven Personalization System according to aspects of embodiments of the present invention.

FIG. 3 illustrates a Loyalty-Based Programmatic Bidding Engine Flow according to aspects of embodiments of the present invention.

FIG. 4 illustrates a Conflict Avoidance and Exclusivity Enforcement Engine according to aspects of embodiments of the present invention.

FIG. 5 illustrates a real-time sponsorship matching engine according to aspects of embodiments of the present invention.

FIG. 6 illustrates a IoT-integrated digital out-of-home (DOOH) system according to aspects of embodiments of the present invention.

FIG. 7 illustrates a Multi-Tenant AI Pipeline Architecture according to aspects of embodiments of the present invention.

FIG. 8 illustrates an Enhanced Fraud Detection and Audit System according to aspects of embodiments of the present invention.

FIG. 9 illustrates a Pre-Spend Behavioral Qualification Engine according to aspects of embodiments of the present invention.

FIG. 10 illustrates an Enforcement Proxy Architecture according to aspects of embodiments of the present invention.

FIG. 11 illustrates a Closed-Loop Reconciliation & Beacon Correlation System according to aspects of embodiments of the present invention.

FIG. 12 illustrates a BQS Unity Coordination Framework System according to aspects of embodiments of the present invention.

FIG. 13 illustrates an Enterprise Token Service Architecture according to aspects of embodiments of the present invention.

FIG. 14 illustrates a Comprehensive Audit and Compliance System according to aspects of embodiments of the present invention.

FIG. 15 illustrates a BQS Unity Platform Integration System according to aspects of embodiments of the present invention.

FIG. 16 illustrates a Hybrid Decisioning Architecture according to aspects of embodiments of the present invention.

FIG. 17 illustrates an Avatar Sponsorship Analytics Engine according to aspects of embodiments of the present invention.

FIG. 18 illustrates a Loyalty-Weighted Bidding Engine according to aspects of embodiments of the present invention.

FIG. 19 illustrates a Sponsorship Feedback Optimizer System according to aspects of embodiments of the present invention.

FIG. 20 illustrates a Multi-Tenant Fraud Detection Architecture according to aspects of embodiments of the present invention.

In aspects of embodiments of the present invention, unless otherwise indicated, solid lines in the drawings/figures represent, inter alia, operational data flows or direct system connections between modules, engines, or subsystems. Solid lines may also correspond to active signal transmission, computation, or enforcement operations performed during system execution.

In aspects of embodiments of the present invention, unless otherwise indicated, dashed (or hashed) lines in the drawings/figures represent, inter alia, logical associations, control dependencies, configuration relationships, or reference mappings that do not constitute a direct or continuous operational data transfer. Dashed lines may also indicate relationships such as shared parameter sets, policy inheritance, feedback coordination, or conceptual coupling across subsystems.

### Definitions

As used herein, the following terms have the meanings set forth below, unless the context indicates otherwise. These definitions are illustrative and non-limiting, and other embodiments may employ additional, fewer, or alternative variations of the defined terms without departing from the scope of the invention.

“Avatar”—In an aspect of an embodiment of the present invention, the term “avatar” refers to a representation of a user or entity, which may be digital, abstract, symbolic, or derived from behavioral attributes, including but not limited to graphical representations in virtual environments, behavioral profiles in advertising systems, tokenized identities in privacy-preserving systems, or any abstracted representation that maintains user characteristics without revealing personally identifiable information and contributes to BQS computation. The avatar may be implemented in hardware, software, or any combination thereof.

“User Entity”—Unless otherwise indicated, in an aspect of an embodiment of the present invention, “user entity” generally refers to a generalized construct representing an interaction source, which may encompass a person, device, session, behavioral profile, cohort, or any combination thereof, and specifically does not require identification of an individual human user. A user entity may be ephemeral (existing only for a single session) or persistent (maintained across multiple interactions), with behavioral signals from the entity contributing to BQS calculation. May be implemented in hardware, software, or any combination thereof.

“Loyalty Token”—As used herein, in an aspect of an embodiment of the present invention, “loyalty token” refers to a cryptographically secured data structure representing behavioral engagement metrics, historical interaction patterns, or value assessments that influence BQS computation, which may be implemented as blockchain tokens, JWT tokens, encrypted database records, or any privacy-preserving representation that enables value attribution without personal identification. The loyalty token may be portable across platforms, time-limited, or domain-restricted based on implementation requirements.

“Loyalty Score”—In an aspect of an embodiment of the present invention, “loyalty score” generally refers to a numerical, categorical, or vectorized representation of user entity engagement, value, or qualification, derived from behavioral signals, interaction patterns, or historical data, which serves as an input to BQS calculation and may be normalized, weighted, or transformed through mathematical functions. The loyalty score may be implemented in hardware, software, or any combination thereof.

“Loyalty Attribute”—In an aspect of an embodiment of the present invention, “loyalty attribute” refers to any behavioral signal, metric, or characteristic indicating a user entity's affinity, engagement level, or value relationship with a brand, sponsor, or entity, expressed as numerical values, categories, or vectors that feed into BQS computation.

“Loyalty Tier”—In an aspect of an embodiment of the present invention, “loyalty tier” refers to a hierarchical classification of user entities based on aggregated loyalty attributes and BQS values, used to modify bid values, personalize content, or prioritize service delivery within the advertising ecosystem.

“Behavioral Qualification Score (BQS)”—In an aspect of an embodiment of the present invention, “BQS” refers to the unified metric that orchestrates all system operations, computed as a numerical score, vector, or multi-dimensional representation generated from behavioral signals including but not limited to engagement patterns, interaction sequences, content consumption, navigation patterns, loyalty attributes, avatar metadata, environmental context, or any observable behavior that indicates user quality or intent, where such score is cryptographically signed, timestamped, and auditable. The BQS serves as the singular coordination mechanism across all subsystems, replacing multi-variable coordination with single-metric orchestration. The BQS may be computed in real-time, pre-computed, or dynamically adjusted based on system feedback.

“BQS Unity Framework”—In an aspect of an embodiment of the present invention, “BQS Unity Framework” refers to the architectural paradigm wherein all system components-fraud detection, personalization, enforcement, loyalty scoring, conflict resolution, and reconciliation-operate through and are coordinated by the single BQS metric, performing dimensional reduction from multiple independent variables to unified scoring that enables convergent optimization across all subsystems.

“Pre-Spend Enforcement”—In an aspect of an embodiment of the present invention, “pre-spend enforcement” refers to the BQS-based prevention, blocking, or modification of advertising transactions before financial commitment occurs, where BQS thresholds gate transaction approval, as distinguished from post-spend detection, measurement, or reporting that occurs after budget consumption. Pre-spend enforcement may occur at various stages including pre-bid, at-bid, or pre-impression, but critically occurs before irreversible financial obligation.

“Closed-Loop Enforcement”—In an aspect of an embodiment of the present invention, “closed-loop enforcement” generally refers to a system architecture wherein BQS-based pre-spend qualification decisions are cryptographically tracked, post-engagement outcomes are measured, reconciliation occurs between predicted BQS values and actual results, and feedback automatically adjusts BQS computation parameters, creating continuous optimization without manual intervention. The closed loop may be implemented in hardware, software, or any combination thereof.

“Privacy-Compliant” or “Privacy-Preserving”—In an aspect of an embodiment of the present invention, these terms refer to system operations that compute BQS values without cookies, device identifiers, personally identifiable information (PII), or other tracking mechanisms that could identify individual users, while meeting requirements of privacy regulations including but not limited to GDPR, CCPA, CPRA, LGPD, PIPEDA, or future privacy frameworks. Privacy compliance may be achieved through various techniques including differential privacy, homomorphic encryption, secure multi-party computation, or behavioral fingerprinting.

“Digital Advertising Middleware”—In an aspect of an embodiment of the present invention, “digital advertising middleware” refers to an intermediary processing layer positioned between demand sources and supply sources in digital advertising ecosystems, operating through BQS-based qualification and enforcement, including but not limited to real-time bidding (RTB) systems, connected television (CTV) platforms, Internet of Things (IoT) networks, immersive/AR/VR environments, digital out-of-home (DOOH) systems, or future advertising delivery mechanisms. The middleware may be implemented as proxy servers, API gateways, service meshes, or any architectural pattern that enables BQS-based interception and modification of advertising transactions.

“Tenant” or “Multi-Tenant”—In an aspect of an embodiment of the present invention, “tenant” refers to a logically separated operational context within the system, which may represent advertisers, publishers, agencies, data providers, or any entity requiring isolated operation with customizable BQS parameters, where logical separation may be achieved through cryptographic isolation, database partitioning, namespace separation, or virtualization, while maintaining unified BQS computation methodology. Multi-tenant operation enables simultaneous service of multiple tenants with tenant-specific BQS calibration while maintaining data isolation and fair resource allocation.

“IoT Contextual Signal”—In an aspect of an embodiment of the present invention, “IoT contextual signal” generally refers to any sensor-derived, environment-derived, or context-derived input from Internet of Things devices that contributes to BQS computation, including but not limited to temperature readings, motion detection, crowd density measurements, acoustic levels, air quality indices, traffic patterns, weather conditions, or any environmental parameter that provides context for BQS-based advertising decisions.

“Qualified Attribution Score (QAS)”—In an aspect of an embodiment of the present invention, “QAS” refers to a post-activation metric derived from reconciliation processes that validates BQS-based pre-spend qualification decisions by comparing predicted BQS outcomes with actual engagement, incorporating fraud detection signals, and generating a composite value used for BQS refinement and feedback optimization in closed-loop systems.

“Enforcement Proxy”—In an aspect of an embodiment of the present invention, “enforcement proxy” refers to a system component that intercepts, evaluates, and controls advertising transactions based on BQS thresholds and configurable policies, operating as a non-bypassable control point that prevents transactions with insufficient BQS values from proceeding. The enforcement proxy may be implemented as a reverse proxy, forward proxy, API gateway, network appliance, or any architectural pattern providing mandatory BQS-based transaction control.

“Enforcement Token”—In an aspect of an embodiment of the present invention, “enforcement token” refers to a cryptographically secured data structure containing BQS-based decision metadata including but not limited to BQS values, QAS values, timestamps, tenant identifiers, policy versions, and authorization states, digitally signed using Ed25519 or equivalent asymmetric signature schemes, serving as verifiable proof of BQS-based pre-spend qualification and enforcement decisions.

“Cryptographically Secured” or “Cryptographically Signed”—In an aspect of an embodiment of the present invention, these terms refer to data protection using cryptographic techniques including but not limited to digital signatures (e.g., Ed25519, ECDSA), hash functions (e.g., SHA-256, SHA-3), encryption algorithms (e.g., AES, ChaCha20), or blockchain/distributed ledger technologies, ensuring BQS data integrity, authenticity, and non-repudiation under current cryptographic assumptions.

“Behavioral Fingerprint”—In an aspect of an embodiment of the present invention, “behavioral fingerprint” refers to a non-personally-identifiable signature derived from interaction patterns, timing sequences, engagement characteristics, or other behavioral attributes that contribute to BQS computation, which is processed through one-way functions (e.g., cryptographic hashing with salt) to prevent reverse engineering to individual identity while maintaining utility for BQS qualification and enforcement decisions.

“Ephemeral Fingerprint”—In an aspect of an embodiment of the present invention, “ephemeral fingerprint” refers to a temporary, non-persistent identifier generated from interaction patterns that feeds into BQS calculation, processed through one-way functions to prevent reverse engineering to individual identity, and which automatically expires or rotates within privacy-compliant intervals (e.g., <300 seconds), ensuring BQS computation remains privacy-compliant.

“Audit Log” or “Immutable Ledger”—In an aspect of an embodiment of the present invention, these terms refer to a tamper-resistant record of BQS-based system events using append-only data structures, cryptographic chaining, blockchain-inspired architectures, or distributed consensus mechanisms, providing verifiable evidence of BQS qualification, enforcement, and reconciliation decisions for compliance, forensic, and evidentiary purposes.

“Beacon”—In an aspect of an embodiment of the present invention, “beacon” refers to a lightweight tracking mechanism including but not limited to JavaScript tags, pixel trackers, server-to-server postbacks, SDK events, or API callbacks, configured to capture post-activation engagement data for BQS reconciliation and refinement without requiring cookies, device identifiers, or persistent tracking mechanisms.

“Orchestration Hub”—In an aspect of an embodiment of the present invention, “orchestration hub” refers to a central or distributed coordination system that manages BQS propagation, workflow execution, resource allocation, and inter-component communication across the BQS Unity Framework, maintaining operational state and ensuring synchronized execution of BQS-driven components, implemented as message brokers, workflow engines, service meshes, or equivalent coordination architectures.

“Fraud Suppression Controller”—In an aspect of an embodiment of the present invention, “fraud suppression controller” refers to an active enforcement component that prevents, blocks, throttles, or modifies advertising transactions identified as fraudulent through anomalous BQS patterns in real-time, operating proactively before budget commitment to prevent waste, as distinguished from detection-only systems that report fraud after occurrence, and integrated with the enforcement proxy for mandatory BQS-based pre-spend prevention.

“BQS Convergence”—In an aspect of an embodiment of the present invention, this term refers to the property of the BQS Unity Framework wherein optimization of the single BQS metric drives coordinated improvements across subsystems, achieving enhanced technical effect through BQS orchestration rather than isolated optimization.

“Sub-[X] ms Latency”—In an aspect of an embodiment of the present invention, references to latency targets (e.g., “sub-200 ms,” “sub-100 ms,” “sub-50 ms”) refer to performance objectives in typical deployments under normal operating conditions, measured at the 99th percentile, where BQS computation occurs within sub-100 ms and complete pipeline processing within sub-200 ms, representing design targets rather than guaranteed performance in all conditions.

“Real-Time” or “Near Real-Time”—In an aspect of an embodiment of the present invention, these terms refer to BQS-based processing that occurs within the latency requirements of digital advertising auctions, typically requiring responses within 200 milliseconds for web display, 500 milliseconds for video, or other timeout thresholds established by specific advertising platforms, where “real-time” implies synchronous BQS computation and “near real-time” allows for cached BQS values with minimal acceptable delay.

“BQS Input Variables”—In an aspect of an embodiment of the present invention, refers to the system parameters that feed into BQS computation, including but not limited to parameters historically denoted as U (user engagement metrics), M (model routing efficiency), E (enforcement strictness), and C (content relevance), which are transformed through the BQS Unity Framework into a single unified score rather than operating as independent coordination variables.

“BQS Weighting Coefficients”—In an aspect of an embodiment of the present invention, the term refers to customizable parameters that adjust the relative influence of different input variables in BQS computation, enabling per-tenant calibration while maintaining the unified scoring methodology across the platform.

“Module”—In an aspect of an embodiment of the present invention, the term represents a self-contained hardware or software computational unit containing processors, memory, and executable code operable to perform the functions described. Sub-blocks represent elements or sub-modules executing defined functions under the control of the parent module. In an aspect of an embodiment of the present invention, each system block labeled as Engine, Module, Controller, Gateway, Proxy, Service, or Manager in the accompanying Figures constitutes a ‘module’ as that term is defined herein.

In an aspect of an embodiment of the present invention, the term “module” may represent self-contained computer hardware. In another aspect of an embodiment of the present invention, the term “module” may represent computer hardware on a designated computer chip or separate computer chips. In yet another aspect of an embodiment of the present invention, the processor may be configured to perform tasks not undertaken by the module(s) disclosed herein. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, module components may also, in an operational context, be components of other modules.

In a further aspect of an embodiment of the present invention, steps, processes, operations or methods undertaken by the modules, systems and/or system components, as discussed above, may be implemented by execution, on one or more servers or processors configured to perform a predefined set of basic operations in response to receiving a corresponding basic instruction selected from a predefined native instruction set of codes. This native instruction set of codes or machine language instruction codes may be built into servers/processors of system components. As such, different operations contemplated by the disclosure above, may be made possible by the selection of machine codes from specific machine language instruction codes. Additional complex operations may be made possible by the combination of different sets of machine language instruction codes.

Further aspects of embodiments of the present invention contemplate the use of non-transitory computer programmable product and computer-implemented methods for the implementation of the different processes outlined above. The same may be found installed on any or all the components discussed in this application including, without limitation, the mobile device(s), registries, etc.

Yet further aspects of embodiments of the present invention contemplate execution of computer code resident on devices, system of devices, and communication media such as wide area networks, the internet etc. enabling the contemplated transactions.

Other terms used herein should be given their plain and ordinary meaning as understood by a person of ordinary skill in the art at the time of the invention, unless explicitly defined otherwise. Where industry-standard definitions exist (e.g., IAB specifications, W3C standards), such definitions may be consulted for context. In the event of conflict with external definitions, the definitions provided herein shall control for purposes of claim interpretation, prosecution, and enforcement. The definitions provided herein are intended to clarify usage within this specification and should not be construed as limiting the scope of the claims unless explicitly recited therein.

All defined terms may be implemented in hardware, software, firmware, or any combination thereof, and may be distributed across multiple physical or logical components without departing from the scope of the invention.

### SUMMARY OF THE INVENTION

An aspect of an embodiment of the present invention contemplates a behavioral qualification middleware system for pre-spend waste prevention in digital advertising comprising: a middleware interception layer positioned between demand-side platforms and programmatic advertising exchanges, a behavioral qualification score (BQS) computation engine communicatively coupled to the middleware interception layer, where the BQS computation engine comprises a signal aggregation module and a weighted scoring module, a closed-loop reconciliation system communicatively coupled to the BQS computation engine, where the closed-loop reconciliation system comprises engagement beacons and a reconciliation processor, and a BQS Unity Framework module communicatively coupled to both the BQS computation engine and the closed-loop reconciliation system, where the BQS Unity Framework module is configured to receive learning signals from the closed-loop reconciliation system.

In an aspect of an embodiment of the present invention, the weighted scoring module of the system's BQS computation engine computes a unified BQS value, where the computation comprises applying a linear weighted sum.

In an aspect of an embodiment of the present invention, the weighted scoring module of the system's BQS computation engine computes a unified BQS value, where the computation comprises applying a nonlinear transformation.

In an aspect of an embodiment of the present invention, the weighted scoring module of the BQS computation engine computes a BQS value as a weighted combination, where the weighted combination comprises at least two behavioral signal types selected from one or more of the following: user engagement (U), model efficiency (M), enforcement strictness (E), and content relevance (C). In another aspect of an embodiment of the present invention, the unified BQS value results from the transformation of signal categories comprising at least user-engagement metrics and at least one of model-efficiency, enforcement-strictness, or content-relevance.

In an aspect of an embodiment of the present invention, the signal aggregation module of the system's BQS computation engine receives user engagement data (U) from an avatar-driven personalization system, where the avatar-driven personalization system is configured to perform one or more of: track user entity behaviors within virtual environments using avatar representations as privacy-compliant proxies, select advertisement content based on behavioral patterns and qualification scores, adapt content presentation in real-time based on user interactions and feed engagement metrics back via learning signals.

In an aspect of an embodiment of the present invention, the signal aggregation module of the BQS computation engine receives user engagement data (U) from a loyalty-based programmatic bidding system, where the loyalty-based programmatic bidding system is configured to perform one or more of: user categorization into loyalty tiers based on historical engagement patterns, application of tier-based multipliers to base bids using adjustment coefficients dynamically updated through performance feedback, integration of BQS values with loyalty-adjusted bids, generation of cryptographic audit trails for bid decisions.

In an aspect of an embodiment of the present invention, the signal aggregation module of the BQS computation engine receives model efficiency data (M) from a hybrid AI decisioning system, where the hybrid AI decisioning system is configured to perform one or more of: evaluate request complexity through analysis of context depth, data volume, and latency budgets, route requests to one or more of: small language model inference pipelines, large language model inference pipelines, hybrid decision modules based on complexity assessment against dynamic thresholds, track processing times and trigger fallback mechanisms and normalize outputs from all inference pipelines.

In an aspect of an embodiment of the present invention, the signal aggregation module of the BQS computation engine receives enforcement strictness data (E) from a fraud detection system, where the fraud detection system is configured to perform one or more of: aggregate bid streams, user interactions, device fingerprints, and network patterns, perform real-time anomaly detection on incoming data streams against statistical baselines, identify complex fraud patterns through pattern correlation across temporal, geographic, and behavioral dimensions, compute fraud probability scores using ensemble models, execute automated blocking actions to prevent fraudulent requests.

In an aspect of an embodiment of the present invention, the signal aggregation module of the BQS computation engine receives content relevance data (C) from a contextual sponsorship matching system, where the contextual sponsorship matching system is configured to perform one or more of: processing real-time venue data from sensors, event feeds, and audience monitors, computing contextual relevance scores identifying optimal activation moments, cross-referencing contextual opportunities with audience profiles under privacy compliance, adapting content format and controlling synchronized delivery across multiple displays, capturing audience reactions, generating performance metrics fed via learning signals.

In an aspect of an embodiment of the present invention, the signal aggregation module of the BQS computation engine receives content relevance data (C) from an IoT-driven environmental adaptation system where the IoT-driven environmental adaptation system is configured to perform one or more of: collect environmental data from sensor arrays comprising weather sensors, traffic monitors, ambient light detectors, and audio level meters, process aggregated sensor data to identify optimal content strategies, match environmental conditions with content variants through visibility checks, audience checks, and adjacency checks, adapt display properties including brightness and contrast.

In an aspect of an embodiment of the present invention, the signal aggregation module of the BQS computation engine receives content relevance data (C) from a conflict avoidance system, where the conflict avoidance system is configured to perform one or more of: extracting sponsor entity information including advertiser, campaign, and exclusivity parameters, performing multi-dimensional conflict checking across category conflicts, temporal exclusivity, and geographic restrictions, applying hierarchical priority resolution rules considering contract terms, bid values, and qualification scores, implementing blocking decision, implementing authorization decisions, generating activation tokens, creating cryptographic logs of conflict detection decisions.

In an aspect of an embodiment of the present invention, the system may further include a multi-tenant isolation architecture, where the middleware interception system maintains cryptographic isolation between tenant environments within the multi-tenant isolation architecture and where the multi-tenant isolation architecture is configured to perform one or more of: manage tenant containers with isolated data stores, configuration repositories, and custom rule engines, enforce strict boundaries preventing cross-tenant data access, ensure cryptographic namespace separation using tokens for tenant data isolation, dynamically distribute computed resources based on tenant service level agreements, maintain separate audit trails per tenant while enabling platform-wide optimization through anonymized patterns.

In an aspect of an embodiment of the present invention, the middleware interception layer comprises an enforcement proxy which operates as a transparent middleware layer between demand-side platforms and advertising exchanges, where the enforcement proxy comprises one or more of: an enterprise token service providing cryptographically secure tokens using asymmetric encryption with identity claims, permission scopes, and temporal validity, a key management system handling key rotation, revocation lists, and emergency recovery, a token validation gateway validating tokens with microsecond latency, a comprehensive audit system capturing activities from all platform modules, processing events through structured logging, storing records in immutable storage using hash-chain verification, evaluating operations against regulatory requirements, generating automated alerts when violations are detected, and enabling third-party auditors to verify record integrity.

In an aspect of an embodiment of the present invention, the system's components maintain end-to-end processing latency below 200 milliseconds within a 99th percentile.

In an aspect of an embodiment of the present invention, the middleware interception layer implements comprehensive failure handling mechanisms to maintain service continuity.

In an aspect of an embodiment of the present invention, the closed-loop reconciliation system is configured to compute Qualified Attribution Scores (QAS) measuring actual engagement quality through weighted signal aggregation with time-based decay factors, where the QAS validate BQS prediction accuracy and inform generation of learning signals.

In an aspect of an embodiment of the present invention, the avatar-driven personalization system comprises one or more of: a virtual environment rendering module displaying virtual venues and positioning avatars within a three-dimensional space, avatar representations tracking user entities as privacy-compliant proxies, a user entity profile store maintaining behavioral attributes built from aggregated signals, a personalization engine processing user profiles and applying matching rules, a dynamic content selector matching BQS values with content variants, virtual display surfaces rendering selected content, a real-time adaptation controller monitoring interactions and feeding engagement metrics back via learning signals.

In an aspect of an embodiment of the present invention, the loyalty-based programmatic bidding system comprises one or more of: a loyalty tier determination module performing user categorization, a user loyalty database storing engagement metrics and affinity scores, tiered segments categorizing users into new users, regular users, and brand advocates, a base bid calculator receiving initial bid values, a loyalty adjustment engine applying tier-based multipliers using adjustment coefficients, a BQS Unity Integration Module performing score combination, a bid validation gateway performing compliance checks, a programmatic auction interface handling bid submission with cryptographic audit trails.

In an aspect of an embodiment of the present invention, the hybrid AI decisioning system comprises one or more of: a routing middleware controller receiving incoming requests and initiating complexity assessment, a complexity assessment module comprising: a context depth analyzer, data volume calculator, and latency budget evaluator generating normalized complexity scores, a gating threshold comparator evaluating complexity scores against dynamic thresholds based on system load metrics and historical accuracy patterns, a latency monitor tracking processing times and comparing against service level agreement requirements, a fallback controller migrating execution between models or utilizing cached decision paths, a model coordination layer normalizing outputs using normalization transforms, a coordination engine computing or updating BQS based on routing efficiency.

In an aspect of an embodiment of the present invention, the fraud detection system comprises one or more of: a comprehensive data collection layer aggregating bid streams, user interactions, device fingerprints, and network patterns, a real-time stream processor performing initial anomaly detection, machine learning classifiers identifying fraud patterns through pattern correlation analyzing temporal patterns, geographic patterns, and behavioral consistency, a risk scoring module computing fraud probability scores using ensemble models, automated blocking actions executing through an enforcement proxy, a cryptographic audit generator creating tamper-proof records stored in an immutable ledger with hash chain verification, a cross-tenant anomaly detector identifying fraud patterns using differential privacy and federated learning.

In an aspect of an embodiment of the present invention, the contextual sponsorship matching system comprises one or more of: an event context analyzer processing real-time venue data including venue sensors, game state feeds, and crowd sentiment monitors, a contextual relevance score generator computing relevance scores using algorithms identifying optimal activation moments, a user entity aggregator collecting attendee information incorporating demographics, behavioral patterns, and engagement histories under k-anonymity groupings, a sponsor matching engine cross-referencing contextual opportunities with audience profiles, a content adaptation module adjusting content format for venue display networks, a synchronized delivery controller controlling coordinated content delivery, an engagement tracking system capturing audience reactions and generating performance metrics.

In an aspect of an embodiment of the present invention, the IoT-driven environmental adaptation system comprises one or more of: a digital-out-of-home (DOOH) display unit serving as primary content delivery mechanism, an integrated sensor array comprising weather sensors, traffic monitors, ambient light detectors, and audio level meters, a local edge processor running inference models for immediate environmental classification, a cloud content decisioning platform coordinating multiple DOOH units, a secure API gateway protecting communications using tokens, an environmental analysis engine processing aggregated sensor data, content selection rules defining adaptation parameters, a creative asset repository storing content variants optimized for different conditions, a dynamic content selector matching conditions with content variants, a rendering engine adapting display properties, performance logs recording display events to an audit system.

In an aspect of an embodiment of the present invention, the conflict avoidance system comprises one or more of: a request intake node receiving placement requests, a sponsor identification module extracting sponsor entity information, an exclusivity rules database containing conflict matrices defining incompatible combinations, category exclusions, temporal windows, and geographic restrictions, a conflict detection engine performing parallel multi-dimensional checking through category conflicts, temporal exclusivity, and geographic restrictions modules, a priority resolution module applying hierarchical rules considering contract terms, bid values, and loyalty scores, an enforcement gateway implementing blocking or authorization decisions and generating activation tokens, an immutable audit ledger creating cryptographic logs, a feedback mechanism updating exclusivity rules.

Another aspect of an embodiment of the present invention contemplates a computer-implemented method for operation of a behavioral qualification middleware system for pre-spend waste prevention in digital advertising comprising executing, on at least one processor configured to perform a predefined set of basic operations in response to receiving a corresponding basic computer executable instruction selected from a predefined native instruction set of codes, steps of: computing a unified BQS value by a behavioral qualification score (BQS) computation engine, enforcing pre-spend qualification, by an enforcement proxy, reconciling predicted qualifications by a closed-loop reconciliation system, and optimizing system-wide performance by a BQS Unity Framework, where the computer-implemented method prevents advertising waste through coordinated pre-spend qualification performed at a middleware interception layer positioned between demand-side platforms and advertising exchanges.

In another aspect of an embodiment of the present invention, computing the unified BQS value by the computer-implemented method comprises applying a linear weighted sum.

In another aspect of an embodiment of the present invention, computing the unified BQS value by the computer-implemented method comprises applying a nonlinear transformation selected from one or more of: sigmoid scaling, geometric mean.

In another aspect of an embodiment of the present invention, the BQS computation engine of the computer-implemented method applies weighted scoring algorithms to compute the unified BQS values as a weighted combination, where the weighted combination comprises at least two behavioral signal types selected from: user engagement (U), model efficiency (M), enforcement strictness (E), and content relevance (C). In another aspect of an embodiment of the present invention, the unified BQS value results from the transformation of signal categories comprising at least user-engagement metrics and at least one of model-efficiency, enforcement-strictness, or content-relevance.

In another aspect of an embodiment of the present invention, computation by the BQS computation engine of the computer-implemented method comprises receiving behavioral signals from user engagement systems, where the step of receiving behavioral signals comprises one or more of: processing signals from an avatar-driven personalization system by tracking user entity behaviors, monitoring user interactions, adjusting display parameters, and feeding interaction outcomes back via learning signals.

In another aspect of an embodiment of the present invention, computation by the BQS computation engine of the computer-implemented method comprises receiving behavioral signals from loyalty platforms, where the step of receiving behavioral signals from loyalty platforms comprises one or more of: processing signals from a loyalty-based programmatic bidding system by performing user categorization, applying tier-based multipliers, integrating BQS values with loyalty-adjusted bids, and generating cryptographic audit trails.

In another aspect of an embodiment of the present invention, computation by the BQS computation engine of the computer-implemented method comprises receiving model efficiency data from hybrid AI decisioning systems, where the step of receiving efficiency data from hybrid AI decisioning systems comprises one or more of: evaluating request complexity, routing requests to inference pipelines, tracking processing times, normalizing outputs, and applying threshold adjustment algorithms.

In another aspect of an embodiment of the present invention, computation by the BQS computation engine of the computer-implemented method comprises receiving enforcement strictness data from fraud detection systems, where the step of receiving enforcement strictness data from the fraud detection systems comprises one or more of: aggregating data streams, performing real-time anomaly detection, identifying complex fraud patterns, computing fraud probability scores, executing automated blocking actions, and maintaining cross-tenant fraud detection.

In another aspect of an embodiment of the present invention, computation by the BQS computation engine of the computer-implemented method comprises receiving content relevance data from contextual matching systems, where the step of receiving content relevance data from contextual matching systems comprises one or more of: processing real-time venue data, computing contextual relevance scores, cross-referencing opportunities with audience profiles, adapting content format, and capturing audience reactions.

In another aspect of an embodiment of the present invention, computation by the BQS computation engine of the computer-implemented method comprises receiving content relevance data from IoT-driven adaptation systems, where the step of receiving content relevance data from IoT-driven adaptation systems comprises one or more of: collecting environmental data, running inference models, processing aggregated sensor data, matching conditions with content variants, and adapting display properties.

In another aspect of an embodiment of the present invention, computation by the BQS computation engine of the computer-implemented method comprises receiving content relevance data from conflict avoidance systems, where the step of receiving content relevance data from conflict avoidance systems comprises one or more of: extracting sponsor entity information, performing multi-dimensional conflict checking, applying priority resolution rules, implementing blocking or authorization decisions, and creating cryptographic logs.

In another aspect of an embodiment of the present invention, the computer-implemented method further comprises the process of maintaining multi-tenant isolation, where the process of maintaining multi-tenant isolation comprises one or more of: managing tenant containers, enforcing strict boundaries, ensuring cryptographic namespace separation, dynamically distributing compute resources, and maintaining separate audit trails.

In another aspect of an embodiment of the present invention, operation of the enforcement proxy of the computer-implemented method comprises one or more of: generating immutable audit records through capturing activities, processing events through structured logging, storing records using hash-chain verification, evaluating operations against regulatory requirements, generating automated alerts, producing scheduled reports, and enabling third-party auditors to verify record integrity.

In another aspect of an embodiment of the present invention, all steps of the computer-implemented method maintain end-to-end latency below 200 milliseconds within a 99th percentile.

In another aspect of an embodiment of the present invention, operation of the middleware system of the computer-implemented method comprises one or more of: implementing comprehensive failure handling through applying cached values when anomalies are detected, routing to pre-computed pathways when latency is breached, adjusting thresholds when unavailability occurs, maintaining values within operational ranges, applying dampening factors, and logging failure events.

A further aspect of an embodiment of the present invention contemplates a computer program product comprising a non-transitory computer readable medium having computer executable instructions stored therein for operation of a behavioral qualification middleware system for pre-spend waste prevention in digital advertising comprising executing, on at least one processor configured to perform a predefined set of basic operations in response to receiving a corresponding basic computer executable instruction selected from a predefined native instruction set of codes, computer readable program code for: computing a unified BQS value by a behavioral qualification score (BQS) computation engine, enforcing pre-spend qualification, by an enforcement proxy, reconciling predicted qualifications by a closed-loop reconciliation system, and optimizing system-wide performance by a BQS Unity Framework, where the computer-implemented method prevents advertising waste through coordinated pre-spend qualification performed at a middleware interception layer positioned between demand-side platforms and advertising exchanges.

In a further aspect of an embodiment of the present invention, the computer program product's computer readable program code for computing the unified BQS value comprises computer readable code for applying a linear weighted sum.

In a further aspect of an embodiment of the present invention, the computer program product's computer readable program code for computing the unified BQS value comprises computer readable code for applying a nonlinear transformation selected from one or more of: sigmoid scaling, geometric mean.

In a further aspect of an embodiment of the present invention, the computer program product's computer readable program code for computing the unified BQS values comprises computer readable code for applying weighted scoring algorithms to compute the unified BQS values as a weighted combination, where the weighted combination comprises at least two behavioral signal types selected from: user engagement (U), model efficiency (M), enforcement strictness (E), and content relevance (C). In a yet further aspect of an embodiment of the present invention, the unified BQS value results from the transformation of signal categories comprising at least user-engagement metrics and at least one of model-efficiency, enforcement-strictness, or content-relevance.

In a further aspect of an embodiment of the present invention, the computer program product's computer readable program code for computation by the BQS computation engine comprises computer readable code for receiving behavioral signals from user engagement systems, where the computer readable code for receiving behavioral signals comprises computer readable code for one or more of: processing signals from an avatar-driven personalization system by tracking user entity behaviors, monitoring user interactions, adjusting display parameters, and feeding interaction outcomes back via learning signals.

In a further aspect of an embodiment of the present invention, the computer program product's computer readable program code for computation by the BQS computation engine comprises computer readable code for receiving behavioral signals from loyalty platforms, where the computer readable code for receiving behavioral signals from loyalty platforms comprises computer readable code for one or more of: processing signals from a loyalty-based programmatic bidding system by performing user categorization, applying tier-based multipliers, integrating BQS values with loyalty-adjusted bids, and generating cryptographic audit trails.

In a further aspect of an embodiment of the present invention, the computer program product's computer readable program code for computation by the BQS computation engine comprises computer readable code for receiving model efficiency data from hybrid AI decisioning systems, where the computer readable code for receiving efficiency data from hybrid AI decisioning systems comprises computer readable code for one or more of: evaluating request complexity, routing requests to inference pipelines, tracking processing times, normalizing outputs, and applying threshold adjustment algorithms.

In a further aspect of an embodiment of the present invention, the computer program product's computer readable program code for computation by the BQS computation engine comprises computer readable code for receiving enforcement strictness data from fraud detection systems, where the computer readable code for receiving enforcement strictness data from the fraud detection systems comprises computer readable code for one or more of: aggregating data streams, performing real-time anomaly detection, identifying complex fraud patterns, computing fraud probability scores, executing automated blocking actions, and maintaining cross-tenant fraud detection.

In a further aspect of an embodiment of the present invention, the computer program product's computer readable program code for computation by the BQS computation engine comprises computer readable code for receiving content relevance data from contextual matching systems, where the computer readable code for receiving content relevance data from contextual matching systems comprises computer readable code for one or more of: processing real-time venue data, computing contextual relevance scores, cross-referencing opportunities with audience profiles, adapting content format, and capturing audience reactions.

In a further aspect of an embodiment of the present invention, the computer program product's computer readable program code for computation by the BQS computation engine comprises computer readable code for receiving content relevance data from IoT-driven adaptation systems, where the computer readable code for receiving content relevance data from IoT-driven adaptation systems comprises computer readable code for one or more of: collecting environmental data, running inference models, processing aggregated sensor data, matching conditions with content variants, and adapting display properties.

In a further aspect of an embodiment of the present invention, the computer program product's computer readable program code for computation by the BQS computation engine comprises computer readable code for receiving content relevance data from conflict avoidance systems, where the computer readable code for receiving content relevance data from conflict avoidance systems comprises computer readable code for one or more of: extracting sponsor entity information, performing multi-dimensional conflict checking, applying priority resolution rules, implementing blocking or authorization decisions, and creating cryptographic logs.

In a further aspect of an embodiment of the present invention, the computer program product may further comprise computer readable code for maintaining multi-tenant isolation, where the computer readable code for maintaining multi-tenant isolation comprises computer readable code for one or more of: managing tenant containers, enforcing strict boundaries, ensuring cryptographic namespace separation, dynamically distributing compute resources, and maintaining separate audit trails.

In a further aspect of an embodiment of the present invention, the computer program product's computer readable program code for operation of the enforcement proxy comprises computer readable code for one or more of: generating immutable audit records through capturing activities, processing events through structured logging, storing records using hash-chain verification, evaluating operations against regulatory requirements, generating automated alerts, producing scheduled reports, and enabling third-party auditors to verify record integrity.

In a further aspect of an embodiment of the present invention, all computer readable code for the computer program product comprise computer readable code for maintaining end-to-end latency below 200 milliseconds within a 99th percentile.

In a further aspect of an embodiment of the present invention, the computer program product's computer readable program code for operation of the middleware system comprises computer readable code for one or more of: implementing comprehensive failure handling through applying cached values when anomalies are detected, routing to pre-computed pathways when latency is breached, adjusting thresholds when unavailability occurs, maintaining values within operational ranges, applying dampening factors, and logging failure events.

A yet further aspect of an embodiment of the present invention contemplates an advertising middleware apparatus comprising: a processor, a memory coupled to the processor, a BQS computation module stored in the memory and executable by the processor to perform one or more of: receive behavioral signals from one or more of: user engagement systems, loyalty platforms, hybrid AI decisioning systems, fraud detection systems, contextual matching systems, IoT-driven adaptation systems, and conflict avoidance systems, compute unified behavioral qualification scores as a weighted combination employing adaptive weighting coefficients assigned to each signal type comprising user engagement (U), model efficiency (M), enforcement strictness (E), and content relevance (C), where the coefficients are constrained to sum to a normalized total, normalize each input signal to a bounded range, store computed scores in a distributed cache, an enforcement module stored in the memory and executable by the processor to perform one or more of: intercept bid requests between demand-side platforms and advertising exchanges, retrieve pre-computed BQS values, apply BQS threshold policies, block unqualified requests before auction submission, enhance qualified bid values proportional to BQS strength, generate cryptographically signed authorization tokens, a reconciliation module stored in the memory and executable by the processor to perform one or more of: receive post-engagement data from beacons deployed across advertising channels, compare actual engagement outcomes with predicted BQS values, compute deviation metrics, generate learning signals, a BQS Unity Framework module stored in the memory and executable by the processor to: receive learning signals from the reconciliation module, adjust the weighting coefficients associated with each signal type (U, M, E, C), propagate updated coefficients to the BQS computation module and all subsystems, maintain convergent optimization through boundary condition enforcement.

In a yet further aspect of an embodiment of the present invention, the processor of the advertising middleware apparatus comprises multiple processing cores enabling parallel processing of one or more of: BQS computation inputs, concurrent enforcement policy evaluation, simultaneous reconciliation processing, and coordinated coefficient optimization.

In a yet further aspect of an embodiment of the present invention, the memory of the advertising middleware apparatus includes a high-speed cache layer optimized for BQS value storage and retrieval comprising: in-memory BQS caches, distributed BQS cache clusters, persistent BQS storage, and multi-tier cache hierarchies.

In a yet further aspect of an embodiment of the present invention, the advertising middleware apparatus further comprises a hardware security module coupled to the processor for performing one or more of: generating cryptographically signed authorization tokens, implementing key management with automated key rotation, providing token validation, enabling cross-system federation, and creating tamper-proof audit records.

In a yet further aspect of an embodiment of the present invention, the advertising middleware apparatus further comprises a network interface configured to perform one or more of: intercept bidstream traffic, protect communications using secure API gateways, coordinate distributed processing across availability zones, enable automatic failover, and support service mesh technology.

In a yet further aspect of an embodiment of the present invention, the advertising middleware apparatus further comprises an audit module stored in the memory and executable by the processor to perform one or more of: capture activities, process raw events through structured logging, store records in immutable storage, evaluate operations against regulatory requirements, generate automated alerts, produce scheduled reports, and enable third-party auditors to verify record integrity.

In a yet further aspect of an embodiment of the present invention the enforcement module of the advertising middleware apparatus implements multi-tenant isolation through one or more of: cryptographic namespace separation, tenant isolation controllers, resource allocation managers, audit aggregation systems, and cross-tenant analytics.

A still further aspect of an embodiment of the present invention contemplates a pre-spend advertising qualification middleware system comprising: a behavioral qualification score (BQS) computation engine configured to perform one or more of: receiving behavioral signals from multiple sources including at least user engagement data, model processing efficiency data, enforcement policy data, and contextual relevance data, computing a unified BQS value as a weighted combination of the received behavioral signals with adaptive weighting coefficients that sum to unity, normalizing each behavioral signal to a bounded numerical range, storing computed BQS values in a distributed cache, and an enforcement proxy middleware layer configured to perform one or more of: intercepting bid requests at a middleware interception point positioned between demand-side platforms and programmatic advertising exchanges, operating transparently to both demand-side platforms and advertising exchanges maintaining compatibility with existing programmatic infrastructure, retrieving pre-computed BQS values associated with intercepted bid requests, applying configurable qualification policies incorporating BQS threshold requirements, fraud risk signals, brand safety requirements, and sponsor conflict checks, blocking bid requests that fail to meet qualification criteria before auction submission, enhancing qualified bid values proportionally to BQS qualification strength, generating cryptographically signed authorization tokens for qualified bid requests, where the enforcement proxy middleware layer prevents advertising waste through pre-spend qualification at a unified interception point before budget commitment.

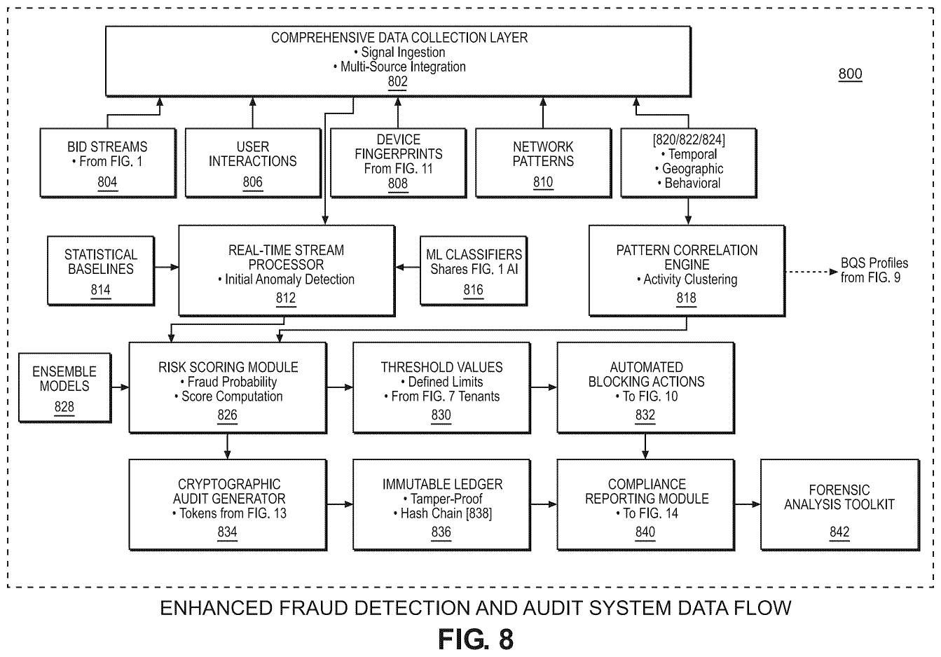

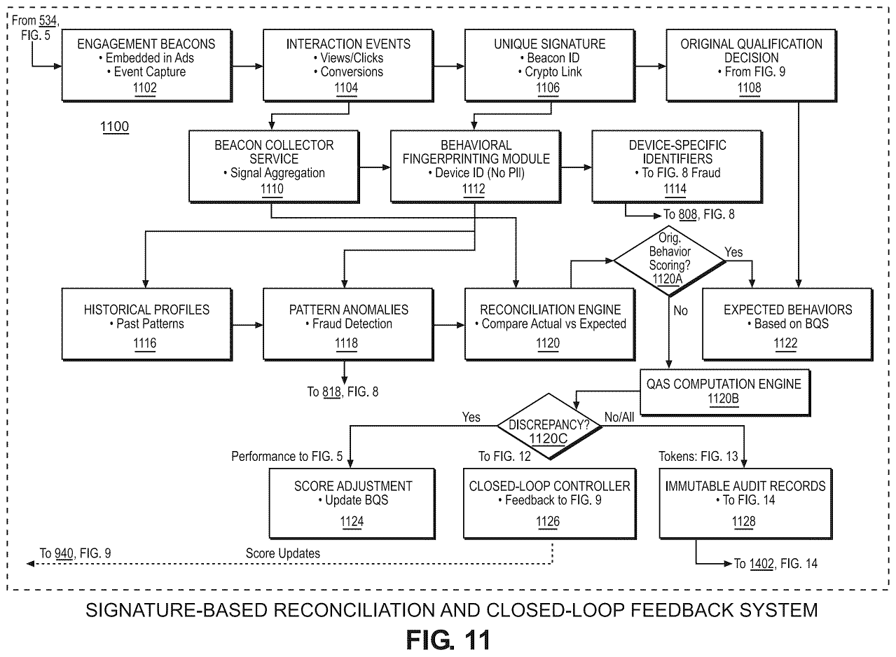

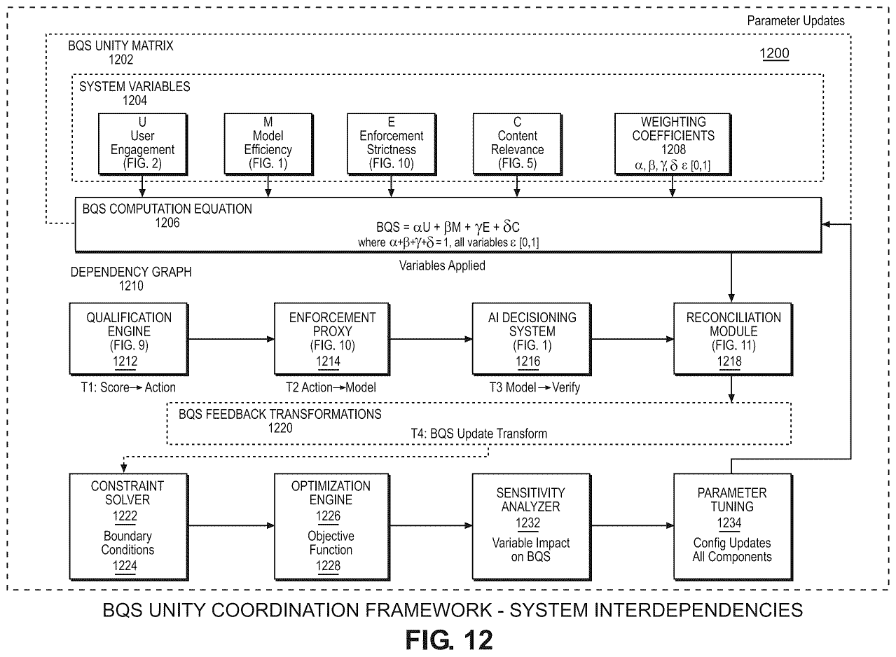

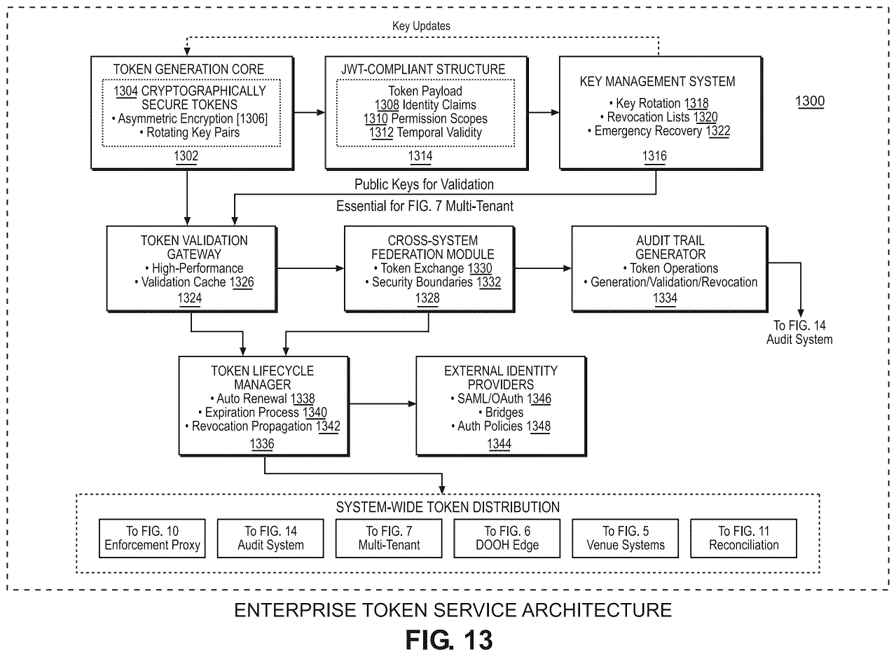

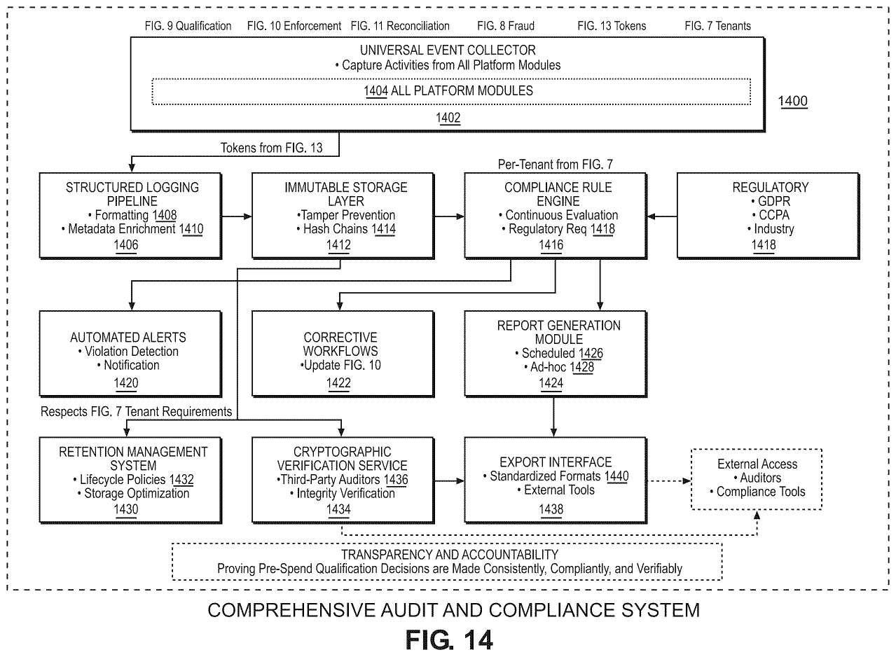

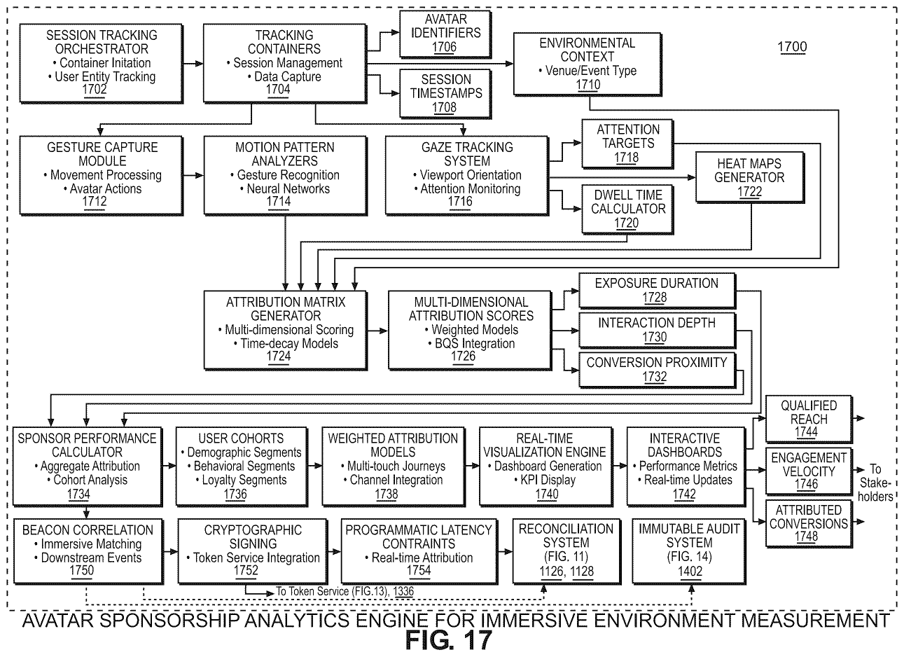

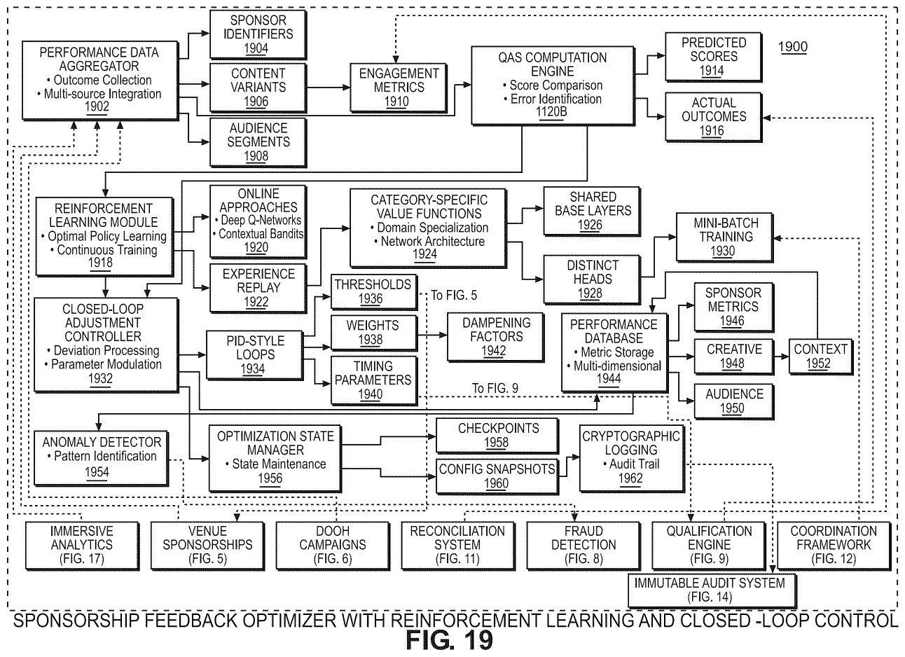

### ELEMENTS

[100] HYBRID LLM/SLM DECISIONING SYSTEM ARCHITECTURE
[102] BID REQUEST INTERFACE
[104] ROUTING CONTROLLER
[104A] ROUTING DECISION
[106] SLM INFERENCE MODULE
[108] LLM INFERENCE MODULE
[110] COORDINATION ENGINE
[112] ENFORCEMENT PROXY
[114] ENFORCEMENT TOKEN
[200] USER ENTITY-DRIVEN PERSONALIZATION SYSTEM
[202] VIRTUAL ENVIRONMENT RENDERING MODULE
[204] AVATAR REPRESENTATIONS
[206] USER ENTITY PROFILE STORE
[208] PERSONALIZATION ENGINE
[210] BEHAVIORAL QUALIFICATION SCORING MODULE
[212] DYNAMIC CONTENT SELECTOR
[214] SPONSOR CONTENT INVENTORY
[216] VIRTUAL DISPLAY SURFACES
[218] REAL-TIME ADAPTATION CONTROLLER
[300] LOYALTY-BASED PROGRAMMATIC BIDDING ENGINE FLOW
[302] LOYALTY TIER DETERMINATION MODULE
[304] USER LOYALTY DATABASE
[306] TIERED SEGMENTS
[308] BASE BID CALCULATOR
[310] LOYALTY ADJUSTMENT ENGINE
[312] ADJUSTMENT COEFFICIENTS
[314] PERFORMANCE FEEDBACK LOOP
[316] BQS VALUES
[318] BQS UNITY INTEGRATION MODULE
[320] BID VALIDATION GATEWAY
[322] PROGRAMMATIC AUCTION INTERFACE
[324] CRYPTOGRAPHIC AUDIT TRAILS
[400] AUTOMATED SPONSOR CONFLICT AVOIDANCE SYSTEM FLOW
[402] REQUEST INTAKE NODE
[404] SPONSOR IDENTIFICATION MODULE
[406] EXCLUSIVITY RULES DATABASE
[408] CONFLICT DETECTION ENGINE
[410] CATEGORY CONFLICTS
[412] TEMPORAL EXCLUSIVITY
[414] GEOGRAPHIC RESTRICTIONS
[416] PRIORITY RESOLUTION MODULE
[418] CONTRACT TERMS
[420] BID VALUES
[422] LOYALTY SCORES
[424] APPROVAL PATHWAY
[426] REMEDIATION WORKFLOW
[428] IMMUTABLE AUDIT LEDGER
[430] ENFORCEMENT GATEWAY
[432] ACTIVATION TOKENS
[434] FEEDBACK MECHANISM
[500] REAL-TIME CONTEXTUAL SPONSORSHIP MATCHING SYSTEM
[502] EVENT CONTEXT ANALYZER
[504] VENUE SENSORS
[506] GAME STATE FEEDS
[508] CROWD SENTIMENT
[510] CONTEXTUAL RELEVANCE SCORE
[512] USER ENTITY AGGREGATOR
[514] DEMOGRAPHIC PROFILES
[516] BEHAVIORAL PATTERNS
[518] ENGAGEMENT HISTORIES
[520] SPONSOR MATCHING ENGINE
[522] SPONSOR INVENTORY DATABASE
[524] RELEVANCE ALGORITHMS
[526] CONTENT ADAPTATION MODULE
[528] VENUE DISPLAY NETWORKS
[530] SYNCHRONIZED DELIVERY CONTROLLER
[532] ENGAGEMENT TRACKING SYSTEM
[534] PERFORMANCE METRICS
[600] IOT-DRIVEN ENVIRONMENTAL CONTENT ADAPTATION SYSTEM
[602] DOOH DISPLAY UNIT
[604] INTEGRATED SENSOR ARRAY
[606] WEATHER SENSORS
[608] TRAFFIC MONITORS
[610] AMBIENT LIGHT DETECTORS
[612] AUDIO LEVEL METERS
[614] LOCAL EDGE PROCESSOR
[616] CLOUD CONTENT DECISIONING PLATFORM
[618] SECURE API GATEWAY
[620] ENVIRONMENTAL ANALYSIS ENGINE
[622] CONTENT SELECTION RULES
[624] CREATIVE ASSET REPOSITORY
[626] DYNAMIC CONTENT SELECTOR
[628/630/632] DYNAMIC CONTENT SELECTOR FACTORS
[634] RENDERING ENGINE
[636] PERFORMANCE LOGS
[700] MULTI-TENANT AI PIPELINE ARCHITECTURE SYSTEM
[702] MULTI-TENANT ORCHESTRATION LAYER
[704A] TENANT CONTAINER A
[704B] TENANT CONTAINER B
[704C] TENANT CONTAINER C
[706] DATA STORE
[708] CONFIG REPO
[710] CUSTOM RULE ENGINE
[712] COMMON PLATFORM SERVICES
[714] TENANT ISOLATION CONTROLLER
[716] CRYPTOGRAPHIC NAMESPACE SEPARATION
[718] SHARED AI PIPELINE INFRASTRUCTURE
[720] TENANT-SPECIFIC FINE-TUNING
[722/724/726] TENANT-SPECIFIC FINE-TUNING CUSTOMIZATION PARAMETERS
[728] RESOURCE ALLOCATION MANAGER
[730] API GATEWAY
[732] AUTH TOKENS
[734] AUDIT AGGREGATION SYSTEM
[736] CROSS-TENANT ANALYTICS
[800] ENHANCED FRAUD DETECTION AND AUDIT SYSTEM
[802] COMPREHENSIVE DATA COLLECTION LAYER
[804] BID STREAMS
[806] USER INTERACTIONS
[808] DEVICE FINGERPRINTS
[810] NETWORK PATTERNS
[812] REAL-TIME STREAM PROCESSOR
[814] STATISTICAL BASELINES
[816] ML CLASSIFIERS
[818] PATTERN CORRELATION ENGINE
[820/822/824] PATTERN CORRELATION ENGINE PATTERN ANALYSES
[826] RISK SCORING MODULE
[828] ENSEMBLE MODELS
[830] THRESHOLD VALUES
[832] AUTOMATED BLOCKING ACTIONS
[834] CRYPTOGRAPHIC AUDIT GENERATOR
[836] IMMUTABLE LEDGER
[838] (HASH CHAIN REFERENCE)
[840] COMPLIANCE REPORTING MODULE
[842] FORENSIC ANALYSIS TOOLKIT
[900] PRE-SPEND BEHAVIORAL QUALIFICATION ENGINE
[902] SIGNAL INGESTION INTERFACE
[904] WEB PROPERTIES
[906] MOBILE APPLICATIONS
[908] CONNECTED DEVICES/IoT
[910] SIGNAL NORMALIZATION MODULE
[912] UNIFIED SCHEMA
[914] SIGNAL QUALITY ASSESSOR
[916] BQS COMPUTATION CORE
[918] WEIGHTED SCORING ALGORITHMS
[920] ENGAGEMENT DEPTH
[922] INTERACTION FREQUENCY
[924] CONV PROXIMITY
[926] BQS VALUES
[928] HIGH-PERF CACHE
[930] THRESHOLD COMPARISON MODULE
[932] ADVERTISER MINIMUMS
[934] AUTHORIZATION TOKEN GENERATOR
[936] CRYPTOGRAPHIC PERMITS
[938] BLOCKING NOTIFICATION SERVICE
[940] FEEDBACK COLLECTOR
ENFORCEMENT PROXY ARCHITECTURE SYSTEM
ENFORCEMENT PROXY LAYER
DSP SYSTEMS
PROGRAMMATIC EXCHANGES
REQUEST INTERCEPTOR
REQUEST METADATA EXTRACT
QUALIFICATION LOOKUP SERVICE
BQS CACHE
POLICY EVALUATION ENGINE
[1016A] POLICY CHECK?
ENFORCEMENT RULES
REQUEST BLOCKING MODULE
BLOCK NOTIFICATIONS
BID ENHANCEMENT MODULE
QUALIFICATION STRENGTH
MODIFIED BID CONSTRUCTOR
RESPONSE HANDLER
BQS ENFORCEMENT METRICS
CRYPTOGRAPHIC PROOF RECORDS
RECONCILIATION AND CLOSED-LOOP FEEDBACK SYSTEM
ENGAGEMENT BEACONS
INTERACTION EVENTS
UNIQUE SIGNATURE
ORIGINAL QUALIFICATION DECISION
BEACON COLLECTOR SERVICE
BEHAVIORAL FINGERPRINTING MODULE
DEVICE-SPECIFIC IDENTIFIERS
HISTORICAL PROFILES
PATTERN ANOMALIES
RECONCILIATION ENGINE
EXPECTED BEHAVIORS
SCORE ADJUSTMENT
CLOSED-LOOP CONTROLLER
IMMUTABLE AUDIT RECORDS
BQS UNITY COORDINATION FRAMEWORK
BQS UNITY MATRIX
SYSTEM VARIABLES
BQS COMPUTATION EQUATION
WEIGHTING COEFFICIENTS
DEPENDENCY GRAPH
QUALIFICATION ENGINE
ENFORCEMENT PROXY
AI DECISIONING SYSTEM
RECONCILIATION MODULE
BQS FEEDBACK TRANSFORMATIONS
CONSTRAINT SOLVER
BOUNDARY CONDITIONS
OPTIMIZATION ENGINE
(OBJECTIVE FUNCTION REFERENCE)
(STABILITY REFERENCE)
SENSITIVITY ANALYZER
PARAMETER TUNING
ENTERPRISE TOKEN SERVICE ARCHITECTURE
TOKEN GENERATION CORE
CRYPTOGRAPHICALLY SECURE TOKENS
(ASYMMETRIC ENCRYPTION REFERENCE)
IDENTITY CLAIMS
PERMISSION SCOPES
TEMPORAL VALIDITY
KEY MANAGEMENT SYSTEM
(KEY ROTATION REFERENCE)
(REVOCATION LISTS REFERENCE)
(EMERGENCY RECOVERY REFERENCE)
TOKEN VALIDATION GATEWAY
(VALIDATION CACHE REFERENCE)
CROSS-SYSTEM FEDERATION MODULE
(TOKEN EXCHANGE REFERENCE)
(SECURITY BOUNDARIES REFERENCE)
AUDIT TRAIL GENERATOR
TOKEN LIFECYCLE MANAGER
(AUTO RENEWAL REFERENCE)
(EXPIRATION PROCESS REFERENCE)
(REVOCATION PROPAGATION REFERENCE)
EXTERNAL IDENTITY PROVIDERS
(SAML/OAUTH REFERENCE)
(AUTH POLICIES REFERENCE)
COMPREHENSIVE AUDIT AND COMPLIANCE SYSTEM
UNIVERSAL EVENT COLLECTOR
ALL PLATFORM MODULES
STRUCTURED LOGGING PIPELINE
(FORMATTING REFERENCE)
(METADATA ENRICHMENT REFERENCE)
IMMUTABLE STORAGE LAYER
(HASH CHAINS REFERENCE)
COMPLIANCE RULE ENGINE
REGULATORY (GDPR, CCPA, INDUSTRY)
AUTOMATED ALERTS
CORRECTIVE WORKFLOWS
REPORT GENERATION MODULE
(SCHEDULED REFERENCE)
(AD-HOC REFERENCE)
RETENTION MANAGEMENT SYSTEM
(LIFECYCLE POLICIES REFERENCE)
CRYPTOGRAPHIC VERIFICATION SERVICE
(THIRD-PARTY AUDITORS REFERENCE)
EXPORT INTERFACE
(FORMATS REFERENCE)
MIDDLEWARE PLATFORM INTEGRATION SYSTEM
CENTRAL MIDDLEWARE ORCHESTRATION HUB
PRE-SPEND QUALIFICATION ENGINE
HYBRID AI DECISIONING LAYER
ENFORCEMENT PROXY GATEWAY
MULTI-TENANT MANAGEMENT PLANE
CONFIG PARAMETERS
CONTEXT RULES
FRAUD THRESHOLDS
BQS UNITY FRAMEWORK (FIG. 12)
MULTIPLE INPUT CHANNELS
IMMERSIVE ENV
VENUE DISPLAYS
DOOH NETWORKS
WEBSITE DISPLAY PROPERTIES
LOYALTY ENHANCEMENT
CONFLICT AVOIDANCE
FRAUD DETECTION (FIG. 8)???
RECONCILIATION FEED BACK (FIG. 11)
ENTERPRISE TOKEN SERVICE (FIG. 13)
IMM UTA BLE AUDIT BACKBONE (FIG. 14)
UNIFIED API GATEWAY
REAL-TIME ANALYTICS DASHBOARDS
AVATAR SPONSORSHIP ANALYTIC'S (FIG. 17)
ANALYTICS PIPELINE
SPONSORSHIP FEEDBACK OPTIMIZER (FIG. 19)
REAL-TIME ANALYTICS DASHBOARDS
HYBRID DECISIONING SYSTEM ARCHITECTURE
ROUTING MIDDLEWARE CONTROLLER
COMPLEXITY ASSESSMENT MODULE
CONTEXT DEPTH
DATA VOLUME CALCULATOR
LATENCY BUDGET EVALUATOR
NORMALIZED COMPLEXITY SCORE
GATING THRESHOLD COMPARATOR
DYNAMIC THRESHOLDS
SYSTEM LOAD METRICS
HISTORICAL ACCURACY PATTERNS
LOW ROUTING STATE
SLM INFERENCE PIPELINE
HIGH ROUTING STATE
LLM INFERENCE PIPELINE
MID ROUTING STATE
HYBRID DECISION MODULE
LATENCY MONITOR
SLA REQUIREMENTS
FALLBACK CONTROLLER
CACHED DECISION PATH
MODEL COORDINATION LAYER
NORMALIZATION TRANSFORMS
AUDIT EVENTS
THRESHOLD ADJUSTMENT ALGORITHMS
BQS UNITY SCORE PROPAGATION
AVATAR SPONSORSHIP ANALYTICS ENGINE
SESSION TRACKING ORCHESTRATOR
TRACKING CONTAINERS
AVATAR IDENTIFIERS
SESSION TIMESTAMPS
ENVIRONMENTAL CONTEXT
GESTURE CAPTURE MODULE
MOTION PATTERN ANALYZERS
GAZE TRACKING SYSTEM
ATTENTION TARGETS
DWELL TIME CALCULATOR
HEAT MAPS GENERATOR
ATTRIBUTION MATRIX GENERATOR
MULTI-DIMENSIONAL ATTRIBUTION SCORES
EXPOSURE DURATION
INTERACTION DEPTH
CONVERSION PROXIMITY
SPONSOR PERFORMANCE CALCULATOR
USER COHORTS
WEIGHTED ATTRIBUTION MODELS
REAL-TIME VISUALIZATION ENGINE
INTERACTIVE DASHBOARDS
QUALIFIED REACH
ENGAGEMENT VELOCITY
ATTRIBUTED CONVERSIONS
BEACON CORRELATION
CRYPTOGRAPHIC SIGNING
PROGRAMMATIC LATENCY CONSTRAINTS
LOYALTY-WEIGHTED BIDDING ENGINE
LOYALTY TOKEN LEDGER
TOKEN BALANCE
VERIFIED ENGAGEMENTS
TIER PROGRESSION CALCULATOR
TIER THRESHOLDS
PROGRESSION CURVES
BID ADJUSTMENT FORMULA PROCESSOR
BASE BID VALUES
LOYALTY TIER MULTIPLIERS
BQS ENHANCEMENT FACTORS
ADJUSTED BID FORMULA
COEFFICIENT OPTIMIZATION MODULE
GRADIENT-BASED METHODS
LOYALTY TOKEN INTEGRATION LAYER
TOKEN REDEMPTION
EXCLUSIVE CONTENT ACCESS
BID PRIORITY ELEVATION
DISTRIBUTED LEDGER
TIER MIGRATION ENGINE
ADVANCEMENT & DEMOTION EVENTS
ADVANCED TARGETING CONTROLS
TIER-SPECIFIC FREQUENCY CAPS
CREATIVE VARIANTS
CONVERSION ATTRIBUTION WINDOWS
PERFORMANCE FEEDBACK LOOP
CONVERSION OUTCOMES
IMMUTABLE AUDIT RECORDS
SPONSORSHIP FEEDBACK OPTIMIZER
PERFORMANCE DATA AGGREGATOR
SPONSOR IDENTIFIERS
CONTENT VARIANTS
AUDIENCE SEGMENTS
ENGAGEMENT METRICS
QAS DEVIATION CALCULATOR
PREDICTED SCORES
ACTUAL OUTCOMES
REINFORCEMENT LEARNING MODULE
ONLINE APPROACHES
EXPERIENCE REPLAY
CATEGORY-SPECIFIC VALUE FUNCTIONS
SHARED BASE LAYERS
DISTINCT HEADS
MINI-BATCH TRAINING
CLOSED-LOOP ADJUSTMENT CONTROLLER
PID-STYLE LOOPS
THRESHOLDS
WEIGHTS
TIMING PARAMETERS
DAMPENING FACTORS
PERFORMANCE DATABASE
SPONSOR METRICS
CREATIVE
AUDIENCE
CONTEXT
ANOMALY DETECTOR
OPTIMIZATION STATE MANAGER
CHECKPOINTS
CONFIG SNAPSHOTS
CRYPTOGRAPHIC LOGGING
MULTI-TENANT PRIVACY AND FRAUD DETECTION SYSTEM
TENANT ISOLATION LAYER
[2004A] NAMESPACE A-[2006] FRAUD MODULES
[2004B] NAMESPACE B-[2006] FRAUD MODULES
[2004C] NAMESPACE C-[2006] FRAUD MODULES
RULE SETS
ML MODELS
THRESHOLDS
DIFFERENTIAL PRIVACY ENGINE
CALIBRATED NOISE
CROSS-TENANT ANOMALY DETECTOR
FEDERATED LEARNING
GRADIENT UPDATES
ANONYMIZED FRAUD SIGNATURES
PATTERN EXCHANGE PROTOCOL
ATTRIBUTION COHORT ENGINE
COHORTS
UNSUPERVISED CLUSTERING
ATTRIBUTION PROFILE
TRANSFER LEARNING
FRAUD SIGNAL AGGREGATOR
TENANT-SPECIFIC SIGNALS
CROSS-TENANT SIGNALS
WEIGHTED ENSEMBLE
TENANT CALIBRATION
PRIVACY AUDIT SYSTEM
COMPLIANCE CERTIFICATES
SCALABILITY ORCHESTRATOR
COMPUTE RESOURCES
SLA PRIORITIES
AUDIT TRAILS

### DETAILED DESCRIPTION OF THE DRAWINGS

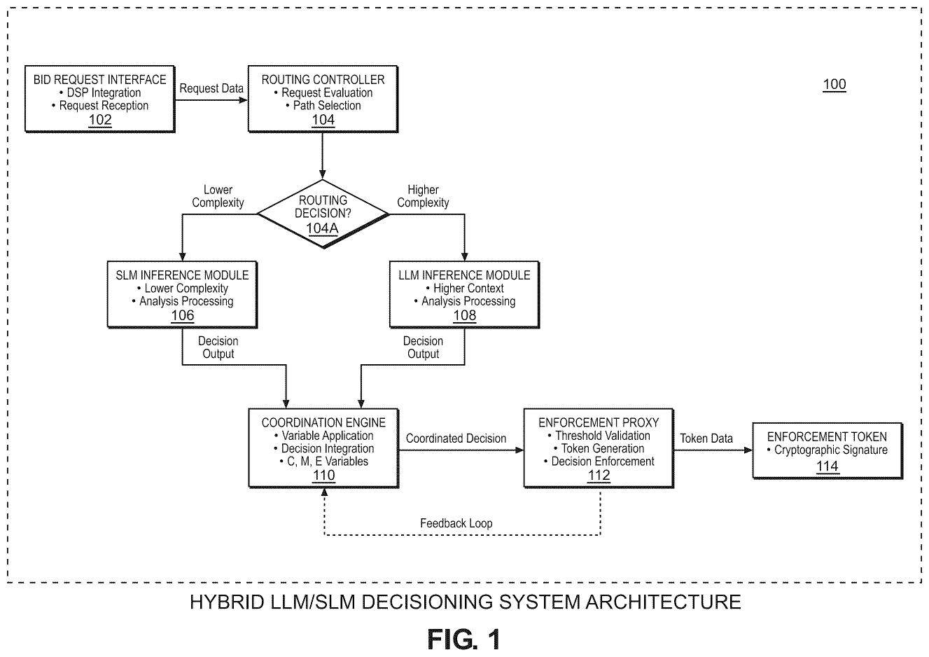

Referring now to FIG. 1, a Hybrid LLM/SLM Decisioning System Architecture [100] is shown according to aspects of embodiments of the present invention. In one aspect of an embodiment of the present invention, hybrid LLM/SLM decisioning system architecture [100] dynamically routes requests between large language models (LLMs) and small language models (SLMs) based on complexity assessment to optimize performance and resource utilization. Bid Request Interface [102] receives incoming advertising requests via DSP (Demand-Side Platform) integration. These requests flow into Routing Controller [104], which performs preliminary analysis to determine the appropriate processing pathway.

Routing Controller [104] contains Routing Decision [104A], which evaluates request complexity using contextual depth, data volume, and latency requirements. This binary decision mechanism determines whether requests are processed through lower or higher complexity pathways. For lower complexity requests, system [100] routes to SLM Inference Module [106], which handles routine requests with lower computational requirements. The SLM pathway enables the system to meet programmatic RTB latency requirements of sub-200 milliseconds for most requests.

Higher complexity requests are directed to LLM Inference Module [108], which manages requests requiring deeper context understanding and sophisticated analysis, including multi-factor bid optimization, complex audience segmentation, and advanced fraud pattern recognition. Both inference pathways converge at Coordination Engine [110], which coordinates decisions from both pathways, manages BQS (Behavioral Qualification Score) propagation across the system, and ensures consistency regardless of which processing path was utilized.

In certain aspects of embodiments of the present invention, Coordination Engine [110] computes or updates the Behavioral Qualification Score (BQS)=f(U,M,E,C) based on user, media, engagement, and contextual parameters, maintaining the unified metric across all inference pathways. The coordinated decision flows to Enforcement Proxy [112], which performs threshold validation against advertiser-defined minimums, executes token generation for authorized requests, and handles decision enforcement. System [100] then generates Enforcement Token [114] containing a cryptographic signature that authenticates and authorizes the decision. This token serves as immutable proof of the qualification decision. Each Enforcement Token [114] includes a timestamp, nonce, and Ed25519-based digital signature hashed into the system's immutable audit ledger (see FIG. 14).

A feedback loop (shown as dashed line) connects from Enforcement Proxy [112] back to Coordination Engine [110], enabling continuous system optimization and learning from enforcement outcomes. Feedback signals modify weight adjustments (AAQS) within the closed-loop optimization layer, allowing future routing and enforcement thresholds to self-tune based on verified outcomes.

In other aspects of embodiments of the present invention, system [100] employs transformer variants or mixture-of-experts models to accommodate latency and confidence trade-offs. Routing may be based on latency, confidence, or adaptive load balancing.

The BQS-unified advertising and sponsorship system comprises multiple interconnected subsystems orchestrated through a single Behavioral Qualification Score (BQS) metric to provide intelligent, real-time advertising decisions while maintaining performance, compliance, and personalization requirements. The architecture is modular and scalable, enabling deployment across multiple environments while maintaining strict data isolation and privacy compliance. All subsystems operate deterministically through BQS-propagated control values that modulate policy weighting, routing, and enforcement parameters in real time.

BQS Unity Framework [1200] optimizes interaction between subsystems through the unified BQS metric, computed as: BQS=f(U, M, E, C) with adaptive weighting coefficients dynamically updated through ΔAQS learning signals, where U represents user engagement metrics, M represents model routing efficiency, E represents enforcement strictness, and C represents content relevance. Adaptive weighting coefficients are determined by real-time system performance metrics and closed-loop feedback signals (see FIG. 1, FIG. 12).

In an aspect of an embodiment of the present invention, hybrid LLM/SLM routing system [100] dynamically allocates natural language processing tasks between computationally intensive LLMs and efficient SLMs based on BQS-determined complexity thresholds, ensuring inference routing remains latency-bounded and privacy-preserving across distributed environments. The routing decision engine evaluates incoming queries by computing a BQS value incorporating token count, semantic depth, domain specificity, and required response latency.

BQS-based complexity assessment algorithms analyze linguistic features and contextual requirements to determine optimal model selection. The assessment process examines syntactic complexity (parse tree depth), semantic ambiguity (disambiguation requirements), domain-specific terminology density, and cross-reference requirements to generate BQS scores for routing decisions.

Graduated fallback strategies adjust BQS routing thresholds when primary models fail, maintaining service availability through progressive degradation: model size reduction for high-BQS requests→context window truncation while preserving BQS computation→deterministic rule-based responses for near-zero-BQS fallback scenarios (see FIG. 12).

Error recovery mechanisms automatically adjust BQS thresholds during resource errors, memory constraints, or timeout conditions, routing requests to available models with reduced batch sizes or alternative endpoints while maintaining BQS scoring integrity. Persistent failures trigger circuit breakers that temporarily raise BQS thresholds for affected components.

Graceful degradation protocols maintain core BQS functionality during partial system failures by disabling non-essential features in BQS-prioritized order: advanced personalization for low-BQS entities→real-time BQS updates for cached scores→predictive BQS analytics→historical BQS reporting.

Real-time monitoring dashboards track BQS performance metrics, routing decisions, and system health indicators, including per-model performance across BQS ranges, BQS accuracy scores, confidence distributions, and resource utilization rates by BQS tier. Quality assurance pipelines continuously evaluate BQS predictions against actual engagement outcomes, identifying drift, bias, or accuracy degradation that might require algorithm refinement or threshold adjustment.

Quality assurance outputs feed directly into the Closed-Loop Optimization Layer (FIG. 11) to refine ΔAQS coefficients and maintain calibration accuracy across tenants, while A/B testing frameworks enable controlled experimentation with different BQS routing strategies, computation configurations, and threshold settings, empirically validating optimization strategies before full deployment within production sandbox environments.

In an aspect of an embodiment of the present invention, automated scaling policies adjust computational resources based on BQS processing demands, historical computation patterns, and real-time metrics, maintaining performance while optimizing infrastructure utilization. With certain aspects of embodiments of the present invention, shadow mode evaluation runs new BQS computation models in parallel with production systems without affecting live decisions, enabling safe validation of algorithm updates before deployment.

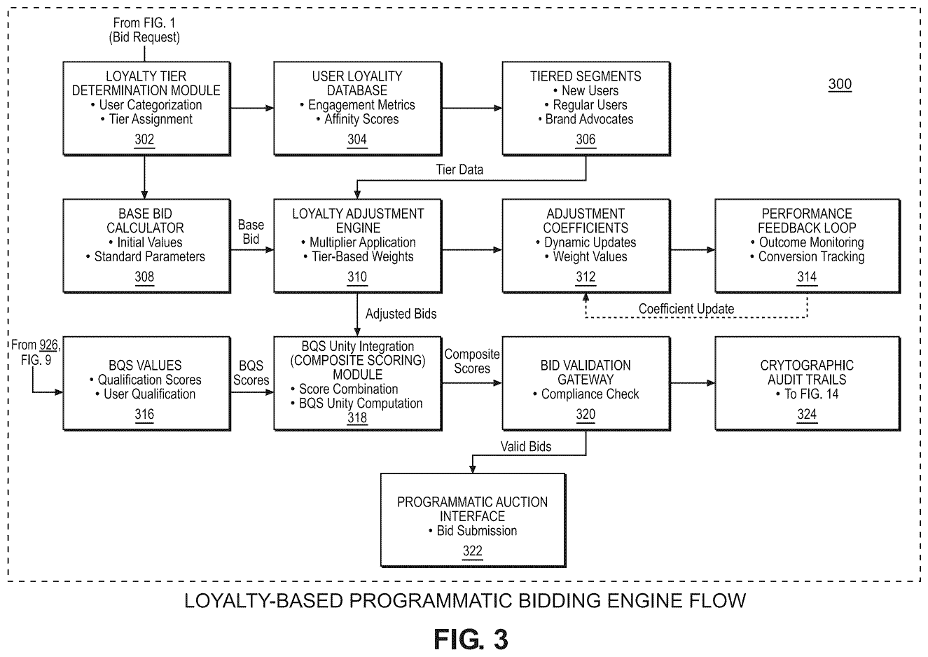

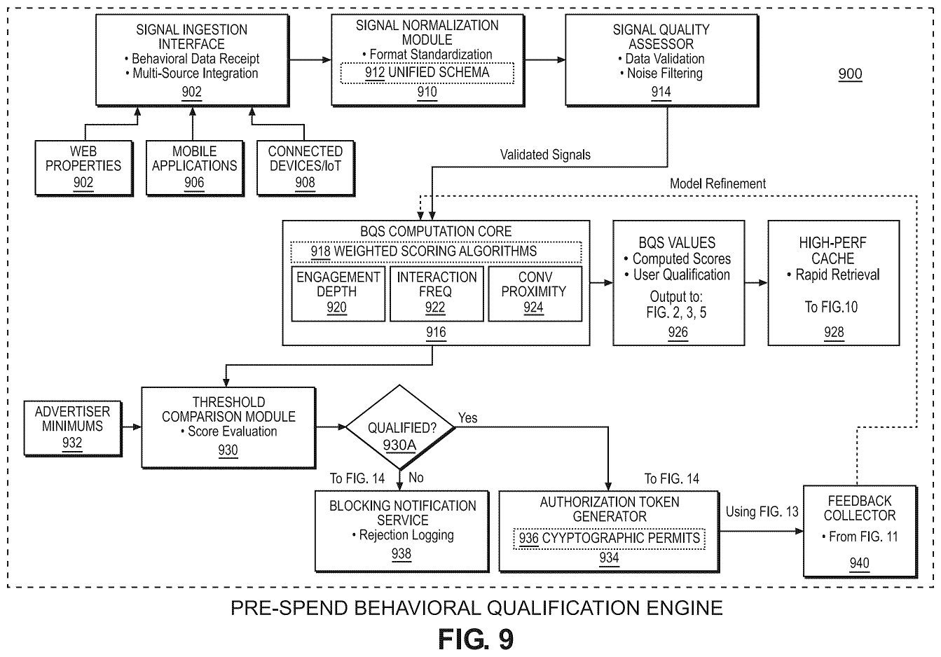

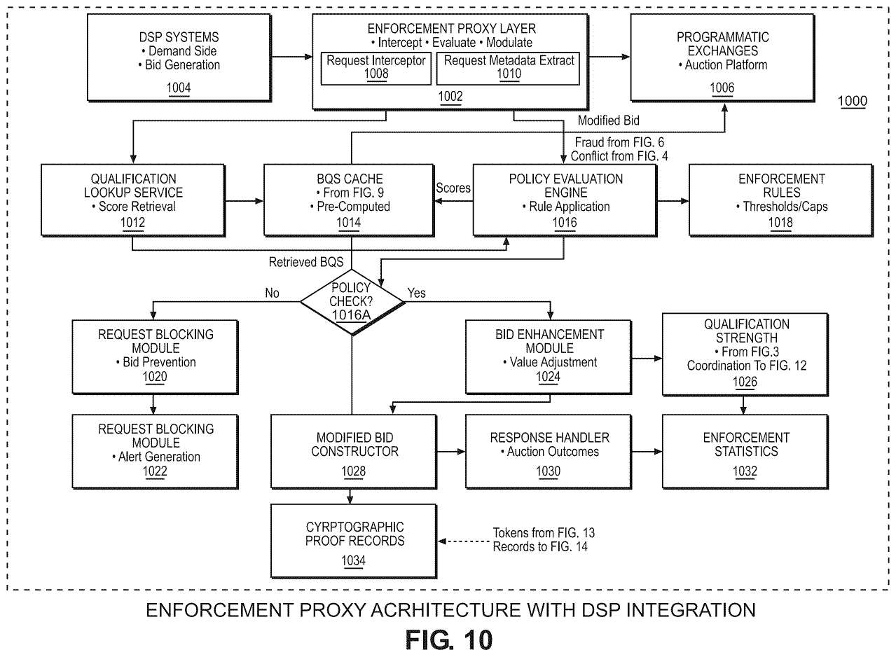

In aspects of embodiments of the present invention, the following examples demonstrate complete integration of all components through BQS in real-world scenarios:
Example 1: Programmatic Ad Bid Flow (aligned to system architecture)
Step 1: A bid request from a demand-side platform (DSP) arrives with publisher information, campaign requirements, and user context (no PII) and no persistent identifiers are retained. The request is received at the ingress/API gateway and given a correlation ID for tracing.
Step 2: The pre-spend Behavioral Qualification Engine (FIG. 9) evaluates the user/entity against historical, normalized signals and produces a BQS value.
Step 3: The loyalty-based programmatic bidding flow (FIG. 3) retrieves any loyalty/entitlement state from distributed cache, verifies the token via the enterprise token service (FIG. 13), and contributes that value into the BQS calculation.
Step 4: The fraud detection and audit system (FIG. 8) scores the request against known patterns; low fraud risk increases confidence/reliability weighting for the BQS inside BQS Unity Framework [1200] (FIG. 12).
Step 5: The enforcement proxy (FIG. 10) intercepts the bid before it goes to the exchange, compares the BQS to advertiser/platform thresholds, and when satisfied, issues an authorization/enforcement record signed via the token service (FIG. 13).
Step 6: The bid is optionally enhanced (FIG. 10, Bid Enhancement Module) using the qualification strength/BQS so the final bid reflects the higher-quality traffic.
Step 7: The qualified bid is returned to the DSP/exchange path within RTB latency, and the decision is written to the immutable audit/compliance system (FIG. 14).
Step 8: After delivery, the reconciliation and beacon-correlation system (FIG. 11) confirms the engagement and feeds the outcome back to BQS Unity (FIG. 12) for parameter updates via ΔAQS learning signals.

### Example 2: IoT Contextual BQS Adjustment

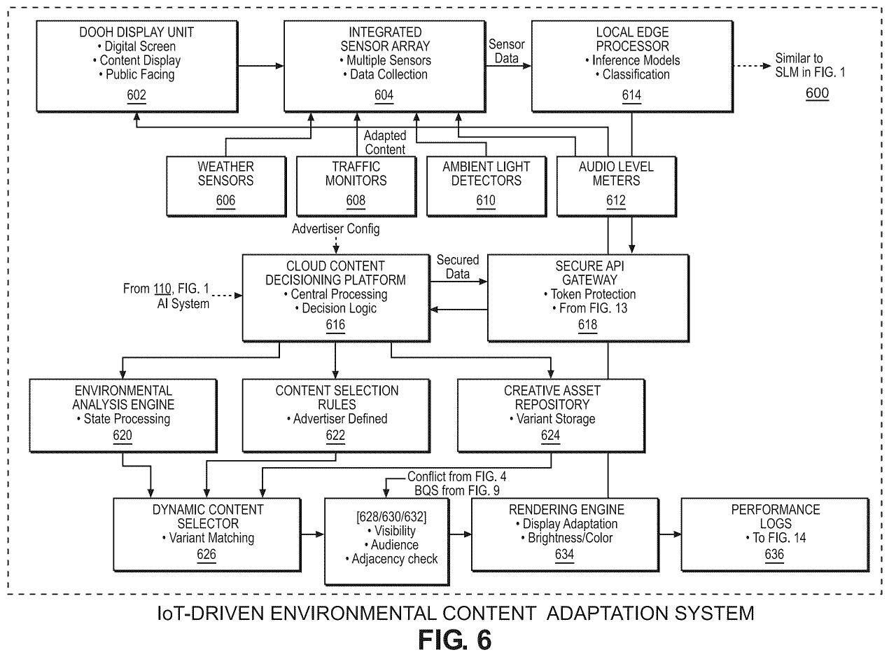

Step 1: Retail store sensors (FIG. 6) detect crowd density increase during a flash sale event. Edge processors aggregate this data with low latency.
Step 2: The IoT integration layer (FIG. 6) processes the crowd surge signal, computing a high contextual relevance score that feeds into BQS calculation via the signal ingestion interface (FIG. 9).
Step 3: BQS Unity Framework [1200] (FIG. 12) incorporates the environmental context, adjusting BQS values to reflect the high engagement opportunity, triggering cascade updates across all BQS-dependent systems within bounded convergence cycles.
Step 4: The bidding engine (FIG. 3) automatically adjusts bid values proportional to increased BQS scores for impressions targeting users near the retail location, while the enforcement proxy (FIG. 10) adapts BQS thresholds to accommodate increased traffic.
Step 5: The loyalty system (FIG. 3) adjusts point accrual contributions to BQS for in-store purchases made during the surge period.
Step 6: Real-time monitoring dashboards update to show BQS distribution changes, with all adjustments logged in the audit system (FIG. 14).

### Example 3: Fraud Prevention Through BQS Anomalies—A Sophisticated Bot Attack is Prevented Through BQS-Based Coordinated Defense

Step 1: The fraud detection system (FIG. 8) identifies unusual BQS patterns: numerous requests with identical behavioral fingerprints but varying user agents, triggering anomaly alerts.
Step 2: BQS Unity Framework [1200] (FIG. 12) immediately adjusts fraud-related weights in BQS computation, propagating updated thresholds to all enforcement components.
Step: The enforcement proxy (FIG. 10) switches to strict mode, requiring elevated BQS scores and implementing rate limiting based on source patterns. These policy changes deploy atomically across all nodes.
Step 4: The BQS computation engine (FIG. 9) increases scrutiny, analyzing additional signals while maintaining acceptable latency through optimized processing.
Step 5: The system blocks suspicious requests through BQS gating before bid submission via the enforcement proxy (FIG. 10), preventing substantial potential fraud losses.
Step 6: The hybrid AI routing system (FIG. 1) shifts toward more sophisticated analysis models to better understand the attack pattern for future refinement.
Step 7: Post-attack analysis generates a cryptographically signed report (FIG. 13, FIG. 14) showing prevention efficacy, with new attack signatures automatically incorporated into BQS computation while maintaining tenant isolation.

BQS Computation (illustrative pseudocode): An exemplary, non-limiting pseudocode as an aspect of an embodiment of the present invention, is outlined below. It should be noted that this is one possible implementation, and it is shown for illustrative purposes only:

```
function compute_bqs(user_entity, signals):
  # Initialize base score from historical baseline
  base_score = user_entity.historical_avg * weight_factor
  # Apply real-time signal weighting
  signal_score = weighted_sum(
    signals.engagement_depth,
    signals.session_duration,
    signals.interaction_rate,
    signals.content_relevance
  )
  # Apply BQS Unity Framework modifiers
  bqs_modifier = calculate_unity_adjustment( )
  # Generate final BQS with bounds
  bqs = bound(
    (base_score + signal_score) * bqs_modifier,
    min_value, max_value
  )
  # Cryptographically sign the BQS
  signature = ed25519_sign(bqs, timestamp, entity_id)
  return {
    “score”: bqs,
    “signature”: signature,
    “timestamp”: current_time( )
}
```

BQS Enforcement Policy (illustrative, non-limiting configuration):

```
{
  “policy_version”: “2.1.0”,
  “bqs_enforcement_rules”: {
    “qualification_threshold”: {
      “minimum_bqs”: “configurable”,
      “strict_mode_bqs”: “elevated”,
      “applies_when”: “fraud_risk_high”
    },
    “loyalty_contribution”: {
      “minimum_score”: “baseline”,
      “premium_tier”: “high_percentile”,
      “boost_multiplier”: “configurable”
    },
    “fraud_limits”: {
      “maximum_risk_score”: “threshold”,
      “auto_block_threshold”: “high”,
      “requires_manual_review”: “range”
    }
  },
  “bqs_response”: {
    “high_fraud_detected”: “adjust_weights”,
    “premium_user”: “enhance_bqs”,
    “resource_constrained”: “optimize_routing”
  }
}
```

These implementation examples demonstrate that the system achieves its design targets in real-world scenarios: programmatic bid flows complete with low latency appropriate for RTB, IoT-driven BQS adjustments propagate rapidly, fraud prevention through BQS anomaly detection activates promptly, and loyalty-enhanced personalization adds minimal overhead. BQS Unity Framework [1200] successfully orchestrates system-wide responses through the unified scoring approach. Audit logs for these operational demonstrations, cryptographically signed using Ed25519 and hashed with SHA-256, are stored in immutable append-only format and serve as reduction-to-practice evidence, demonstrating operational realization of each claimed subsystem under deterministic control of BQS Unity Framework [1200].

### Additional Hybrid LLM/SLM Routing System Operational Descriptions

Model-Specific BQS Optimization: SLMs process queries with BQS values below tenant-specific thresholds, achieving significant accuracy on routine low-BQS queries while using fewer computational resources than LLMs. LLMs are reserved for high-BQS tasks indicating complex reasoning requirements, multi-turn conversations with elevated cumulative BQS, and queries where BQS patterns suggest nuanced interpretation needs.

BQS-based Hybrid LLM/SLM decisioning system [100] operates entirely without cookies, device IDs, or personally identifiable information by computing BQS values only from contextual signals and behavioral patterns that cannot be traced to individuals. Input features for BQS calculation include aggregated session metrics (request frequency contributing to BQS velocity component), contextual attributes (time and category affecting BQS context weights), and ephemeral behavioral fingerprints that rotate at short, privacy-compliant intervals while maintaining BQS continuity. The BQS computation never stores or processes email addresses, names, phone numbers, IP addresses (beyond geographic region for BQS localization), or any persistent identifiers. Both LLM and SLM models use BQS values derived from anonymized datasets where all PII has been removed through differential privacy techniques within bounded privacy budgets.

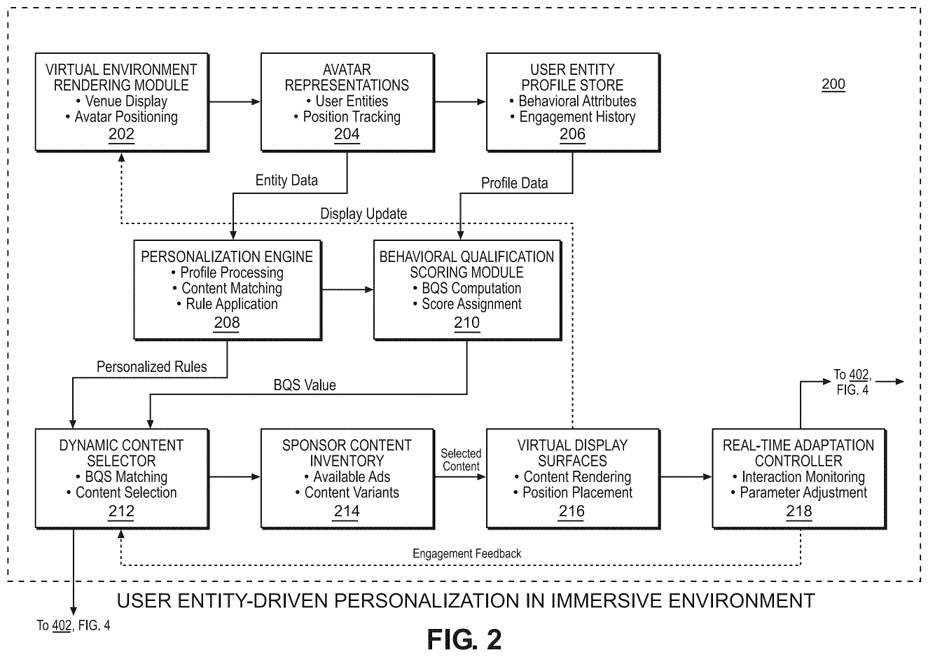

Referring now to FIG. 2, a user entity-driven personalization system [200] is shown according to aspects of embodiments of the present invention. In one aspect of an embodiment of the present invention, user entity-driven personalization system [200] operates within immersive virtual environments, demonstrating how the platform adapts advertising content based on avatar behaviors and user entity attributes while maintaining privacy compliance.

Virtual Environment Rendering Module [202] of system [200] displays the virtual venue and positions avatars within 3D space, creating an immersive context where advertising interactions occur, supporting various virtual environments from gaming worlds to virtual conferences.

Avatar Representations [204] track user entities and their positions within virtual space. Each avatar serves as a privacy-compliant proxy for the user, enabling behavioral tracking without exposing personally identifiable information.

User Entity Profile Store [206] maintains behavioral attributes and engagement history for each user entity. These profiles are built from aggregated behavioral signals rather than PII, ensuring General Data Protection Regulation (GDPR) and California Consumer Privacy Act (CCPA) compliance while enabling effective personalization.

Personalization Engine [208] processes user profiles and applies matching rules to determine appropriate content selection, considering multiple factors including past engagement patterns, content preferences, and contextual relevance.

Behavioral Qualification Scoring (BQS) Module [210] computes and assigns BQS values to each user entity based on their behavioral signals. BQS module [210] implements the core scoring algorithms that drive the entire platform's qualification decisions, generating the unified metric that determines advertising eligibility and feeds into BQS Unity Framework [1200] (FIG. 12).

Dynamic Content Selector [212] matches BQS values with appropriate content variants from the sponsor inventory, ensuring that users receive relevant advertising based on their qualification scores rather than invasive personal data collection.

Sponsor Content Inventory [214] maintains available advertisements and their variants, including different creative formats, messaging variations, and interaction modalities suitable for immersive environments.

Virtual Display Surfaces [216] render selected content in positioned locations throughout the virtual environment. These surfaces adapt to the virtual world's aesthetic while maintaining clear sponsor visibility, ensuring that advertisements appear contextually appropriate within the virtual space.

Real-Time Adaptation Controller [218] monitors user interactions and adjusts display parameters in real-time, tracking engagement metrics such as gaze duration, proximity, and interaction depth to optimize content presentation. Real-Time Adaptation Controller [218] also monitors interaction outcomes and engagement metrics, feeding this data back to Behavioral Qualification Scoring Module [210] for continuous refinement via ΔAQS learning signals. This feedback mechanism enables system [200] to improve BQS accuracy over time based on actual user entity responses within immersive environments.

Feedback loops (shown as dashed lines) in system [200] update content selection algorithms and display parameters based on observed engagement patterns, creating a continuously improving personalization system that operates under deterministic control of BQS Unity Framework [1200].

In alternative aspects of embodiments of the present invention, personalization engine [200] employs collaborative filtering, recommendation systems, or graph neural networks. Avatars may be graphical, abstract, or behavioral embeddings. Delivery may occur across VR, AR, web, mobile, or CTV, rendered via client-side, server-side, or cloud infrastructure.

Referring now to FIG. 3, a loyalty-based programmatic bidding engine flow [300] is shown according to aspects of embodiments of the present invention. Loyalty-based programmatic bidding engine flow [300] illustrates the sophisticated bidding system that integrates loyalty tiers, behavioral qualification scores, and dynamic bid adjustments to optimize programmatic advertising auctions while rewarding genuine user engagement.

Flow [300] initiates with Loyalty Tier Determination Module [302], which performs user categorization and tier assignment based on historical engagement patterns, evaluating cumulative user behaviors to assign appropriate loyalty classifications.

User Loyalty Database [304] then stores engagement metrics and affinity scores for each user entity. This database maintains historical interaction data that informs loyalty tier assignments and bid adjustments.

Next, Tiered Segments [306] categorize users into distinct groups: New Users (minimal engagement history), Regular Users (consistent engagement patterns), and Brand Advocates (high engagement and conversion history). These segments enable differentiated bidding strategies.

Base Bid Calculator [308] then receives initial bid values and standard parameters from the advertiser's campaign settings, establishing the foundational bid amount before loyalty and behavioral adjustments.

Loyalty Adjustment Engine [310] applies tier-based multipliers to the base bid received from Base Bid Calculator [308]. The engine receives tier data from Tiered Segments [306] and applies corresponding weight adjustments, rewarding higher loyalty tiers with increased bid values.

Adjustment Coefficients [312] provide dynamic updates and weight values that modify bid calculations based on real-time performance data. These coefficients are continuously optimized through machine learning algorithms and ΔAQS learning signals.

Performance Feedback Loop [314] monitors outcome data including conversions, engagement depth, and attribution metrics. This feedback mechanism enables the system to refine adjustment coefficients based on actual campaign performance, feeding back to BQS Unity Framework [1200] (FIG. 12).

BQS Values [316], computed by qualification engine [916] (shown in FIG. 9), provide behavioral qualification scores that indicate user quality beyond simple loyalty metrics. These scores incorporate multi-dimensional behavioral signals.

BQS Unity Integration Module [318] performs score combination, integrating BQS values with loyalty-adjusted bids to create a unified bid score. This module implements the mathematical framework that balances loyalty rewards with behavioral qualification.

Bid Validation Gateway [320] performs compliance checks to ensure composite scores meet advertiser requirements and platform policies, preventing invalid bids from entering the auction.

Cryptographic Audit Trails [324] reference audit system [1400] shown in FIG. 14, ensuring all bid decisions are cryptographically logged for transparency and accountability.

Programmatic Auction Interface [322] serves as the destination for validated bids, handling bid submission to advertising exchanges and SSPs (Supply-Side Platforms).

In alternative aspects of embodiments of the present invention, loyalty-based bidding engine [300] employs RFM analysis, lifetime value prediction, or influence scoring. Adjustments may be linear, polynomial, sigmoid, or reinforcement based. Loyalty tiers may be static, dynamic, or cross-platform.

### Additional Loyalty Based Programmatic Bidding Engine Flow Operational Descriptions

In an aspect of an embodiment of the present invention, real-time loyalty scoring engine [300] computes loyalty metrics that directly influence BQS values through integrated weighting functions, where loyalty scores serve as inputs to the BQS computation engine. The scoring engine processes behavioral signals contributing to both loyalty and BQS calculations within low-latency windows, enabling pre-spend BQS evaluation incorporating loyalty before bid commitment.

The loyalty score computation for BQS integration incorporates multiple weighted factors including engagement frequency contributing to BQS user engagement parameter (U), transaction history influencing BQS conversion proximity weights, content interaction depth affecting BQS engagement depth calculation (E), social signals modulating viral coefficients, and platform-specific loyalty indicators enhancing BQS platform relevance scores. These weights are configurable per tenant within the unified BQS framework and dynamically adjusted based on vertical-specific optimization objectives via ΔAQS learning signals.

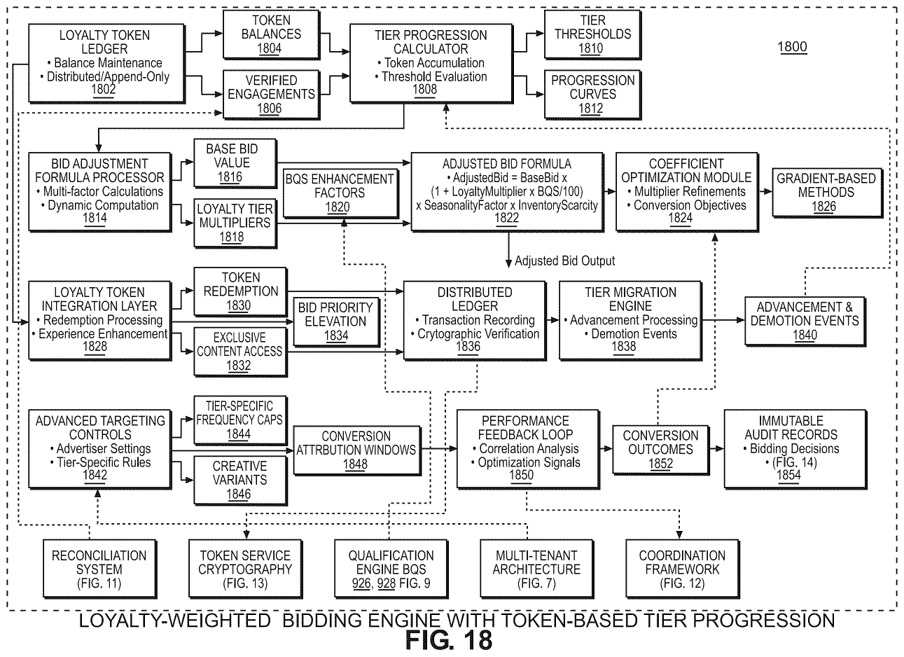

The BQS-weighted loyalty-based advertisement bidding system is depicted in FIG. 3 and FIG. 18, with the BQS datastore incorporating loyalty values [304], bidding engine retrieving BQS scores [310], adjustment module applying BQS-proportional modifications [312], and auction module determining winners based on BQS-adjusted bids [322].

The privacy-compliant data flow ensures that raw behavioral signals never leave their originating platform, with only normalized, hashed vectors contributing to BQS transmitted to the loyalty scoring engine. This architecture implements privacy-by-design principles for BQS computation, with data minimization enforced at the protocol level and retention policies automatically purging signals older than configurable retention windows.

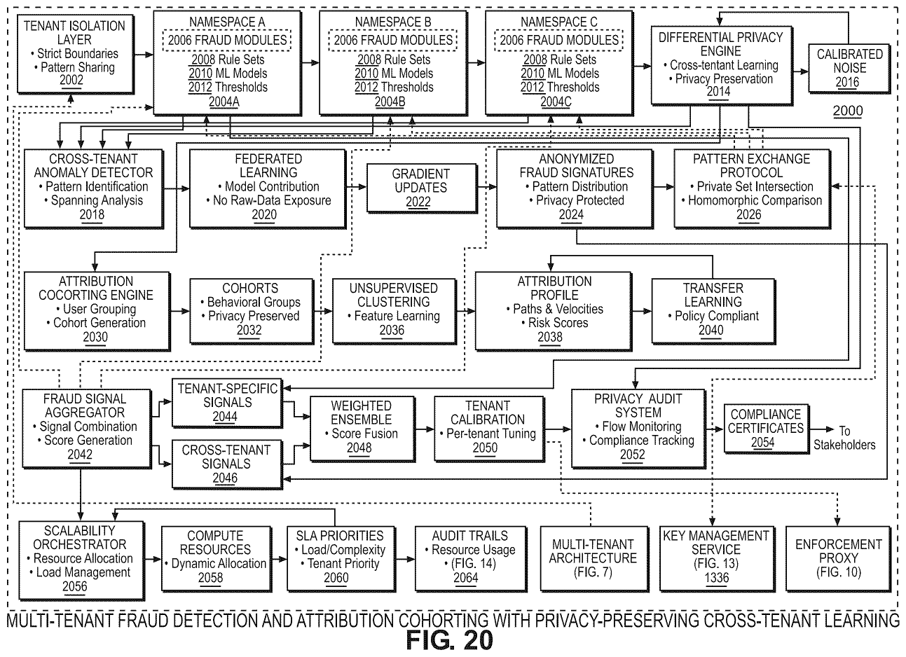

In an aspect of an embodiment of the present invention, Loyalty System [300] feeds directly into BQS Computation Core [916] (FIG. 9), transmitting its computed Loyalty Coefficients [304] as weighted inputs through the BQS Modification Pipeline [2000] (FIG. 20). Within this pipeline, the coefficients are combined with other behavioral and contextual signals to derive the final BQS values that determine bid amounts and qualification thresholds. High-value coefficients proportionally elevate BQS values through configurable multipliers, ensuring that advertising spend is directed toward verified, high-BQS user entities representing genuine engagement rather than transient or fraudulent traffic.

Personalization engine integration enables real-time content adaptation based on BQS values incorporating loyalty-weighted preference vectors, with the system selecting creative variants, messaging tone, and offer structures optimized for each BQS tier. High-BQS user entities (influenced by strong loyalty scores) receive premium experiences including reduced ad frequency, exclusive content access, and enhanced interactive features, while maintaining consistent brand safety and compliance standards.

The enforcement layer integration implements BQS-based access control incorporating loyalty signals, with the enforcement proxy [112] (FIGS. 1 & 10) blocking advertising spend for user entities with BQS values below configurable thresholds (where low loyalty contributes to low BQS). BQS scores incorporating loyalty are evaluated at enforcement checkpoints with low-latency overhead, ensuring real-time prevention without impacting bidding performance.

Example: High-value user receives enhanced experience through BQS recognition:
Step 1: A user entity with extensive engagement history and high loyalty contribution to BQS initiates a session. The loyalty token affecting BQS is validated rapidly via enterprise token service [1300] (FIG. 13).
Step 2: Personalization engine [200] (FIG. 2) recognizes the high BQS tier and implements premium treatment: ad frequency capping adjusted based on BQS, premium creative variants selected for high-BQS entities, and exclusive offers enabled.
Step 3: BQS Unity Framework [1200] (FIG. 12) ensures all system components recognize and prioritize high-BQS user experiences, with BQS thresholds adapted to reduce false-positive risk for validated high-value entities.
Step 4: Hybrid LLM/SLM router [104] (FIG. 1) dedicates appropriate resources based on BQS complexity scores to generate sophisticated, personalized responses for any conversational interactions.
Step 5: Bidding engine [300] (FIG. 3) applies BQS-proportional bid premiums for this user's impressions, reflecting their higher predicted lifetime value indicated by elevated BQS scores.
Step 6: Real-time behavioral signals show significantly higher engagement rates compared to baseline, validating the BQS-based optimization strategy and feeding back to the closed-loop optimization layer [1100] (FIG. 11) via ΔAQS learning signals.

Tokenized loyalty representations enable cross-platform BQS portability without identity leakage through a double-hashing scheme: platform-specific behavioral signals contributing to BQS are first hashed locally, then re-hashed with rotating salts during token generation via enterprise token service [1300] (FIG. 13), creating cryptographic separation between platforms while maintaining BQS continuity. Token refresh operations preserve BQS state while rotating cryptographic materials, preventing long-term tracking while maintaining BQS-based loyalty benefits.

The BQS-integrated loyalty scoring system maintains complete privacy compliance by generating loyalty tokens that contain only cryptographically hashed behavioral patterns contributing to BQS, never storing actual user identities or enabling cross-session tracking beyond ephemeral windows. BQS-influencing loyalty scores are computed from privacy-safe signals including session depth affecting BQS engagement metrics (without URLs), interaction patterns modulating BQS frequency (without specific content), and conversion events boosting BQS proximity scores (without transaction details). The system may use homomorphic encryption when aggregating loyalty signals for BQS calculation across sessions, ensuring individual session data cannot be extracted even by system operators. BQS-based loyalty tiers are determined through k-anonymity clustering ensuring sufficient group size, preventing individual identification through tier membership.

The privacy-compliant data flow ensures that raw behavioral signals never leave their originating platform, with only normalized, hashed vectors contributing to BQS transmitted to the loyalty scoring engine. This architecture implements privacy-by-design principles for BQS computation, with data minimization enforced at the protocol level and retention policies automatically purging signals older than configurable retention windows.

The loyalty system feeds directly into BQS computation engine [900] (FIG. 9), with high loyalty scores increasing BQS values through configurable multipliers, ensuring advertising spend is directed toward high-BQS user entities representing genuinely engaged audiences rather than transient or fraudulent traffic. The integration occurs through the BQS modification pipeline, where loyalty scores are combined with other behavioral signals to compute final BQS values determining bid amounts, as shown in the integration flow of FIG. 20.

The personalization engine integration enables real-time content adaptation based on BQS values incorporating loyalty-weighted preference vectors, with the system selecting creative variants, messaging tone, and offer structures optimized for each BQS tier. High-BQS user entities (influenced by strong loyalty scores) receive premium experiences including reduced ad frequency, exclusive content access, and enhanced interactive features, while maintaining consistent brand safety and compliance standards.

The enforcement layer integration implements BQS-based access control incorporating loyalty signals, with the enforcement proxy [112] (FIGS. 1 & 10) blocking advertising spend for user entities with BQS values below configurable thresholds (where low loyalty contributes to low BQS). BQS scores incorporating loyalty are evaluated at enforcement checkpoints with low-latency overhead, ensuring real-time prevention without impacting bidding performance.

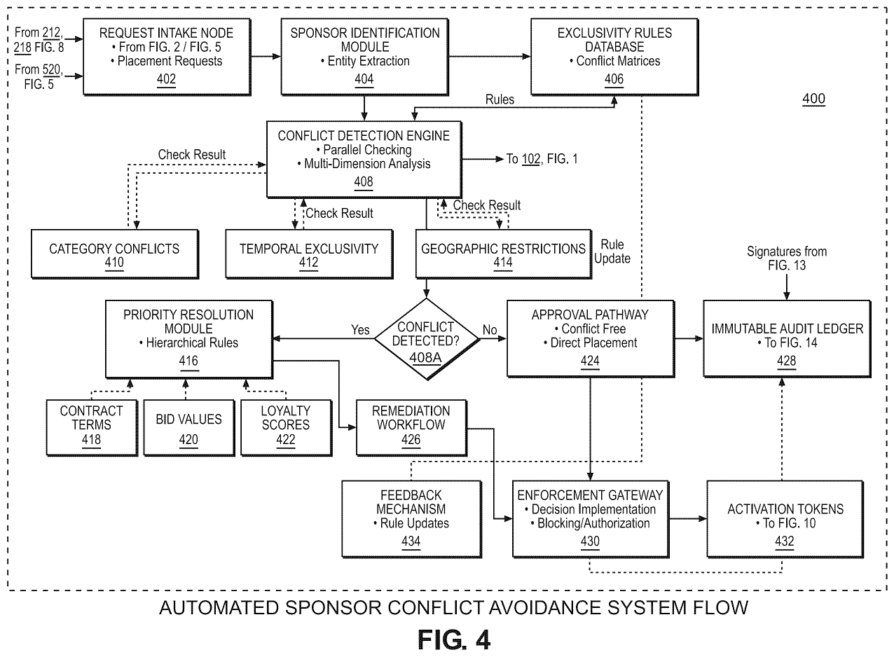

Referring now to FIG. 4, an automated sponsor conflict avoidance system [400] is shown according to aspects of embodiments of the present invention. In one aspect of an embodiment of the present invention, automated sponsor conflict avoidance system [400] depicts the conflict avoidance and exclusivity enforcement engine that prevents competing advertisers from appearing simultaneously and ensures sponsor exclusivity agreements are honored across all advertising channels. Automated sponsor conflict avoidance system [400] is characterized, in aspects of embodiments of the present invention, by the following components:

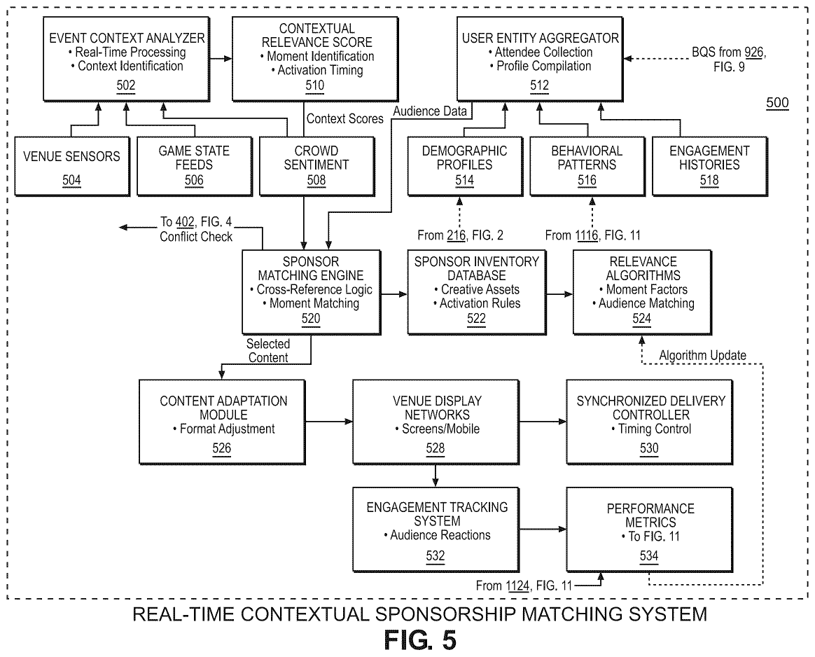

Request Intake Node [402] receives placement requests from Dynamic Content Selector [212] of personalization system [200] (FIG. 2) and Sponsor Matching Engine [520] of venue matching system [500] (FIG. 5). This node serves as the entry point for all advertising placement requests requiring conflict validation.

Sponsor Identification Module [404] extracts sponsor entity information from incoming requests, identifying the advertiser, campaign, and relevant exclusivity parameters associated with each placement request.

Exclusivity Rules Database [406] contains conflict matrices defining incompatible sponsor combinations, category-based exclusions, temporal exclusivity windows, and geographic restrictions. This database is continuously updated based on advertiser agreements and platform policies.

Conflict Detection Engine [408] performs parallel multi-dimensional checking across multiple conflict dimensions, evaluating each placement request against all active exclusivity rules simultaneously. Three parallel detection modules operate within the conflict detection engine:
Category Conflicts [410] checks for category-based incompatibilities (e.g., competing automotive brands);
Temporal Exclusivity [412] validates time-based exclusivity windows ensuring sponsors receive exclusive visibility during contracted periods; and
Geographic Restrictions [414] verifies location-based restrictions for regional campaigns and local exclusivity agreements.

If a conflict is detected, Priority Resolution Module [416] applies hierarchical rules to resolve conflicts when multiple sponsors compete for the same placement. This module considers multiple priority factors:
Contract Terms [418] evaluate contractual obligations and guaranteed impression commitments;
Bid Values [420] consider economic factors when contracts permit dynamic resolution; and
Loyalty Scores [422] factor in historical advertiser value and platform loyalty.

For conflict-free requests, Approval Pathway [424] enables direct placement without additional processing, minimizing latency for non-conflicting advertisements.

When conflicts are detected, Remediation Workflow [426] identifies alternative placement opportunities that satisfy the sponsor's campaign objectives without violating exclusivity agreements.

Immutable Audit Ledger [428] creates cryptographic logs of all conflict detection decisions using the token service (FIG. 13), ensuring complete accountability for exclusivity enforcement and feeding into the comprehensive audit system [1400] (FIG. 14).

Enforcement Gateway [430] implements the final blocking or authorization decision, either permitting the advertisement placement or blocking it based on conflict detection results.

Activation Tokens [432] are generated for approved placements and passed to the enforcement proxy [112] (FIGS. 1 & 10) for execution.

Feedback Mechanism [434] updates exclusivity rules based on observed outcomes and advertiser feedback, enabling continuous improvement of conflict detection accuracy and feeding into BQS Unity Framework [1200] (FIG. 12) for system-wide optimization.

In alternative aspects of embodiments of the present invention, automated sponsor conflict avoidance system [400] applies Boolean logic, constraint satisfaction, auctions, or game-theoretic resolution.

Referring now to FIG. 5, real-time contextual sponsorship matching system [500] is shown according to aspects of embodiments of the present invention. In one aspect of an embodiment of the present invention, real-time contextual sponsorship matching system [500] identifies optimal moments for sponsor activation in venue-based contexts, matching contextual opportunities with audience characteristics and sponsor objectives.

In another aspect of an embodiment of the present invention, Real-time contextual sponsorship matching system [500] identifies optimal moments for sponsor activation in venue-based contexts, matching contextual opportunities with audience characteristics and sponsor objectives.

In another aspect of an embodiments of the present invention, Real-time contextual sponsorship matching system [500] includes Event Context Analyzer [502] which processes real-time venue data to identify sponsorship opportunities, continuously monitoring venue conditions to detect optimal activation moments. Three primary input sources feed the context analyzer:
Venue Sensors [504] provide environmental data including crowd density, movement patterns, and ambient conditions;
Game State Feeds [506] deliver real-time updates on sporting events, concerts, or other venue activities; and
Crowd Sentiment Monitors [508] analyze collective audience emotional states through audio levels, movement patterns, and social media signals.

Real-time contextual sponsorship matching system [500] is further characterized, in aspects of embodiments of the present invention, by the following components:

Contextual Relevance Score [510], as computed by Relevance Algorithms [524] within FIG. 5, identifies optimal activation moments based on contextual signals. High relevance scores indicate moments of peak audience attention and engagement potential.

User Entity Aggregator [512] collects attendee information from multiple sources to build an aggregate audience profile, incorporating BQS values from Pre-Spend Behavioral Qualification Engine [900] (FIG. 9) to enhance audience qualification. All aggregation maintains privacy compliance by working with cohort-level data under k-anonymity groupings. User data sources include:
Demographics [514] provide aggregate audience composition without individual identification;
Behavioral Patterns [516] analyze collective audience behaviors and preferences; and
Engagement Histories [518] consider past interaction patterns with venue advertising.

Sponsor Matching Engine [520] cross-references contextual opportunities with audience profiles to identify optimal sponsor-content matches. This engine queries conflict avoidance system [400] (specifically Request Intake Node [402] of FIG. 4) to ensure selected sponsors do not violate exclusivity agreements.

Sponsor Inventory Database [522] contains creative assets, activation rules, and campaign parameters for all available sponsors. Each sponsor entry includes multiple content variants optimized for different contexts.

Relevance Algorithms [524] consider both moment factors (game state, crowd energy) and audience factors (demographics, preferences) to compute match scores for each sponsor-context combination.

Content Adaptation Module [526] adjusts content format and presentation for optimal display on available venue infrastructure, ensuring content is properly formatted for each display type.

Venue Display Networks [528] include both large-format screens and mobile delivery channels, enabling synchronized multi-channel activation across all venue touchpoints.

Synchronized Delivery Controller [530] controls timing to ensure coordinated content delivery across multiple displays, creating cohesive brand moments that maximize impact.

Engagement Tracking System [532] captures audience reactions including attention metrics, interaction rates, and sentiment changes following sponsor activation.

Performance Metrics [534] send output to the reconciliation system (FIG. 11) for closed-loop optimization via ΔAQS learning signals, enabling continuous improvement of matching algorithms based on measured outcomes and feeding back to BQS Unity Framework [1200][1200] (FIG. 12). This causal feedback ensures deterministic parameter adjustment within BQS Unity Framework [1200] (FIG. 12).

In alternative aspects of embodiments of the present invention, real-time contextual sponsorship matching system [500] analyzes events using computer vision, audio processing, NLP, or sentiment data.

Referring now to FIG. 6, an IoT-driven environmental content adaptation system is shown according to aspects of embodiments of the present invention. In one aspect of an embodiment of the present invention, IoT-driven environmental content adaptation system [600] adapts advertising content in real-time based on environmental sensor data, creating contextually relevant advertising experiences. IoT-driven environmental content adaptation system [600] is characterized, in aspects of embodiments of the present invention, by the following components:

DOOH (Digital-Out-Of-Home) Display Unit [602] serves as the primary content delivery mechanism for public advertising. These units range from billboard-sized displays to smaller street-level screens.

Integrated Sensor Array [604] collects environmental data from multiple sensor types, providing comprehensive context about current conditions around the display. Four primary sensor categories provide inputs: Weather Sensors [606], Traffic Monitors [608], Ambient Light Detectors [610], and Audio Level Meters [612] provide environmental intelligence:
Weather Sensors [606] monitor temperature, humidity, precipitation, and wind conditions;
Traffic Monitors [608] track vehicle and pedestrian flow patterns;
Ambient Light Detectors [610] measure lighting conditions for display optimization; and
Audio Level Meters [612] assess environmental noise levels affecting content audibility.

Local Edge Processor [614] runs inference models for immediate classification of environmental conditions. This processor, similar to SLM module [106] in FIG. 1, enables low-latency response to changing conditions without cloud communication delays.

Cloud Content Decisioning Platform [616] provides central processing and decision logic for content selection, coordinating multiple DOOH units and ensuring campaign consistency.

Secure API Gateway [618] protects communications using tokens from Token Lifecycle Manager [1336] (as described in FIG. 13), ensuring secure data transmission between edge devices and cloud infrastructure.

Environmental Analysis Engine [620] processes aggregated sensor data to identify current environmental states and predict optimal content strategies.

Content Selection Rules [622] define advertiser-specified parameters for content adaptation, including weather-based triggers, traffic thresholds, and time-of-day preferences. All rule evaluations are recorded in the Immutable Audit Ledger (FIG. 14) to ensure traceability.

Creative Asset Repository [624] stores multiple content variants optimized for different environmental conditions. Each campaign includes assets for various scenarios such as sunny weather, rain, high traffic, or low visibility.

Dynamic Content Selector [626], which receives conflict data from automated sponsor conflict avoidance system [400] (FIG. 4) and BQS values from Pre-Spend Behavioral Qualification Engine [900] (FIG. 9), matches current conditions with appropriate content variants based on three selection factors: Visibility Check [628], Audience Check [630], and Adjacency Check [632], which evaluate:
Visibility Conditions [628] ensure content remains viewable under current lighting and weather;
Audience Presence [630] verified through BQS thresholds from FIG. 9; and
Competitive Adjacency [632] checked against conflict rules from FIG. 4.

Rendering Engine [634] adapts display properties including brightness, contrast, color temperature, and resolution to optimize visibility under current conditions.

Performance Logs [636] record all display events, content selections, and environmental conditions to audit system [1400] of FIG. 14 for accountability and optimization.

In alternative aspects of embodiments of the present invention, IoT-driven environmental content adaptation system [600] incorporates diverse sensors and runs on edge processors, accelerators, or distributed clusters, as illustrated in FIG. 6 compliance sub-flow.

### Additional IoT Driven Environmental Content Adaptation System Operational Description

The system implements comprehensive GDPR compliance through BQS computation without personally identifiable information, using only ephemeral behavioral signals that rotate at privacy-compliant intervals. GDPR compliance features include BQS computation from anonymized signals, data portability of aggregated BQS metrics, and consent-based BQS threshold adjustments, as detailed in the compliance flow of FIG. 6.

CCPA compliance mechanisms provide California residents with required data access rights to their aggregated BQS values, opt-out capabilities from BQS-based targeting, and deletion of historical BQS data upon request. The system maintains separate consent states for BQS data collection, BQS computation, and BQS-based advertising decisions, with granular controls for each privacy right.

California Privacy Rights Act (CPRA) enhancements extend privacy protections through sensitive data category exclusion from BQS computation, automated risk assessments of BQS processing activities, and enhanced audit trails for all BQS-based decisions, proactively identifying and mitigating privacy risks in BQS operations before they result in compliance violations.

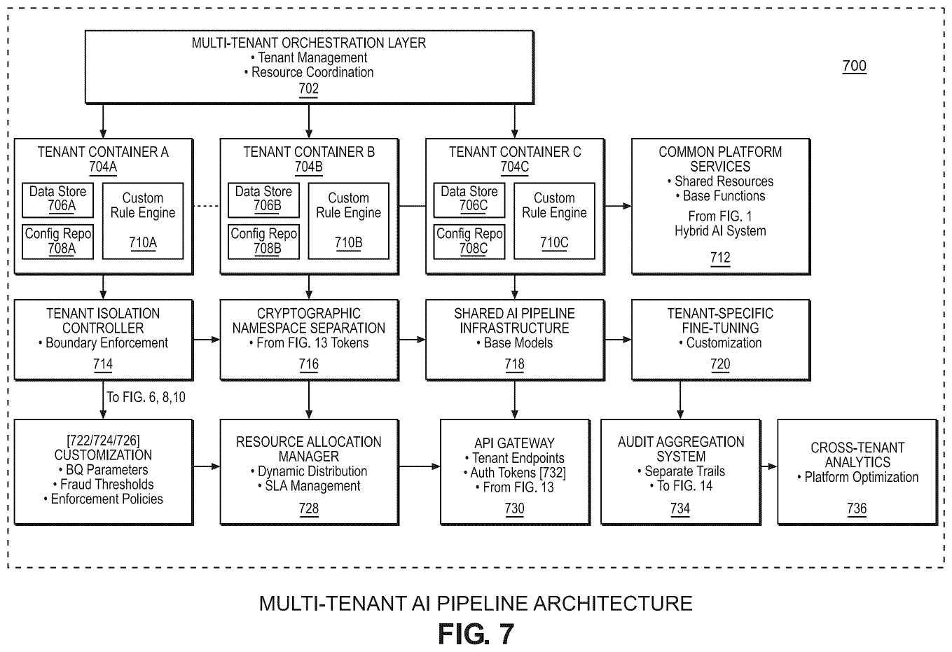

Referring now to FIG. 7, a multi-tenant AI pipeline architecture system [700] is shown according to aspects of embodiments of the present invention. In one aspect of an embodiment of the present invention, multi-tenant AI pipeline architecture system [700] enables isolated enterprise deployments while leveraging shared platform services, demonstrating how the system serves multiple organizations simultaneously without data commingling. Multi-tenant AI pipeline architecture system [700] may be characterized by the following:

Multi-Tenant Orchestration Layer [702] manages tenant containers and coordinates resource allocation across all client organizations, ensuring fair resource distribution while maintaining strict isolation boundaries.

Three representative Tenant Containers [704A/B/C] operate in complete isolation, each representing a different client organization. Each container maintains:
Data Stores [706] containing tenant-specific user profiles, campaign data, and historical metrics;
Config Repositories [708] storing tenant-specific settings, thresholds, and business rules; and
Custom Rule Engines [710] implementing tenant-specific business logic and decisioning criteria.

Common Platform Services [712] provide shared resources and base functionality derived from the hybrid AI system (FIG. 1). These services are stateless and process tenant data without storing it.

Tenant Isolation Controller [714] enforces strict boundaries between tenants, preventing any cross-tenant data access or interference. This controller implements multiple isolation mechanisms at network, compute, and storage layers.

Cryptographic Namespace Separation [716] ensures cryptographic isolation across tenant environments within the middleware system. The middleware system maintains cryptographic isolation between tenant environments through Cryptographic Namespace Separation [716], which may use tokens from the enterprise token service (FIG. 13) to ensure cryptographic isolation between tenant operations. Each tenant operates within its own cryptographic namespace, preventing cross-tenant data access or token reuse. This architecture preserves data sovereignty and security compliance while supporting multi-tenant scalability.

Shared AI Pipeline Infrastructure [718] provides base AI models and inference capabilities available to all tenants. These models are trained on anonymized, aggregated data to benefit all tenants without exposing individual tenant information.

Tenant-Specific Fine-Tuning [720] modules allow each tenant to customize AI models based on their unique requirements and historical data. Fine-tuning occurs within tenant boundaries without affecting other tenants. Three categories of customization parameters enable tenant-specific configuration:
BQS Parameters [722] configure BQS computation weights and thresholds (FIG. 9);
Fraud Thresholds [724] set tenant-specific fraud detection sensitivity (FIG. 8); and
Enforcement Policies [726] define tenant-specific enforcement rules (FIG. 10).

All parameters ultimately adjust the unified BQS scoring system, maintaining consistency while allowing customization.

Resource Allocation Manager [728] dynamically distributes computing resources based on tenant SLAs and current demand, ensuring each tenant receives guaranteed resources while efficiently utilizing spare capacity.

API Gateway [730] provides tenant-specific endpoints secured with Authentication Tokens [732] from the token service (FIG. 13). Each tenant accesses only their designated endpoints.

Audit Aggregation System [734] maintains separate audit trails per tenant while feeding the comprehensive audit system [1400] (FIG. 14), ensuring tenant-specific compliance while enabling platform-wide monitoring.

Cross-Tenant Analytics [736] enable platform-wide optimization by analyzing anonymized, aggregated patterns without exposing individual tenant data. These analytics improve the platform for all tenants while maintaining privacy.

In alternative preferred embodiments, multi-tenant AI pipeline architecture system [700] may use VMs, containers, serverless, or physical isolation.

### Additional Multi-Tenant AI Pipeline Architecture System Operational Descriptions

Each tenant data store [706] hosts an independent instance of User Entity Profile Store [206] described in FIG. 2. Each profile-store microservice maintains the behavioral attributes and engagement history for users associated only with that tenant and exposes its data exclusively through tenant-scoped interfaces. These per-tenant profile stores interact with the shared BQS computation and personalization services [712] via secure API calls authenticated by tokens from FIG. 13. Tenant Isolation Controller [714] and Cryptographic Namespace Separation [716] modules enforce that no behavioral data, identifiers, or scoring parameters from one tenant are accessible to another, thereby preserving strict privacy boundaries while still enabling cross-tenant optimization analytics [736] on anonymized, aggregated performance metrics.

The microservices architecture separates system functionality into independently deployable services that communicate through BQS-based APIs, enabling selective scaling, fault isolation, and independent deployment cycles while maintaining unified BQS orchestration. Core services include the BQS computation engine (FIG. 9), enforcement proxy [112] (FIGS. 1 & 10), hybrid LLM/SLM router [104] (FIG. 1), loyalty assessment service (FIG. 3), and audit logging system [1400] (FIG. 14), each maintaining its own data stores while sharing the unified BQS scoring methodology.

The system enforces strict data isolation between different advertisers (tenants) through cryptographic separation at the database level while maintaining unified BQS computation. Each tenant's data is encrypted with unique keys, stored in logically separated database schemas, and accessed only through tenant-specific API endpoints that validate BQS attestation tokens before data retrieval, with tenant-specific BQS calibration parameters as depicted in multi-tenant architecture [700] of FIG. 7.

Security measures include end-to-end encryption of all inter-service communication using TLS 1.3, API authentication through OAuth 2.0 flows with JWT tokens containing BQS attestations signed using Ed25519 cryptographic signatures, and comprehensive audit logging of all BQS-based decisions. The system implements defense-in-depth strategies with multiple security layers including network segmentation, application-level firewalls, BQS anomaly detection (FIG. 8), and immutable logging to Audit System [734] to identify potential security breaches through unusual scoring patterns.

The system maintains real-time latency appropriate for programmatic bidding environments with BQS computation optimized for low-latency execution through aggressive caching of BQS values, optimized BQS calculation pipelines, and parallel processing of BQS inputs. Latency optimization techniques include pre-computed BQS values stored in distributed caches, connection pooling for BQS database access, and asynchronous processing for non-critical BQS updates, as shown in the performance architecture of FIG. 9.

Horizontal scalability enables the system to handle high-throughput BQS computation capacity scaled by demand through stateless BQS calculation design, distributed BQS caching, and load balancing across multiple availability zones. Auto-scaling policies trigger new instance deployment based on observed processing thresholds and request queue depth indicators. These performance optimizations maintain deterministic control under the unified BQS feedback loop [1200] (FIG. 12).

Referring now to FIG. 8, an enhanced fraud detection and audit system [800] is shown according to aspects of embodiments of the present invention. In one aspect of an embodiment of the present invention, enhanced fraud detection and audit system [800] identifies and prevents fraudulent advertising activity through multi-layered analysis and machine learning, protecting advertisers from invalid traffic and bot activity.

Comprehensive Data Collection Layer [802] serves as the ingestion point for all signals relevant to fraud detection, aggregating diverse data streams for holistic fraud analysis. Four primary input signals feed the detection system:
Bid Streams [804] from hybrid AI system [100] (FIG. 1) provide bidding patterns and anomalies;
User Interactions [806] capture engagement patterns and behavioral sequences;
Device Fingerprints [808] from reconciliation system [1100] (FIG. 11) identify device characteristics; and
Network Patterns [810] reveal traffic sources and routing anomalies.

Real-Time Stream Processor [812] performs initial anomaly detection on incoming data streams, identifying obvious fraud patterns for immediate blocking while queuing suspicious activity for deeper analysis.

Statistical Baselines [814] provide reference patterns for normal behavior comparison. These baselines are continuously updated to reflect legitimate traffic evolution while maintaining fraud detection accuracy.

ML Classifiers [816] implement machine learning models that share infrastructure with hybrid AI system [100] (FIG. 1). These classifiers identify complex fraud patterns that evade rule-based detection.

Pattern Correlation Engine [818] identifies suspicious activity clusters by analyzing relationships between multiple signals, detecting coordinated fraud campaigns that might appear legitimate in isolation. Three types of pattern analysis operate in parallel:
Temporal Patterns [820] identify time-based anomalies such as traffic spikes or suspicious timing patterns;
Geographic Patterns [822] detect location-based fraud including GPS spoofing and impossible travel scenarios; and
Behavioral Consistency [824] checks against BQS profiles from FIG. 9 to identify behavioral anomalies.

Enhanced fraud detection and audit system [800] is further characterized by the following:
Risk Scoring Module [826] computes fraud probability scores for each interaction, combining multiple fraud indicators into a single risk metric.
Ensemble Models [828] combine multiple detection approaches for improved accuracy. The ensemble approach reduces false positives while maintaining high fraud catch rates.
Threshold Values [830] are configured per tenant through the multi-tenant system (FIG. 7), allowing each client to set their fraud tolerance levels.
Automated Blocking Actions [832] execute through the enforcement proxy [112](FIGS. 1 & 10) to prevent fraudulent requests from entering auctions. Blocking occurs in real time to prevent budget waste.
Cryptographic Audit Generator [834] creates tamper-proof records of all fraud detection decisions using tokens from FIG. 13. These records provide evidence for dispute resolution and compliance.
Immutable Ledger [836] stores fraud detection records with Hash Chain Verification [838] ensuring record integrity. This ledger provides an unalterable history of all fraud detection activities and feeds into comprehensive audit system [1400] (FIG. 14).
Compliance Reporting Module [840] generates regulatory documentation demonstrating fraud prevention measures. These reports satisfy advertiser requirements and industry standards.
Forensic Analysis Toolkit [842] enables post-incident investigation of fraud patterns. Security teams can analyze historical data to identify new fraud techniques and improve detection algorithms.

In alternative aspects of embodiments of the present invention, enhanced fraud detection and audit system [800] employs anomaly detection, machine learning ensembles, or collaborative threat intelligence, with responses including blocking, throttling, or manual review.

### Additional Enhanced Fraud Detection and Audit System Operational Descriptions

Cross-Tenant Fraud Detection System, shown in architecture [1400] of FIG. 14, implements sophisticated BQS anomaly detection algorithms that identify suspicious BQS patterns across multiple tenant environments while maintaining strict data isolation. The system analyzes BQS distributions, engagement patterns affecting BQS, and user entity BQS trajectories to detect potential fraud or system abuse.

BQS Anomaly Detection Framework: Fraud detection system [800] utilizes machine learning models trained on historical BQS patterns to identify deviations from normal BQS distributions. Detection algorithms include time-series analysis for BQS velocity anomalies (rapid BQS changes indicating manipulation), clustering algorithms for identifying synthetic user entities with artificial BQS patterns, and statistical outlier detection for BQS values inconsistent with observed behaviors, as illustrated in the detection pipeline of FIG. 14.

Cross-Tenant BQS Analytics: While maintaining complete data isolation between tenants, system [800] generates anonymized aggregate BQS insights that improve fraud detection accuracy across the platform. Cross-tenant BQS pattern recognition identifies coordinated fraud attempts through synchronized BQS anomalies, distributed bot networks through clustered low-BQS entities, and emerging attack vectors through novel BQS manipulation patterns without exposing individual tenant data or user entity information. Data isolation is mathematically enforced through homomorphic encryption techniques that allow BQS pattern detection across encrypted tenant datasets without decryption, differential privacy mechanisms that add calibrated noise to BQS distributions preventing individual tenant identification within bounded privacy budgets, and cryptographically separated key spaces where each tenant's BQS data is encrypted with hardware security module (HSM)-generated keys, as shown in the privacy architecture of FIG. 14.

Fraud detection system [800] identifies malicious activity through BQS anomalies without tracking individual users by analyzing BQS patterns at the cohort level using privacy-preserving analytics. The system processes anonymized BQS signals including request timing patterns affecting BQS velocity (without timestamps), geographic BQS distributions (region-level only), and BQS progression sequences (abstracted to pattern types). BQS-based fraud scoring may use secure multi-party computation where multiple parties can jointly compute fraud probabilities from BQS patterns without any party seeing the others' input data. The system maintains privacy even when detecting sophisticated attacks through techniques including private set intersection (identifying common BQS fraud patterns without revealing specific entities) and homomorphic encryption (computing on encrypted BQS data without decryption). All individual BQS signals expire at privacy-compliant intervals, with only aggregate BQS statistics retained for model training and fed back to BQS Unity Framework [1200] (FIG. 12) via ΔAQS learning signals.

Referring now to FIG. 9, a Pre-Spend behavioral qualification engine [900] is shown according to aspects of embodiments of the present invention. In one aspect of an embodiment of the present invention, Pre-Spend behavioral qualification engine [900] generates the unified BQS (Behavioral Qualification Score) metric driving all platform decisions, demonstrating the pre-spend prevention paradigm that eliminates waste before it occurs. Pre-Spend behavioral qualification engine [900] may be characterized by the following:

Signal Ingestion Interface [902] serves as the entry point for all behavioral signals entering the qualification system, handling high-volume data streams from multiple sources. Three primary signal sources provide behavioral data:
Web Properties [904] deliver website interaction data including page views, clicks, and dwell time;
Mobile Apps [906] provide app-based behavioral signals including session depth and feature usage; and
Connected Devices/IoT [908] contribute ambient behavioral indicators from smart TVs, voice assistants, and other connected devices.

Signal Normalization Module [910] standardizes diverse signal formats into a consistent structure. Within this module, the Unified Schema [912] (shown in dashed box) defines the standardized data format ensuring all signals are processed consistently regardless of source. In certain embodiments, the Signal Normalization Module standardizes diverse signal formats by converting heterogeneous input types into numerical feature values normalized to a bounded range (for example, between 0 and 1) to ensure consistent weighting across signal sources.

Signal Quality Assessor [914] validates signal integrity and filters out low-quality or suspicious data, ensuring only high-fidelity signals contribute to BQS computation.

BQS Computation Core [916] implements the primary scoring algorithms. Within this core, Weighted Scoring Algorithms [918] (shown in dashed box) apply sophisticated mathematical models to generate BQS values. The computation considers three primary scoring factors:
Engagement Depth [920] measures the intensity of user interactions;
Interaction Frequency [922] evaluates the consistency of engagement over time; and
Conversion Proximity [924] assesses the likelihood of near-term conversion.

BQS Values [926] represent the computed behavioral qualification scores that serve as the unified metric for all platform decisions, outputting to the hybrid AI system (FIG. 2), personalization engine (FIG. 3), and dynamic content optimization system (FIG. 5). These values are stored in High-Performance Cache [928] for low-latency access by downstream systems including the enforcement proxy [112] (FIGS. 1 & 10).

Threshold Comparison Module [930] evaluates BQS values against Advertiser Minimums [932] to determine qualification status. This comparison implements the pre-spend prevention paradigm by blocking unqualified traffic before bid submission.

A decision diamond routes traffic based on qualification status. Qualified requests proceed to Authorization Token Generator [934], which creates Cryptographic Permits [936] (shown in dashed box) using tokens from the enterprise token service [1300] (FIG. 13), serving as signed authorization tokens for downstream enforcement and audit logging (FIG. 14).

Non-qualified requests are routed to Blocking Notification Service [938], which logs rejections to the audit system [1400] (FIG. 14) and generates alerts for blocked traffic, providing feedback to advertisers about traffic quality.

Feedback Collector [940] receives performance data from the reconciliation system [1100] (FIG. 11), enabling continuous refinement of BQS computation algorithms based on actual outcomes via ΔAQS learning signals fed to BQS Unity Framework [1200] (FIG. 12).

In alternative aspects of embodiments of the present invention, Pre-Spend behavioral qualification engine [900] computes BQS values using neural networks, ensemble methods, temporal decay functions, Bayesian inference, or fuzzy logic. Thresholds may be static, dynamically learned, or consensus based. Engagement depth, interaction frequency, and conversion proximity may be calculated using smoothing, filtering, or predictive models.

BQS-Based Query Classification Pipeline: Incoming natural language queries undergo multi-stage BQS scoring as illustrated in FIG. 9: First, a lightweight tokenizer extracts basic features contributing to initial BQS calculation including length, vocabulary complexity, and special character patterns. Second, a trained classifier assigns a BQS component score from 0-100 based on query complexity. Third, domain detection adjusts BQS values upward for specialized knowledge requirements that benefit from LLM processing. Finally, urgency flags modulate BQS to enable low-latency SLM routing when time constraints override complexity considerations.

Referring now to FIG. 10, an enforcement proxy architecture system [1000] is shown according to aspects of embodiments of the present invention. In one aspect of an embodiment of the present invention, enforcement proxy architecture system [1000] sits between demand-side platforms and programmatic exchanges, implementing BQS-based qualification decisions to prevent unqualified bid submissions. Enforcement proxy architecture system [1000] may be characterized by the following:

Enforcement Proxy Layer [1002] which serves as the main intercept, evaluate, and modulate layer for all programmatic bid requests. This layer operates transparently to existing RTB infrastructure while enforcing qualification requirements. This non-bypassable middleware layer [1002] thereby establishes a middleware interception point functioning as a unified qualification gateway through which all bid traffic is evaluated prior to exchange submission.

DSP Systems [1004] represent demand-side platforms generating bid requests. These systems operate normally, unaware of the qualification enforcement occurring at the proxy layer.

Programmatic Exchanges [1006] represent the auction platforms where qualified bids compete for inventory. Only bids passing qualification reach these exchanges.

Within enforcement proxy layer [1002] is Request Interceptor [1008] captures all bid requests before they reach exchanges. Request Metadata Extract [1010], another component of enforcement proxy layer [1002], extracts relevant qualification data from intercepted requests.

Qualification Lookup Service [1012] retrieves pre-computed BQS scores from BQS Cache [1014] populated by system [900] of FIG. 9. This lookup occurs in microseconds to maintain RTB latency requirements.

Policy Evaluation Engine [1016] applies enforcement rules to determine bid eligibility. Within this engine, Policy Decision Point [1016A] makes the binary go/no-go determination for each bid request based on qualification scores and policy rules.

Enforcement Rules [1018] incorporate multiple policy dimensions including BQS thresholds, frequency caps, brand safety requirements, fraud signals from system [800] of FIG. 8, and conflict checks from system [400] of FIG. 4.

For requests failing policy evaluation, Request Blocking Module [1020] prevents bid submission to exchanges. Block Notifications [1022] alert DSPs and advertisers about blocked requests, providing transparency about enforcement actions.

Qualified requests proceed to Bid Enhancement Module [1024], which adjusts bid values based on Qualification Strength [1026] factors derived from loyalty system [300] of FIG. 3. Higher BQS scores can receive bid enhancements to improve auction competitiveness.

Modified Bid Constructor [1028] rebuilds enhanced bids maintaining RTB protocol compatibility while incorporating qualification enhancements.

Response Handler [1030] processes auction outcomes, tracking win rates and performance metrics for qualified bids. Enforcement Statistics [1032] feed the coordination framework (FIG. 12) for system optimization via ΔAQS learning signals.

All enforcement actions generate Cryptographic Proof Records [1034] using tokens from system [1300] of FIG. 13 and storing records in audit system [1400] of FIG. 14, ensuring complete accountability for enforcement decisions.

In alternative aspects of embodiments of the present invention, enforcement proxy architecture system [1000] is implemented via API gateways, service meshes, network filters, or SDK integrations. Blocking may occur through network resets, HTTP responses, DNS filtering, or bid-level modulation using linear, logarithmic, or machine-learned functions.

### Additional Enforcement Proxy Architecture System Operational Descriptions

In an aspect of an embodiment of the present invention, Enforcement Proxy Architecture System [1000] implements adaptive BQS thresholds that adjust routing decisions based on current system load and response time requirements. When system latency approaches defined operational thresholds, the router automatically raises BQS thresholds for LLM routing, directing more queries to SLMs based on adjusted BQS cutoffs, as shown in the latency management flow of FIG. 10.

Predictive BQS modeling may use historical performance data to estimate processing time for different BQS ranges before routing occurs. The model considers how BQS values correlate with resource utilization, queue depths for different BQS tiers, model warm-up states for BQS ranges, and network conditions to predict response times with high correlation between BQS and observed performance outcomes.

Emergency fallback mechanisms ensure system availability by progressively raising BQS thresholds to route more traffic to simpler models when latency exceeds critical limits. The fallback hierarchy adjusts BQS routing thresholds progressively: High-BQS to LLM→Medium-BQS to Large SLM→Low-BQS to Small SLM→Cached responses for repeat BQS patterns→Static defaults for near-zero-BQS requests.

BQS Feedback Integration: Fraud detection results feed directly into BQS computation engine [900] (FIG. 9), adjusting BQS values in real-time based on detected anomalies and preventing fraudulent user entities from achieving qualification through manipulated BQS scores. Detection events trigger automatic BQS-based enforcement actions including user entity blocking for BQS values below fraud thresholds, campaign suspension for anomalous BQS patterns, and alert generation for manual review of suspicious BQS trajectories.

As originally described in the provisional middleware enforcement proxy, Enforcement Proxy Architecture System [1000] operates as a non-bypassable middleware layer positioned between demand-side platforms and supply-side inventory sources, intercepting all bid requests and responses to enforce BQS-based pre-spend qualification requirements in real-time. The enforcement proxy processes bidstream traffic with low latency appropriate for programmatic environments through optimized packet inspection of BQS values, parallel processing of BQS evaluations, and predictive caching of BQS qualification decisions, as depicted in the enforcement architecture of FIG. 10. This non-bypassable middleware layer thereby establishes a middleware interception point functioning as a unified qualification gateway through which all bid traffic is evaluated and authorized prior to exchange submission.

The activation-time control mechanism evaluates each bid request against BQS thresholds incorporating multiple factors including behavioral qualification scores as the primary metric, loyalty contributions to BQS, fraud indicators affecting BQS, brand safety signals modulating BQS, and contextual appropriateness adjusting BQS values, making deterministic allow/block decisions based on unified BQS evaluation before bid submission. Unlike industry solutions that provide pre-bid signals or post-campaign reports, this BQS-based middleware enforcement physically prevents bids with insufficient BQS values from entering the auction, achieving true pre-spend prevention through BQS gating rather than advisory detection.

The pre-spend BQS qualification system as depicted in FIG. 9 includes behavioral signal ingestion engine [902], BQS computation engine [916], threshold enforcement module [930], and BQS-based activation authorization module [934] for implementation of the claimed functionality.

BQS-based enforcement decisions are computed using policy-driven logic that combines rule-based filters applying BQS floors for known fraud patterns, threshold-based gates requiring minimum BQS scores for bid submission, probabilistic assessments adjusting BQS requirements based on risk, and cryptographic validation of BQS attestation tokens (FIG. 13) for authorized entities. The decision engine evaluates BQS policies in parallel across multiple processing cores, achieving consistent low-latency BQS decisions even under peak loads with high request volumes.

Referring now to FIG. 11, a signature-based reconciliation and closed-loop feedback system [1100] is shown according to aspects of embodiments of the present invention. In one aspect of an embodiment of the present invention, signature-based reconciliation and closed-loop feedback system [1100] validates post-activation outcomes against pre-spend qualifications, creating the closed-loop feedback mechanism that continuously improves BQS accuracy. In one aspect of an embodiment of the present invention, signature-based reconciliation and closed-loop feedback system [1100] may be characterized by the following:

Engagement Beacons [1102] deployed across advertising channels capture Interaction Events [1104] representing actual user engagements with advertisements. Each event includes a Unique Signature [1106] cryptographically linking it to Original Qualification [1108] decision that authorized the advertisement.

Beacon Collector Service [1110] aggregates signals from multiple beacon sources including display channels from systems [200], [500], and [600] of FIGS. 2, 5, and 6, respectively. This service handles high-volume event streams while maintaining event ordering and integrity.

Behavioral Fingerprinting Module [1112] generates Device-Specific Identifiers [1114] that enable cross-session correlation without storing PII. These identifiers feed fraud detection system [800] of FIG. 8 to identify suspicious patterns.

Historical Profiles [1116] provide baseline behavior patterns for comparison, while Pattern Anomalies [1118] flag deviations from expected behavior that might indicate fraud or model drift.

Reconciliation Engine [1120] compares actual outcomes with Expected Behaviors [1122] predicted by the qualification engine. This comparison identifies systematic differences between predictions and reality.

A decision component evaluates whether significant discrepancies exist between expected and actual outcomes. When discrepancies are detected, Score Adjustment [1124] mechanism computes correction factors that flow to Closed-Loop Controller [1126].

The closed-loop controller implements feedback to the qualification engine [900] of FIG. 9, adjusting BQS computation parameters to improve future prediction accuracy via ΔAQS learning signals. This feedback mechanism ensures the system continuously learns from outcomes and maintains deterministic control under BQS Unity Framework [1200] (FIG. 12).

All reconciliation activities generate Immutable Audit Records [1128] using cryptographic tokens from FIG. 13 and storing in audit system [1400] of FIG. 14. These records provide evidence of closed-loop optimization.

Performance metrics flow to both sponsorship matcher [500] of FIG. 5 and the coordination framework [1200] of FIG. 12, enabling system-wide optimization based on reconciliation insights.

In alternative aspects of embodiments of the present invention, signature-based reconciliation and closed-loop feedback system [1100] may use tags, postbacks, or blockchain transactions, with feedback loops employing control systems or adaptive learning.

### Additional Signature-Based Reconciliation and Closed Loop Feedback System Operational Descriptions

In an aspect of an embodiment of the present invention, system [1100] utilizes BQS confidence scoring algorithms which evaluate model outputs to determine response reliability in relation to input BQS values, triggering escalation to more powerful models when confidence falls below BQS-adjusted thresholds. Each model response includes confidence metrics weighted by input BQS scores, incorporating output token probabilities, semantic coherence relative to BQS expectations, and fact verification scaled by BQS importance, as illustrated in the confidence flow of FIG. 11.

BQS Threshold Calibration: Confidence thresholds are continuously calibrated based on BQS performance feedback using reinforcement learning from engagement outcomes at different BQS levels. Thresholds vary by BQS-indicated query importance: higher confidence thresholds for high-BQS factual queries, proportionally lower thresholds for medium-BQS creative tasks, and dynamic thresholds for low-BQS conversational responses based on BQS context patterns.

Multi-Model BQS Consensus: For high-value decisions or transactions characterized by elevated BQS values (including significant bid amounts, content moderation requirements, or fraud detection with anomalous BQS patterns), system [1100] invokes multiple models in parallel and may use BQS-weighted voting to achieve consensus, improving reliability for high-value BQS determinations while accepting increased processing overhead.

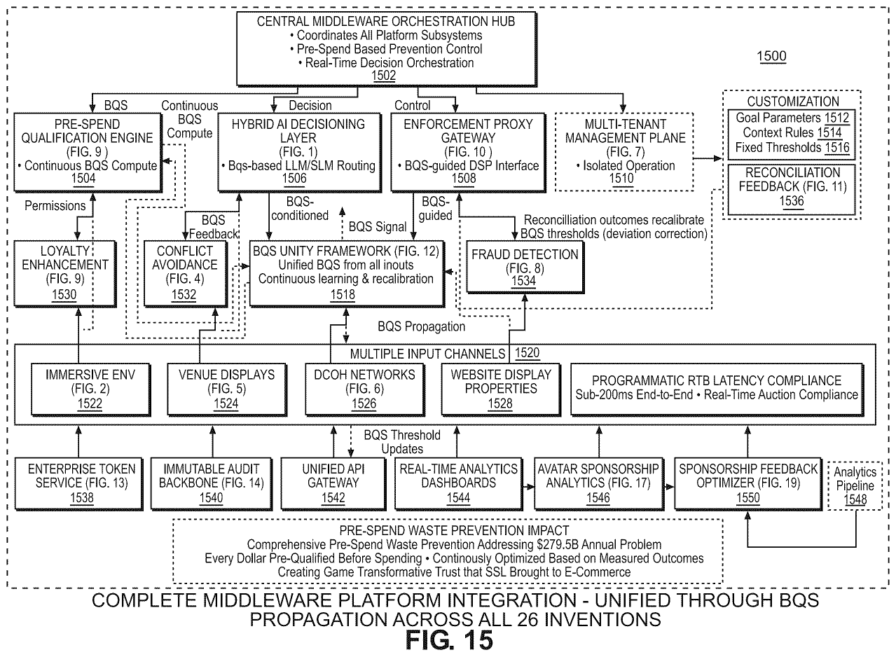

In an aspect of an embodiment of the present invention, Signature-Based Reconciliation System [1100], as depicted in FIG. 15's closed-loop flow, implements closed-loop BQS verification capabilities that ensure advertising spend reaches genuinely qualified user entities through post-engagement validation of BQS predictions, providing cryptographic proof of BQS-based advertising effectiveness without relying on personally identifiable information or privacy-invasive tracking mechanisms.

Engagement Beacon Deployment: System [1100] deploys lightweight engagement beacons within digital advertising creatives, post-click web environments, and mobile application surfaces to capture data for BQS reconciliation. These beacons capture behavioral interaction data that validates original BQS scores including dwell time, scroll depth, click patterns, hover duration, and gesture recognition events. Beacon deployment utilizes JavaScript tags for web-based BQS validation, mobile SDK integration for native application BQS tracking, and server-to-server APIs for headless BQS verification scenarios, as illustrated in the beacon architecture of FIG. 11.

Behavioral Fingerprint Reconciliation for BQS Validation: Captured engagement data is processed through behavioral fingerprinting algorithms that create non-PII signatures for BQS score verification. The reconciliation process compares post-engagement behavioral patterns against original BQS predictions using temporal sequence matching to validate BQS accuracy, probabilistic cohort inference for BQS refinement, and rule-based compliance verification of BQS thresholds without revealing individual user identities, following the reconciliation flow shown in FIG. 11.

Immutable BQS Audit Trail Generation: All BQS reconciliation events generate cryptographically signed audit records using Ed25519 signatures (FIG. 13), creating tamper-resistant proof of BQS validation. Audit records include correlation identifiers linking pre-spend BQS qualification decisions to post-engagement verification outcomes, enabling complete accountability for BQS-based advertising effectiveness and regulatory compliance reporting. All records are stored in the immutable audit system [1400] (FIG. 14).

The Qualified Attribution Score (QAS) Computation extends the BQS reconciliation system by generating quantitative metrics that validate BQS-based pre-spend qualification decisions against actual post-engagement outcomes. The QAS computation engine receives engagement signals from reconciliation beacons including dwell time contributing to QAS calculation, scroll depth validating BQS-predicted engagement, interaction events confirming BQS qualification accuracy, and conversion indicators proving BQS effectiveness. These signals are normalized and weighted according to advertiser-defined importance factors that feed back into BQS refinement via ΔAQS learning signals, with conversion events having higher weight for BQS adjustment than passive engagement metrics.

The QAS formula incorporates temporal decay to validate BQS predictions across attribution windows: QAS values are computed using weighted signal aggregation with time-based decay factors, ensuring recent engagements contribute more strongly to BQS validation while still crediting longer-term brand impact on BQS accuracy. The QAS values provide continuous feedback for BQS calibration, with higher QAS values confirming accurate BQS predictions and lower QAS values triggering BQS algorithm refinement. The system maintains rolling averages of QAS scores per BQS tier, enabling predictive modeling of BQS accuracy for different qualification levels.

The BQS-QAS Reconciliation Process creates a closed feedback loop where BQS predictions are continuously validated and refined through QAS measurements. When a QAS is computed for an impression that had a pre-spend BQS value, the system calculates the deviation between predicted BQS and actual QAS outcomes. Significant deviations trigger automatic recalibration of BQS computation weights: if BQS consistently overestimates engagement (QAS lower than BQS), the system adjusts BQS weighting parameters to reduce predictive signal importance and increase historical behavior weight; conversely, if BQS underestimates (QAS higher than BQS), the system increases BQS sensitivity to real-time signals.

In an aspect of an embodiment of the present invention, Reconciliation engine maintains a correlation matrix tracking BQS-QAS relationships across different segments including device types affecting BQS accuracy, time periods influencing BQS predictions, content categories impacting BQS reliability, and user cohorts with varying BQS-QAS correlations. Machine learning models identify patterns where BQS predictions systematically deviate from QAS outcomes, generating automated adjustments to BQS computation algorithms via ΔAQS learning signals. The reconciliation process directly influences BQS Unity Framework [1200] (FIG. 12): high BQS-QAS correlation indicates accurate BQS computation requiring minimal adjustment, while low correlation triggers enhanced BQS analysis through more sophisticated processing. All BQS-QAS reconciliation events generate immutable audit records (FIG. 14) proving the closed-loop validation process, with cryptographic signatures making retroactive modification computationally infeasible under standard cryptographic assumptions.

Referring now to FIG. 12, a mathematical coordination framework system [1200] is shown according to aspects of embodiments of the present invention. In one aspect of an embodiment of the present invention, mathematical coordination framework system [1200] transforms four independent system variables into a single unified BQS metric, demonstrating how complex multi-variable coordination becomes elegant single-metric orchestration for pre-spend waste prevention in digital advertising. In an aspect of an embodiment of the present invention, mathematical coordination framework system [1200] may be characterized by the following:

BQS Unity Matrix [1202] which serves as the central command center where all system intelligence converges. This matrix implements the dimensional reduction that simplifies system coordination from managing four independent variables to orchestrating a single unified score.

System Variables [1204] which represent the four primary inputs to BQS computation:
U (User Engagement) from system [200] of FIG. 2 which captures interaction depth and quality from immersive personalization systems;
M (Model Efficiency) from system [100] of FIG. 1 which represents AI routing effectiveness through the hybrid LLM/SLM decisioning system;
E (Enforcement Strictness) from system [1000] of FIG. 10 which indicates qualification threshold levels applied by the enforcement proxy; and
C (Content Relevance) from system [500] of FIG. 5 which measures contextual match quality from the real-time sponsorship matching engine.

BQS Computation Equation [1206] which implements the core mathematical relationship:

BQS=αU+βM+γE+δC
where α+β+γ+δ=1 and all variables are normalized to [0,1].
   This equation performs dimensional reduction from 4D variable space to 1D BQS space, enabling unified system coordination through a single metric.

The BQS computation operates as follows: each input variable (U, M, E, C) is first normalized to the range [0,1] through standard scaling techniques. Weighting Coefficients [1208] (α, β, γ, δ) are derived from per-tenant business objectives and must satisfy the constraint α+β+γ+δ=1 to ensure consistent BQS output scaling. For example, with coefficients α=0.25, β=0.25, γ=0.30, 6=0.20 and inputs U=0.9, M=0.8, E=0.6, C=0.7, the resulting BQS=0.25(0.9)+0.25(0.8)+0.30(0.6)+0.20(0.7)=0.74.

Alternative aspects of embodiments of the present invention include nonlinear transformations such as BQS=tan h(αU+βM+γE+δC) for sigmoid scaling, or BQS=(αU×βM×γE×δC)\hat{ }(¼) for geometric mean computation, enabling different mathematical relationships while maintaining the unified coordination principle.

Flexible Signal Configuration: Alternative embodiments compute BQS using at least two of the four signal types (U, M, E, C), with weighting coefficients normalized to sum to unity regardless of the number of active signal sources. This flexibility enables deployment scenarios where not all signal types are available or applicable, while maintaining the unified BQS computational framework. For example, a simplified deployment might compute BQS using only user engagement (U) and enforcement strictness (E), with coefficients α and γ constrained such that α+γ=1. An alternative embodiment contemplates the unified BQS value resulting from the transformation of signal categories comprising at least user-engagement metrics and at least one of model-efficiency, enforcement-strictness, or content-relevance.

Dependency Graph [1210] shows the execution sequence through four critical transformation stages that implement the BQS-driven processing pipeline:
Qualification Engine [1212] (FIG. 9) generates initial BQS scores through the T1: Score→Action transformation, receiving behavioral signals and computing unified qualification metrics;
Enforcement Proxy [1214] (FIG. 10) applies BQS thresholds through the T2: Action→Model transformation, blocking requests with insufficient BQS values before budget commitment;
AI Decisioning System [1216] (FIG. 1) routes to LLM/SLM processing through the T3: Model→Verify transformation, using BQS complexity indicators to optimize resource allocation; and
Reconciliation Module [1218] (FIG. 11) verifies outcomes and feeds back to the system, completing the closed-loop learning cycle.

BQS Feedback Transformations [1220] process the T4: BQS Update Transform, implementing closed-loop learning that continuously improves BQS computation accuracy via ΔAQS learning signals. When reconciliation identifies systematic differences between predicted BQS values and actual engagement outcomes, the feedback system automatically adjusts the weighting coefficients (α, β, γ, δ) to improve future prediction accuracy.

The optimization layer operates through the following coordinated components:
Constraint Solver [1222] applies boundary conditions including BQS Min/Max Limits [1224] to ensure the system operates within valid ranges, preventing extreme BQS values that could destabilize operations;
Optimization Engine [1226] implements an Objective Function [1228] that maximizes BQS performance while maintaining Stability [1230] constraints through dampening factors that prevent oscillation;
Sensitivity Analyzer [1232] evaluates how changes in each input variable impact overall BQS values, identifying critical dependencies and optimization opportunities for coefficient adjustment; and
Parameter Tuning [1234] performs configuration updates across all system components based on optimization results, ensuring the entire platform benefits from BQS refinements through the solid feedback connection to the BQS Computation Equation [1206].

BQS Unity Framework [1200] represents a fundamental architectural advancement by replacing the complexity of coordinating four independent variables (U, M, E, C) with the elegance of optimizing a single unified BQS metric. This approach ensures that improvements to the BQS computation automatically benefit all subsystems-fraud detection, personalization, enforcement, and reconciliation-through unified scoring rather than isolated optimization that may create conflicts.

The framework enables convergent optimization where all subsystems work toward the common goal of waste prevention through BQS qualification. Unlike conventional architectures where subsystems optimize independently and may conflict with overall objectives, the BQS Unity approach ensures that every component optimization enhances the unified metric, creating a self-improving ecosystem that prevents advertising waste through coordinated BQS-based pre-spend enforcement.

The mathematical precision of the BQS equation, combined with the closed-loop feedback optimization and parameter tuning connections, demonstrates that the claimed invention is technically enabled and provides concrete implementation guidance for a person of ordinary skill in the art to practice the invention without undue experimentation.

In alternative aspects of embodiments of the present invention, mathematical coordination framework system [1200] applies linear, non-linear, stochastic, or quantum optimization.

Referring now to FIGS. 11 through 12, in aspects of embodiments of the present invention, additional operational descriptions of each disclosed system follows:

IoT Sensor Data Ingestion: The system ingests real-time environmental and contextual data from Internet of Things (IoT) sensors including crowd density monitors, weather stations, traffic sensors, retail foot-traffic counters, and ambient condition detectors to enhance BQS computation with physical-world context, as illustrated in the IoT integration architecture of FIG. 6. IoT data streams are processed through edge computing nodes that normalize sensor readings, apply temporal smoothing algorithms to eliminate noise, and generate location-specific BQS modifiers that update at configurable adaptive intervals.

Environmental Context Processing for BQS Enhancement: IoT sensor data directly influences Behavioral Qualification Scores through dynamic BQS adjustment based on environmental conditions. For example, the system adjusts BQS thresholds during detected high foot-traffic periods to capture increased engagement opportunities, modulates BQS fraud sensitivity during known public events to reduce false positives, and modifies BQS expectations based on weather patterns to account for environmental impact on user behavior. The IoT integration maintains low-latency BQS processing through distributed stream processing and selective sensor sampling based on relevance scoring algorithms that prioritize sensors within proximity of target advertising locations.

Sensor Fusion for BQS Reliability: Multiple IoT sensors are fused using filtering techniques to produce reliable BQS environmental adjustments even when individual sensors fail or provide conflicting data. The system assigns confidence weights to each sensor based on historical accuracy, maintenance records, and cross-validation with nearby sensors for BQS computation reliability. When sensor confidence falls below operational thresholds, the system automatically applies historical BQS baselines for that location and time period, ensuring continuous BQS-based operation without degradation in qualification accuracy.

The BQS Unity Coordination Engine implements the unified scoring equation: BQS=f(U, M, E, C)×Weighting Coefficients, across all subsystem interactions, as depicted in the coordination flow of FIG. 12. The framework transforms multiple input parameters into the single BQS metric that orchestrates all system decisions.

Subsystem BQS Integration: Each major subsystem contributes to and responds to the unified BQS metric in specific ways. The loyalty-based bidding system [300] (FIG. 3) contributes loyalty values that influence BQS computation weights, while the conflict avoidance and exclusivity logic (FIG. 4) adjusts BQS thresholds based on sponsor relationship constraints. The enforcement proxy system [1000] (FIG. 10) modulates BQS parameters through compliance feedback, the pre-spend qualification engine (FIG. 9) refines BQS algorithms based on behavioral verification results, and the IoT sensor integration (FIG. 6) adjusts BQS values based on environmental context.

Real-Time BQS Updates: The BQS computation is evaluated continuously as new data arrives and system state changes occur. When user entity loyalty scores increase, the BQS values increase accordingly, which shifts routing preferences toward appropriate model selection and adjusts enforcement thresholds to protect premium user experiences. Conversely, when enforcement actions detect fraudulent activity (FIG. 8), BQS anomaly patterns trigger adjustments that shift processing toward more sophisticated analysis. IoT sensor inputs (FIG. 6) create additional BQS modulation, with high crowd density increasing BQS values for location-based opportunities and adverse weather conditions adjusting BQS expectations appropriately.

BQS Convergence Optimization: BQS Unity Framework [1200] is designed to converge toward optimal scoring values within bounded parameter spaces and exhibits stability characteristics that support reliable system behavior. BQS convergence monitoring systems track score changes and dynamically adjust weighting coefficients via ΔAQS learning signals to maintain system stability while optimizing overall platform performance across all integrated subsystems. In operation, the system approaches operational equilibrium between competing objectives (revenue maximization, fraud prevention, user experience) within adaptive stabilization periods following state changes under typical deployment conditions.

Example: BQS Unity Framework in operation during a high-traffic e-commerce event. The system begins with baseline BQS values reflecting moderate engagement levels. When IoT sensors detect significant crowd density increases at a retail location, this triggers adjustments to the BQS computation:
Initial State: The system maintains baseline BQS values across all user entities with standard weighting coefficients applied to the input parameters U (user engagement), M (model efficiency), E (enforcement), and C (content relevance).
Environmental Trigger: The crowd surge is detected by IoT sensors (FIG. 6), which feeds into the BQS computation as an environmental modifier, increasing the weight of engagement signals in the BQS calculation.
BQS Adjustment Process: The framework recalculates BQS values incorporating the environmental context, with higher crowd density increasing the engagement component weight, triggering appropriate model routing decisions based on adjusted BQS thresholds, and modifying enforcement strictness proportional to the new BQS distributions.

After the BQS recalculation process completes within acceptable processing timeframes, the system achieves new equilibrium BQS values that reflect the high-engagement environment. These adjusted BQS values trigger automatic system responses: bid adjustments proportional to increased BQS values for the retail location, routing system optimization based on the distribution of recalculated BQS scores, enforcement threshold adjustments to ensure quality during high-value periods, and fraud detection sensitivity calibration based on BQS anomaly patterns.

BQS Unity Framework [1200]'s effectiveness is demonstrated through coordinated improvements in system operation: advertising efficiency enhancement through better BQS-based targeting, system latency optimization through BQS-driven routing decisions, fraud prevention improvement through BQS anomaly detection, and maintained low false positive rates despite dynamic BQS adjustments. This example illustrates how the unified BQS metric creates coordinated optimization across all subsystems, validating the unified invention concept where all components work in concert through the single BQS score.

The middleware system implements comprehensive failure-handling mechanisms to maintain service continuity even during adverse conditions, including component faults, transient network errors, or resource saturation. These mechanisms include automatic retry logic, circuit-breaker controls, redundant service endpoints, and transaction rollback procedures to ensure consistent and reliable operation across all middleware subsystems.

The system implements comprehensive failure handling mechanisms to ensure continued BQS-based operation, compliance, and reliability under adverse conditions. These mechanisms include:

BQS Computation Anomalies:
Detection: A BQS monitor identifies unusual scoring patterns or computation failures;
Response: The system applies cached BQS values from recent computations;
Fallback: Historical BQS baselines from similar contexts are utilized; and
Recovery: Gradual BQS recalibration occurs over subsequent requests via ΔAQS learning signals.

Latency Target Breach:
Detection: Monitoring detects when BQS computation or routing exceeds latency thresholds;
Response: Circuit breaker mechanisms route to pre-computed BQS decision pathways;
Fallback: Cached BQS-based advertisement selections maintain service continuity; and
Recovery: Progressive re-enablement of real-time BQS processing as performance normalizes.

Model Unavailability:
LLM failure: BQS thresholds adjust to route all requests to SLM processing (FIG. 1);
SLM failure: Cached BQS decisions and rule-based fallbacks provide continuity;
Dual failure: Deterministic BQS-based policy selection maintains operation; and
Recovery: Automatic health checks and reconnection restore BQS-driven model routing.

BQS Framework Bounds:
BQS values are maintained within operational ranges to prevent extreme scores;
Dampening factors are applied to prevent BQS oscillation during adjustments; and
Emergency BQS reset triggers if scores remain at boundaries beyond acceptable durations.

Collectively, these mechanisms guarantee that the BQS-based system remains operational, privacy-compliant, and fraud-preventive even in failure conditions, prioritizing BQS accuracy and audit integrity over latency during degradation scenarios. All failure events are logged to the immutable audit system (FIG. 14) for traceability.

Referring now to FIG. 13, an enterprise token service architecture system [1300] is shown according to aspects of embodiments of the present invention. In one aspect of an embodiment of the present invention, enterprise token service architecture system [1300] depicts the comprehensive token service that provides cryptographic security for all platform operations, enabling secure multi-tenant isolation, authenticated communications, and tamper-proof audit trails. In aspects of embodiments of the present invention, enterprise token service architecture system [1300] may be characterized by the following:

Token Generation Core [1302] creates Cryptographically Secure Tokens [1304] using Asymmetric Encryption [1306] with rotating key pairs. This core ensures all tokens are cryptographically strong and unforgeable.

Tokens [1304] follow a JWT-Compliant Structure [1314] containing three essential components:
Identity Claims [1308] establish the entity requesting authorization;
Permission Scopes [1310] define allowed operations; and
Temporal Validity [1312] sets token expiration and validity windows.

Key Management System [1316] handles cryptographic key lifecycle including:
Key Rotation [1318] regularly refreshes encryption keys;
Revocation Lists [1320] invalidate compromised tokens; and
Emergency Recovery [1322] enables system recovery from key compromise.

Token Validation Gateway [1324] provides high-performance token verification with a Validation Cache [1326] for frequently accessed tokens. This gateway validates millions of tokens per second while maintaining microsecond latency.

Cross-System Federation Module [1328] enables secure communication between platform components through:
Token Exchange [1330] between different security contexts; and
Security Boundaries [1332] essential for multi-tenant isolation (FIG. 7).

Audit Trail Generator [1334] logs all token operations to the comprehensive audit system [1400] of FIG. 14, ensuring complete accountability for security operations.

Token Lifecycle Manager [1336] handles ongoing token operations including:
Automatic Renewal [1338] for long-running operations;
Expiration Processing [1340] to clean up expired tokens; and
Revocation Propagation [1342] across distributed systems.

External Identity Providers [1344] integrate with enterprise authentication systems through:
SAML/OAuth Bridges [1346] for standard protocol support; and
Authorization Policies [1348] mapping external identities to platform permissions.

System [1300] shows token distribution to six critical platform components: Enforcement Proxy of FIG. 10, Audit System of FIG. 14, Multi-Tenant Containers of FIG. 7, DOOH Edge Processors of FIG. 6, Venue Systems of FIG. 5, and Reconciliation of FIG. 11.

In alternative aspects of embodiments of the present invention, enterprise token service [1300] may use RSA, ECDSA, post-quantum signatures, zero-knowledge proofs, or distributed consensus protocols. Key management may involve HSMs, secure enclaves, or threshold schemes.

### Additional Enterprise Token Service Operational Descriptions

Enterprise Token Service [1300], as illustrated in FIG. 13, provides cryptographically secure BQS attestation and authorization capabilities across all system components, eliminating the need for repeated BQS validation and enabling secure cross-system BQS verification. The service implements a complete token lifecycle management system using Ed25519 cryptographic signatures to attest to BQS values and qualification decisions.

BQS attestation tokens upon successful BQS-based qualification or system component authentication. Each token contains encrypted payload data including BQS values, user entity identifiers (non-PII), permission scopes based on BQS tiers, expiration timestamps, and cryptographic signatures attesting to BQS computation integrity. The issuance process validates requesting entities against BQS thresholds and system authorization policies before token generation, following the authentication flow shown in FIG. 13.

Token Lifecycle Management: BQS attestation tokens progress through defined lifecycle stages including minting (initial creation with BQS value and cryptographic signing), validation (real-time BQS verification during system access), refresh (automatic renewal with updated BQS values before expiration), and revocation (immediate invalidation for BQS anomalies or policy violations). The lifecycle management system maintains token status in distributed cache systems with low-latency lookup performance for real-time BQS validation requirements, as depicted in the token lifecycle diagram of FIG. 13.

Cross-Service BQS Validation Integration: The token service integrates with the BQS-based enforcement proxy [1000] (FIG. 10) to provide seamless authentication across demand-side platforms, BQS computation engines (FIG. 9), and audit systems (FIG. 14). Each service validates BQS attestation tokens through cryptographic signature verification without requiring centralized BQS recalculation, improving system performance and reducing single points of failure in BQS verification.

Referring now to FIG. 14, a comprehensive audit and compliance system [1400] is shown according to aspects of embodiments of the present invention. In one aspect of an embodiment of the present invention, comprehensive audit and compliance system [1400] is the backbone that provides transparency and accountability across the entire platform, demonstrating how every BQS-driven decision creates an immutable audit trail. In an aspect of an embodiment of the present invention, comprehensive audit and compliance system [1400] may be characterized by the following:

Universal Event Collector [1402] which captures activities from All Platform Modules [1404], including qualification decisions (FIG. 9), enforcement actions (FIG. 10), reconciliation outcomes (FIG. 11), fraud detections (FIG. 8), token operations (FIG. 13), and tenant activities (FIG. 7).

Structured Logging Pipeline [1406] which processes raw events through:
Consistent Formatting [1408] ensuring uniform log structure; and
Metadata Enrichment [1410] adding context including tokens from FIG. 13.

Immutable Storage Layer [1412] which may use blockchain-inspired Hash Chains [1414], where each record includes a hash of the previous record, making tampering mathematically detectable.

Compliance Rule Engine [1416] which continuously evaluates platform operations against Regulatory Requirements [1418] including, without limitation, GDPR, CCPA, and industry-specific regulations. Rules are customizable per tenant through the multi-tenant system (FIG. 7).

When violations are detected, Automated Alerts [1420] notify appropriate stakeholders while Corrective Workflows [1422] update enforcement policies in FIG. 10 to prevent recurrence.

Report Generation Module [1424] which produces:
Scheduled Compliance Reports [1426] for regular audits; and
Ad-hoc Queries [1428] for investigations and forensic analysis.

Retention Management System [1430] which implements Data Lifecycle Policies [1432] respecting tenant-specific requirements from FIG. 7 while ensuring compliance with data retention regulations.

Cryptographic Verification Service [1434] which enables Third-Party Auditors [1436] to verify record integrity without accessing sensitive data, providing transparency while maintaining security.

Export Interface [1438] which provides Standardized Data Formats [1440] enabling integration with external compliance tools and enterprise audit systems.

In alternative aspects of embodiments of the present invention, comprehensive audit and compliance system [1400] employs blockchains, Merkle trees, append-only logs, or content-addressable storage.

The system emphasizes transparency and accountability as fundamental principles that transform the digital advertising industry into a trusted ecosystem where every decision is verifiable.

### Additional Comprehensive Audit and Compliance System Operational Descriptions

Edge processing pipelines, as enabled by Comprehensive Audit and Compliance System [1400], implement multi-stage data refinement for BQS: raw sensor readings are validated and normalized at edge gateways (FIG. 6), temporal patterns are extracted for BQS velocity calculations, spatial correlations are computed for location-based BQS adjustments, and final BQS context modifiers are generated using lightweight machine learning models. This edge-heavy architecture reduces network bandwidth significantly while maintaining BQS data freshness, with only aggregated BQS modifiers transmitted to the central BQS computation engine (FIG. 9) rather than raw sensor streams.

The IoT-enhanced BQS computation system [600] as illustrated in FIG. 6, includes IoT ingestion interface [604], BQS adjustment module [626], and display controller [634] providing the claimed elements. Edge processing for BQS enhancement and sensor integration are detailed below.

Sensor data influences BQS computation through contextual modulation: high crowd density increases BQS engagement weights to favor active audiences, extreme weather conditions adjust BQS expectations to account for environmental impact, and variable network connectivity shifts BQS routing thresholds toward appropriate model selection. These modulations are applied as factors to the base BQS computation, ensuring smooth BQS transitions as environmental conditions change.

IoT data processing for BQS maintains complete privacy compliance through edge anonymization, where sensor readings contributing to BQS are stripped of any potentially identifying information before aggregation, with no device IDs, MAC addresses, or location traces retained beyond the immediate BQS processing window. The system implements differential privacy at the edge with bounded privacy budgets when aggregating readings for BQS computation across multiple sensors, ensuring that individual movement patterns cannot be reconstructed from BQS context scores.

Federated learning at the edge enables BQS model improvement without centralizing sensitive data, where edge nodes collaboratively train BQS context prediction models using secure multi-party computation protocols that prevent any party from accessing raw training data. BQS model updates are encrypted, aggregated using homomorphic addition where applicable, and only decrypted after sufficient updates are combined from multiple edge nodes, ensuring that no individual sensor's contribution to BQS can be extracted from model parameters.

The retention and anonymization flow for BQS data ensures regulatory compliance through automatic data lifecycle management: raw sensor readings are discarded quickly at the edge, aggregated BQS context scores are retained temporarily for model training, and only statistical BQS summaries persist beyond that window. This aggressive data minimization, combined with cryptographic guarantees of anonymization, enables the BQS system to operate in privacy-strict jurisdictions while maintaining full contextual awareness for BQS computation.

The combined multi-tenant and IoT architecture demonstrates enterprise-grade BQS scalability, supporting numerous simultaneous tenants processing sensor events for BQS enhancement while maintaining low end-to-end latency appropriate for programmatic advertising. The system achieves this through horizontal scaling across three dimensions: tenant sharding for distributed BQS computation, geographic distribution of BQS edge processing near sensor sources, and functional decomposition with specialized clusters for different BQS processing stages.

BQS performance optimization techniques include predictive resource allocation based on historical BQS patterns, speculative execution of likely BQS updates, aggressive caching of stable BQS computations, and adaptive batching of related BQS operations. The system pre-computes BQS trajectories for common scenarios, enabling instant response to typical events while reserving computational power for anomalous situations requiring full BQS recalculation.

The unified BQS platform eliminates the inefficiencies of separate systems for advertising, IoT processing, and multi-tenant management, reducing infrastructure costs while improving performance through integrated BQS optimization. BQS Unity Framework [1200] (FIG. 12) ensures that resources are allocated optimally across all functions, with IoT context improving BQS accuracy, advertising revenue funding infrastructure, and multi-tenant isolation enabling secure shared BQS resources.

Multi-tenant and IoT capabilities strengthen the core BQS enforcement mechanism by providing richer qualification signals and ensuring fair enforcement across all advertisers, with tenant-specific BQS baselines preventing gaming and IoT-enhanced BQS preventing location-based fraud. The enforcement proxy (FIG. 10) evaluates both tenant-specific BQS policies and IoT-derived BQS modifiers in every decision, blocking impressions that fail either tenant BQS requirements or contextual BQS appropriateness checks.

Referring again to FIGS. 13 through 14, the enforcement system, in an aspect of an embodiment of the present invention, provides cryptographic proof of BQS-based enforcement through Ed25519-signed BQS attestation tokens issued for each allowed bid, creating an immutable audit trail that proves BQS-based pre-spend qualification was verified before budget commitment. Each BQS enforcement token contains the bid request identifier, BQS values at decision time, applied BQS policy version, and precise timestamp, all signed with the enforcement proxy's private key.

Referring now to FIG. 15, a complete middleware platform integration system is shown according to aspects of embodiments of the present invention. In one aspect of an embodiment of the present invention, middleware platform integration system [1500] presents a complete system-wide integration architecture operating as a unified middleware platform, demonstrating how the BQS metric orchestrates every component to achieve pre-spend waste prevention. In an aspect of an embodiment of the present invention, middleware platform integration system [1500] may be characterized by the following:

Central Middleware Orchestration Hub [1502] which serves as the master controller coordinating all subsystems through BQS-driven pre-spend waste prevention. This hub implements real-time decision orchestration while maintaining sub-200 ms RTB latency compliance. The core processing layer includes four essential components:

Pre-Spend Qualification Engine [1504] from FIG. 9 which continuously computes BQS values with a bidirectional feedback loop to BQS Unity Framework [1200][1518]. This bidirectional connection enables continuous learning and threshold optimization via ΔAQS learning signals.

Hybrid AI Decisioning Layer [1506] from FIG. 1 which routes requests between LLM and SLM models based on BQS complexity thresholds, optimizing resource utilization while maintaining decision quality.

Enforcement Proxy Gateway [1508] from FIG. 10 which serves as the DSP interface applying BQS-guided enforcement to prevent unqualified bid submissions.

Multi-Tenant Management Plane [1510] from FIG. 7 which enables isolated enterprise operations with tenant-specific customization through:
Goal Parameters [1512] defining business objectives;
Context Rules [1514] specifying operational constraints; and
Fixed Thresholds [1516] setting qualification boundaries.

BQS Unity Framework [1518] from FIG. 12 which replaces complex mathematical coordination with a unified BQS metric. This framework computes a single BQS value from engagement, efficiency, enforcement, and relevance variables. The bidirectional flow with the qualification engine creates continuous learning via ΔAQS signals, while reconciliation feedback (FIG. 11) enables threshold recalibration.

Supporting subsystems provide specialized functionality:
Loyalty Enhancement [1530] from FIG. 3 implements permission-based scoring;
Conflict Avoidance [1532] from FIG. 4 manages advertiser exclusivity;
Fraud Detection [1534] from FIG. 8 performs real-time fraud analysis; and
Reconciliation Feedback [1536] from FIG. 11 enables deviation correction.

Input Channels [1520] aggregate signals from:
Immersive Environments [1522] (FIG. 2);
Venue Displays [1524] (FIG. 5);
DOOH Networks [1526] (FIG. 6); and
Website Display Properties [1528].

Supporting infrastructure ensures security and accountability:
Enterprise Token Service [1538] from FIG. 13 which provides cryptographic security.
Immutable Audit Backbone [1540] from FIG. 14 which creates tamper-proof decision trails.
Unified API Gateway [1542] which offers single integration point for all platform services.
Real-Time Analytics Dashboards [1544] which enable live BQS performance monitoring.

Analytics and optimization components which include:
Avatar Sponsorship Analytics [1546] from FIG. 17;
Analytics Pipeline [1548] for data processing; and
Sponsorship Feedback Optimizer [1550] from FIG. 19.

The diagram shows critical operational flows including BQS propagation throughout the system, complete data integration across all components, maintained security and compliance, and real-time performance guaranteeing sub-200 ms RTB compliance.

The system addresses advertising waste by pre-qualifying every dollar through BQS scoring before spending, continuously optimizing based on measured outcomes via ΔAQS learning signals, and creating trust through cryptographically verifiable enforcement (FIG. 13, FIG. 14).

### Additional Middleware Platform Integration System Operational Descriptions

The complete system architecture, as shown in FIG. 15, integrates all components through BQS Unity Framework [1200] (FIG. 12), with the Enterprise Token Service (FIG. 13) providing secure BQS attestation, the Fraud Detection System (FIG. 8) ensuring traffic quality through BQS anomaly detection while maintaining strict tenant isolation, the Closed-Loop Reconciliation System (FIG. 11) verifying BQS prediction accuracy via ΔAQS learning signals, and the IoT Sensor Integration (FIG. 6) providing real-world context for BQS computation. The Enforcement Proxy (FIG. 10) ensures that BQS-based pre-spend qualification outcomes are enforced at activation time, preventing low-BQS impressions from entering the bidstream. This comprehensive BQS-unified integration creates a self-optimizing ecosystem that eliminates advertising waste through BQS-based pre-spend prevention rather than post-spend detection.

The closed-loop BQS verification extends across tenants and contexts, where post-engagement outcomes are analyzed not just for individual BQS performance but for cross-tenant BQS patterns and contextual BQS correlations. This enables the system to identify subtle fraud patterns that only emerge across multiple tenants or specific environmental conditions affecting BQS, continuously improving enforcement accuracy through BQS optimization via ΔAQS learning signals that incorporate these multi-dimensional insights.

The complete integration of multi-tenant BQS isolation (FIG. 7), IoT-enhanced BQS computation (FIG. 6), and BQS Unity Framework [1200] (FIG. 12) creates a paradigm shift in digital advertising infrastructure, transforming it from fragmented, reactive systems to a unified, BQS-driven platform that prevents waste through BQS qualification before it occurs while maintaining privacy compliance and enterprise scalability. This architectural approach, anchored in the unified BQS metric and closed-loop BQS enforcement, demonstrates that the disclosed inventions form a unified advancement in how digital advertising systems are designed, implemented, and operated at scale through BQS orchestration.

Middleware Platform Integration System [1500] operates on distributed computing infrastructure comprising commodity servers, cloud compute clusters, and edge processing nodes, with hardware components specifically selected to optimize BQS computation and BQS Unity Framework [1200] while maintaining low end-to-end latency appropriate for programmatic advertising. The infrastructure includes multi-core CPUs for general BQS computation, GPUs/TPUs for BQS-related machine learning inference, hardware security modules (HSMs) for cryptographic BQS attestations (FIG. 13), high-speed storage for BQS audit logs (FIG. 14), and low-latency network interfaces for BQS data communication.

Data persistence and caching layers for BQS operations utilize distributed caches for rapid BQS value access, time-series databases for behavioral data contributing to BQS, distributed storage for BQS audit logs, and object storage for long-term BQS data retention. The caching strategy implements multi-tier hierarchies optimized for BQS access patterns with in-memory BQS caches, distributed BQS cache clusters, and persistent BQS storage, ensuring that the majority of BQS requests are served from cache in typical deployments.

Container orchestration enables dynamic scaling of BQS computation resources and fault tolerance, with microservices processing BQS calculations packaged in containers that maintain immutable infrastructure principles. The deployment architecture spans multiple availability zones with active-active BQS replication, automatic failover preserving BQS state, and rolling updates maintaining BQS service continuity. Service mesh technology provides secure inter-service communication for BQS data, automatic retry logic for BQS operations, and circuit breakers preventing cascade failures in BQS processing.

Middleware Platform Integration System [1500] achieves comprehensive BQS performance targets in typical deployments, maintaining end-to-end processing latency below 200 milliseconds at the 99th percentile. Low end-to-end latency from bid request to BQS-based response ensures that behavioral qualification and enforcement decisions occur within programmatic time constraints. The platform incorporates asynchronous event handling, predictive caching, and real-time load balancing to sustain consistent latency performance under high-volume traffic conditions.

Throughput specifications enable processing of high volumes of BQS computations per node in typical deployments, with horizontal scaling supporting aggregate BQS throughput at scale across full cluster deployments. The system maintains these throughput levels while simultaneously processing IoT events for BQS enhancement, supporting concurrent tenant BQS sessions, and generating cryptographically signed BQS audit records for every transaction.

Scaling capabilities demonstrate efficient performance improvements as nodes are added, with BQS computation efficiency remaining high even at maximum scale. BQS Unity Framework [1200] (FIG. 12) automatically adjusts to maintain optimal performance as the system scales, shifting BQS processing strategies, caching policies, and enforcement thresholds based on current load patterns via ΔAQS learning signals without manual intervention.

Typical Deployment Specifications for BQS Operation: As used herein, the term “typical deployment” refers to a representative production configuration of the BQS system that balances performance, cost, and operational feasibility. The specifications described below provide baseline conditions under which the claimed BQS performance characteristics are achieved.

Hardware Configuration for BQS Processing:
Enterprise-grade multi-core processors for BQS computation;
Substantial system memory for BQS caching;
High-bandwidth network interfaces for BQS data transfer; and
Fast storage systems for BQS persistence.

Software Stack for BQS Operations:
Container orchestration for BQS microservices;
Distributed cache layer for BQS values;
Time-series database for BQS history; and
Messaging infrastructure for BQS events.

Operating Conditions for BQS:
Sustained request volumes requiring continuous BQS computation;
Geographic distribution affecting BQS latency;
Low network latency to exchange endpoints for BQS decisions; and
Multiple concurrent tenants with isolated BQS processing.

Performance Characteristics Under Typical BQS Deployment:
End-to-end BQS-based decision latency appropriate for RTB;
BQS computation within programmatic timing requirements;
BQS enforcement decisions at low latency; and
Fraud detection through BQS anomalies with minimal overhead.

Edge Cases: For large-scale environments with extreme request volumes, multi-region BQS deployments, or numerous concurrent tenants, the system remains operational but may engage graceful BQS degradation strategies as previously described with respect to graduated fallback strategies, error recovery mechanisms, and graceful degradation protocols. These strategies ensure continuity of BQS-based service by prioritizing BQS accuracy and privacy compliance over latency in extreme conditions.

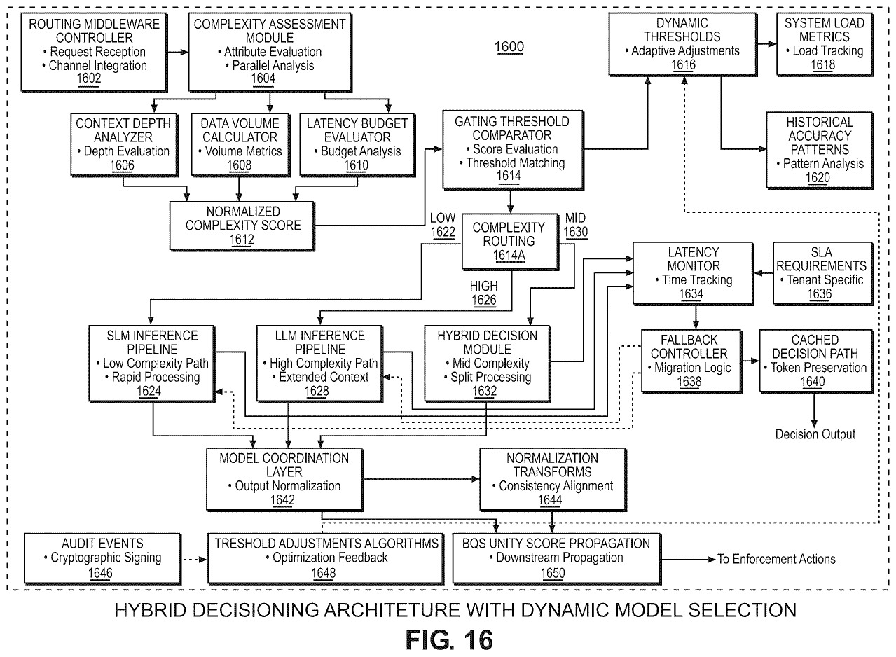

Referring now to FIG. 16, a hybrid decisioning system architecture [1600] is shown according to aspects of embodiments of the present invention. In one aspect of an embodiment of the present invention, hybrid decisioning system architecture [1600] represents the sophisticated routing architecture that dynamically selects between inference models based on request complexity, demonstrating intelligent resource allocation for optimal latency-quality tradeoffs. In an aspect of an embodiment of the present invention, hybrid decisioning system architecture [1600] may be characterized by the following:

Routing Middleware Controller [1602] receives incoming requests and initiates the complexity assessment process. This controller serves as the entry point for all inference requests requiring model selection.

Complexity Assessment Module [1604] which employs three parallel analyzers:
Context Depth Analyzer [1606] which evaluates the contextual richness required for decision-making;
Data Volume Calculator [1608] which measures the amount of data requiring processing; and
Latency Budget Evaluator [1610] which determines available processing time based on RTB constraints.

These analyzers converge to produce Normalized Complexity Score [1612] that quantifies request difficulty on a standardized scale.

Gating Threshold Comparator [1614] which evaluates the complexity score against Dynamic Thresholds [1616] that adapt based on:
System Load Metrics [1618] monitoring current resource utilization; and
Historical Accuracy Patterns [1620] tracking model performance overtime.

A routing decision determination which directs requests to three possible paths:
Low Complexity [1622] routes to SLM Inference Pipeline [1624] for efficient processing;
High Complexity [1626] routes to LLM Inference Pipeline [1628] for sophisticated analysis; and
Mid Complexity [1630] routes to Hybrid Decision Module [1632] combining both approaches.

Latency Monitor [1634] which tracks processing times from all pipelines, comparing against SLA Requirements [1636] to ensure compliance with RTB timing constraints.

Fallback Controller [1638] which provides resilience by migrating execution between models or utilizing Cached Decision Path [1640] when latency constraints are at risk.

Model Coordination Layer [1642] which normalizes outputs from all pipelines using Normalization Transforms [1644] to ensure consistency regardless of which model processed the request.

Audit Events [1646] which log all routing decisions for cryptographic signing (FIG. 13, FIG. 14), while Threshold Adjustment Algorithms [1648] optimize gating thresholds overtime through ΔAQS feedback loops.

BQS Unity Score Propagation [1650] which represents the final output where dynamically routed complexity assessments converge into a single unified BQS score that propagates to enforcement actions throughout the system via BQS Unity Framework [1200] (FIG. 12).

Referring now to FIG. 17, an avatar sponsorship analytics engine [1700] is shown according to aspects of embodiments of the present invention. In one aspect of an embodiment of the present invention, avatar sponsorship analytics engine [1700] presents a system for measuring sponsorship effectiveness in immersive virtual environments, transforming avatar behaviors into actionable sponsorship metrics. In an aspect of an embodiment of the present invention, avatar sponsorship analytics engine [1700] may be characterized by the following:

Session Tracking Orchestrator [1702] which initiates monitoring when users enter immersive environments. Tracking Containers [1704] capture three essential data streams:
Avatar Identifiers [1706] for unique session identification;
Session Timestamps [1708] for temporal tracking; and
Environmental Context [1710] for venue/event classification.

Gesture Capture Module [1712] which processes avatar movements through Motion Pattern Analyzers [1714] using neural networks to recognize meaningful gestures and interactions.

Gaze Tracking System [1716] which monitors viewport orientation to determine:
Attention Targets [1718] identifying what users observe;
Dwell Time [1720] measuring attention duration; and
Heat Maps [1722] visualizing aggregate attention patterns.

Attribution Matrix Generator [1724] which combines behavioral signals with environmental context to produce Multi-dimensional Attribution Scores [1726] across three dimensions:
Exposure Duration [1728] for quantifying visibility time;
Interaction Depth [1730] for measuring engagement intensity; and
Conversion Proximity [1732] for assessing purchase likelihood.

Sponsor Performance Calculator [1734] which aggregates attribution across User Cohorts [1736] segmented by demographics, behavior, and loyalty levels. Weighted Attribution Models [1738] account for multi-touch journeys across channels.

Real-time Visualization Engine [1740] which generates Interactive Dashboards [1742] displaying three primary KPIs:

Qualified Reach [1744] showing BQS-qualified audience size;
Engagement Velocity [1746] tracking interaction rates over time; and
Attributed Conversions [1748] measuring campaign effectiveness.

Beacon Correlation [1750] which matches immersive interactions with downstream engagement events, while Cryptographic Signing [1752] ensures audit integrity via the token service (FIG. 13).

Programmatic Latency Constraints [1754] which maintain real-time operation for bidding decisions, ensuring analytics don't impact RTB performance.

Referring now to FIG. 18, a loyalty-weighted bidding engine [1800] is shown according to aspects of embodiments of the present invention. In one aspect of an embodiment of the present invention, loyalty-weighted bidding engine [1800] illustrates a sophisticated bidding system which incorporates a token economy for loyalty tier management, demonstrating how genuine engagement translates into bidding advantages. In an aspect of an embodiment of the present invention, loyalty-weighted bidding engine [1800] may be characterized by the following:

Loyalty Token Ledger [1802] which maintains Token Balances [1804] on a distributed append-only ledger. Verified Engagements [1806] from the reconciliation system (FIG. 11) ensure only genuine interactions earn tokens.

Tier Progression Calculator [1808] which evaluates token accumulation against Tier Thresholds [1810] and Progression Curves [1812] customized per advertiser, determining user advancement through loyalty tiers.

Bid Adjustment Formula Processor [1814] which combines three inputs:
Base Bid Values [1816] for setting the starting bid amount;
Loyalty Tier Multipliers [1818] for providing tier-based enhancements; and
BQS Enhancement Factors [1820] from behavioral qualification scores.

Adjusted Bid Formula [1822] which explicitly shows:

AdjustedBid=BaseBid×(1+LoyaltyMultiplier×BQS/100)×SeasonalityFactor×InventoryScarcity

Coefficient Optimization Module [1824] which continuously refines multipliers using Gradient-Based Methods [1826] to optimize for conversion objectives via ΔAQS learning signals.

Loyalty Token Integration Layer [1828] which enables three redemption paths:
Token Redemption [1830] for direct value exchange;
Exclusive Content Access [1832] for premium experiences; and
Bid Priority Elevation [1834] for auction advantages.

Distributed Ledger [1836] which records all transactions with cryptographic verification via the token service (FIG. 13). The Tier Migration Engine [1838] processes Advancement & Demotion Events [1840] based on engagement velocity and recency.

Advanced Targeting Controls [1842] which allow advertisers to set:
Tier-Specific Frequency Caps [1844] for varying exposure limits by tier;
Creative Variants [1846] with tier-appropriate messaging; and
Conversion Attribution Windows [1848] adjusting measurement periods by tier.

Performance Feedback Loop [1850] which correlates tier-adjusted bids with Conversion Outcomes [1852], feeding both the coefficient optimization module via ΔAQS learning signals and coordination framework (FIG. 12).

All decisions generate Immutable Audit Records [1854] in the audit system (FIG. 14), while the multi-tenant architecture (FIG. 7) enables per-advertiser customization.

Referring now to FIG. 19, a sponsorship feedback optimizer [1900] is shown according to aspects of embodiments of the present invention. In one aspect of an embodiment of the present invention, sponsorship feedback optimizer [1900] with reinforcement learning and closed-loop control is the adaptive optimization system using reinforcement learning and control theory to continuously improve sponsorship effectiveness based on measured outcomes. In an aspect of an embodiment of the present invention, sponsorship feedback optimizer [1900] may be characterized by the following:

Performance Data Aggregator [1902] which collects outcomes from three sponsorship channels: Immersive Analytics (FIG. 17), Venue Sponsorships (FIG. 5), and DOOH Campaigns (FIG. 6). Each outcome record captures Sponsor Identifiers [1904], Content Variants [1906], Audience Segments [1908], and Engagement Metrics [1910] validated through the reconciliation system (FIG. 11).

QAS Deviation Calculator [1912] which performs systematic error analysis comparing Predicted Scores [1914] from the qualification engine (FIG. 9) with Actual Outcomes [1916], identifying prediction accuracy gaps.

Reinforcement Learning Module [1918] which employs Online Approaches [1920] including Deep Q-Networks and Contextual Bandits, utilizing Experience Replay [1922] to learn from historical interactions.

Category-Specific Value Functions [1924] which implement Shared Base Layers [1926] for common features and Distinct Heads [1928] for category specialization. Mini-batch Training [1930] enables continuous learning with feedback to the RL module.

Closed-Loop Adjustment Controller [1932] which receives both RL outputs and deviation signals, employing PID-Style Loops [1934] for stable control adjustments. The controller modulates three parameters:
Thresholds [1936] for adjusting qualification boundaries;
Weights [1938] for tuning scoring factors; and
Timing Parameters [1940] for optimizing temporal aspects.

Dampening Factors [1942] which ensure stability and prevent oscillation in parameter adjustments.

Performance Database [1944] which stores multi-dimensional metrics across Sponsor Metrics [1946], Creative [1948], Audience [1950], and Context [1952] dimensions.

Anomaly Detector [1954] which identifies unusual patterns and flags potential fraud to FIG. 8. The Optimization State Manager [1956] maintains Checkpoints [1958] and Config Snapshots [1960] for rollback capability.

Cryptographic Logging [1962] which creates immutable audit trails in the audit system (FIG. 14), ensuring complete accountability for optimization decisions. All parameter adjustments feed back to BQS Unity Framework [1200] (FIG. 12) via ΔAQS learning signals.

### Additional Operational Descriptions for Cross-Platform Architecture System:

In an aspect of an embodiment of the present invention, Cross-Platform Architecture System [1900] implements a user entity abstraction layer (which may represent an avatar, persona, or profile depending on the platform context) that provides unified behavioral representation for BQS computation across diverse digital environments without requiring personally identifiable information. The user entity abstraction maintains platform-agnostic behavioral vectors that contribute to BQS calculation through interaction patterns, engagement metrics, and qualification signals regardless of whether the underlying representation is a 3D avatar in a virtual world, a hashed profile in e-commerce, or a loyalty token in connected television environments, as illustrated in the cross-platform architecture of FIG. 19.

Each user entity may be characterized by multi-attribute behavioral vectors that feed into BQS computation comprising appearance preferences, interaction patterns, contextual behaviors, and historical engagement signals, all represented as cryptographically hashed or tokenized values that preserve privacy while enabling sophisticated BQS-based personalization. These vectors include temporal engagement patterns influencing BQS velocity components, content affinity scores affecting BQS content relevance weights, behavioral consistency metrics modulating BQS reliability factors, and contextual adaptation indicators adjusting BQS environmental parameters, with each attribute normalized for BQS mathematical processing.

The vector transformation pipeline processes raw behavioral signals for BQS computation through multiple stages: signal collection from platform-specific APIs contributing to BQS inputs, normalization to remove platform biases from BQS calculation, dimensionality reduction optimizing BQS computation efficiency, and final encoding into privacy-preserving tokens containing BQS values. The transformation maintains mathematical properties necessary for BQS processing while ensuring no reverse engineering to individual identity is possible, achieving both BQS analytical utility and privacy compliance simultaneously.

The personalization engine achieves user-specific BQS customization without any PII through a privacy-preserving vector approach where user preferences contribute to BQS computation as anonymous behavioral vectors in a high-dimensional embedding space. These vectors are generated using locality-sensitive hashing that maps similar behaviors to proximate BQS values while preventing reverse engineering to actual behavior sequences. BQS-based personalization decisions use only the vector distance metrics for score calculation, never accessing underlying behavioral data. The system implements federated learning where BQS models are refined on-device (when applicable) with only model gradients shared centrally, ensuring raw behavioral data contributing to BQS never leaves the user's environment. Content recommendations are generated through BQS thresholds with differential privacy mechanisms preventing individual preference extraction.

Referring now to FIG. 20, a multi-tenant fraud detection and attribution cohorting system [2000] is shown according to aspects of embodiments of the present invention. In one aspect of an embodiment of the present invention, multi-tenant fraud detection and attribution cohorting system [2000] enables platform-wide fraud detection and attribution while maintaining strict tenant isolation and mathematical privacy guarantees. In an aspect of an embodiment of the present invention, multi-tenant fraud detection and attribution cohorting system [2000] may be characterized by the following:

Tenant Isolation Layer [2002] which serves as the primary control point, maintaining strict boundaries while orchestrating controlled pattern sharing mechanisms.

Three representative Namespaces [2004A/B/C] which operate in complete isolation, each containing:
Fraud Modules [2006] for implementing tenant-specific detection logic;
Custom Rule Sets [2008] tailored to business models;
ML Models [2010] trained on tenant-specific data; and
Configurable Thresholds [2012] adjusted per requirements.

Differential Privacy Engine [2014] which enables cross-tenant learning while guaranteeing mathematical privacy bounds. Calibrated Noise [2016] ensures differential privacy guarantees are maintained.

Cross-Tenant Anomaly Detector [2018] which identifies fraud patterns spanning multiple tenants using privacy-preserved data. Federated Learning [2020] enables models to contribute knowledge without sharing underlying data through Gradient Updates [2022].

Anonymized Fraud Signatures [2024] which capture fraud patterns without revealing tenant-specific information. Pattern Exchange Protocol [2026] distributes signatures using private set intersection and homomorphic comparison methods, integrated with the key management service (FIG. 13).

Attribution Cohorting Engine [2030] which groups users into Cohorts [2032] based on behavioral patterns while maintaining privacy. Unsupervised Clustering [2036] identifies natural groupings in privacy-preserved feature spaces.

Attribution Profiles [2038] which contain user journey paths, engagement velocities, and risk scores, all computed without individual user identification. Transfer Learning [2040] enhances profiles by applying knowledge across cohorts within privacy constraints.

Fraud Signal Aggregator [2042] which serves as the central scoring engine, receiving:
Tenant-Specific Signals [2044] from individual namespaces; and
Cross-Tenant Signals [2046] from collective intelligence.

Weighted Ensemble [2048] which combines signals using learned weights, with Tenant Calibration [2050] applying per-tenant adjustments.

Privacy Audit System [2052] which continuously monitors data flows, tracking privacy budget consumption and generating Compliance Certificates [2054] for stakeholders.

Scalability Orchestrator [2056] which manages Compute Resources [2058] based on processing load and SLA Priorities [2060], generating Audit Trails [2064] of all resource allocation decisions.

In an aspect of an embodiment of the present invention, the architecture achieves the complex balance of enabling platform-wide fraud prevention and intelligent attribution while maintaining enterprise-grade tenant isolation, mathematical privacy guarantees, and complete regulatory compliance. All fraud detection results feedback to BQS Unity Framework [1200] (FIG. 12) via ΔAQS learning signals to improve BQS computation accuracy.

### Additional Multi-Tenant Fraud Detection and Attribution Cohorting System Operational Descriptions

The loyalty token lifecycle supporting BQS computation, as operating within the Multi-Tenant Fraud Detection and Attribution Cohorting System [2000], progresses through defined stages including minting (initial token generation with BQS contribution values), validation (real-time BQS verification during platform interactions), refresh (periodic BQS update incorporating new loyalty scores), and revocation (immediate BQS adjustment upon fraud detection or policy violation), as illustrated in the token lifecycle diagram of FIG. 20. Each lifecycle transition generates cryptographically signed audit events documenting BQS state changes.

Token minting occurs upon first user entity BQS qualification, with the initial loyalty contribution to BQS computed from available historical signals or set to configurable defaults for new entities. The minting process generates a unique token identifier for BQS tracking, encrypts the loyalty payload affecting BQS, signs the token with the system's private key for BQS attestation via the enterprise token service (FIG. 13), and registers the token in the distributed cache for rapid BQS validation. Minted tokens include metadata specifying applicable platforms for BQS calculation, valid use contexts for BQS application, and permission scopes for BQS-based decisions.

Token refresh operations maintain BQS accuracy through continuous recalculation incorporating recent loyalty signals, with refresh frequency adapted to user entity activity levels affecting BQS volatility (highly active entities with rapidly changing BQS refreshed frequently, dormant entities with stable BQS refreshed less often). The refresh process preserves token identity while updating BQS contributions, rotating cryptographic materials for security, and extending expiration timestamps for continuity, ensuring seamless BQS-based loyalty continuity without service interruption.

### Non-Limiting, Additional, Exemplary Aspects of Embodiments of the Present Invention

In an aspect of an embodiment of the present invention, elements of the contemplated invention identified as Bid Request Interface [102], Routing Controller [104], LLM/SLM Inferences [106-108], Coordination Engine [110], Enforcement Proxy [112] may be seen to operate as modules which are self-contained services executing routing and decisioning prior to spend.

In an aspect of an embodiment of the present invention, elements of the contemplated invention identified as Routing Decision [104A], Threshold Comparator [114] may be seen to operate as functions which are control and comparison logic within modules.

In an aspect of an embodiment of the present invention, elements of the contemplated invention identified as Rendering Engine [202], BQS Module [210], Dynamic Content Selector [212], Adaptation Controller [218] may be seen to operate as modules which are executable personalization engines driven by BQS signals.

In an aspect of an embodiment of the present invention, elements of the contemplated invention identified as Profile Processor [206], Feedback Analyzer [214] may be seen to operate as functions which are sub-routines operating within Sponsorship Feedback Optimizer [210].

In an aspect of an embodiment of the present invention, elements of the contemplated invention identified as Tier Determination [302], Adjustment Engine [310], Composite Scoring Module [318], Validation Gateway [320] may be seen to operate as modules which are compute units determining loyalty-weighted bids.

In an aspect of an embodiment of the present invention, elements of the contemplated invention identified as Coefficient Updater [314], Score Combiner [316] may be seen to operate as functions which perform processes or steps within BQS Unity Integration Module [318].

In an aspect of an embodiment of the present invention, elements of the contemplated invention identified as Request Intake [402], Conflict Detection Engine [408], Priority Resolver [416], Enforcement Gateway [430] may be seen to operate as hostable modules preventing ad/sponsor conflicts pre-auction.

In an aspect of an embodiment of the present invention, elements of the contemplated invention identified as Category/Geo/Temporal Checks [410-414] may be seen to operate as elements or sub-modules which are functional detectors embedded in Conflict Detection Engine [408].

In an aspect of an embodiment of the present invention, elements of the contemplated invention identified as Event Analyzer [502], Matching Engine [520], Selector [526], Delivery Controller [530] may be seen to operate as modules which operate as matching and delivery coordination engines.

In an aspect of an embodiment of the present invention, elements of the contemplated invention identified as Relevance Algorithm [524], Performance Metric [534] may be seen to operate as functions which are operational routines within Matching Engine [520].

In an aspect of an embodiment of the present invention, elements of the contemplated invention identified as Sensor Array [604], Edge Processor [614], Decisioning Platform [616], Dynamic Selector [626] may be seen to operate as hardware/software modules enabling IoT ad adaptation.

In an aspect of an embodiment of the present invention, elements of the contemplated invention identified as Environmental Analyzer [620], Renderer [634] may be seen to operate as calculations within Cloud Content Decisioning Platform [616].

In an aspect of an embodiment of the present invention, elements of the contemplated invention identified as Orchestration Layer [702], Tenant Containers [704 A-C], Common Platform Services [712], Isolation Controller [714], API Gateway [730] may be seen to operate as multi-tenant compute and security modules.

In an aspect of an embodiment of the present invention, elements of the contemplated invention identified as Customization Parameters [722-726], Audit Aggregator [734] may be seen to operate as sub-modules or artifacts that are configuration and log components.

In an aspect of an embodiment of the present invention, elements of the contemplated invention identified as Stream Processor [812], Pattern Engine [818], Risk Scoring [826], Auto-Blocking [832], Ledger [836] may be seen to operate as Pipeline modules for pre-spend fraud prevention.

In an aspect of an embodiment of the present invention, elements of the contemplated invention identified as ML Classifier [816], Pattern Analyzer [820] may be seen to operate as functional Computations inside Pattern Correlation Engine [818].

In an aspect of an embodiment of the present invention, elements of the contemplated invention identified as Signal Normalization [910], Computation Core [916], Threshold Comparator [930], Token Generator [934] may be seen to operate as modules which are central BQS computation units.

In an aspect of an embodiment of the present invention, elements of the contemplated invention identified as Unified Schema [912], Weighted Algorithms [918] may be seen to operate as sub-modules which are components of BQS Computation Core [916].

In an aspect of an embodiment of the present invention, elements of the contemplated invention identified as Enforcement Proxy [1002], Policy Engine [1016], Bid Enhancement Module [1024], Response Handler [1030] may be seen to operate as hardware/software enforcement modules.

In an aspect of an embodiment of the present invention, elements of the contemplated invention identified as Policy Decision Point [1016A] may be seen as a function which a decision logic within Policy Evaluation Engine [1016].

In an aspect of an embodiment of the present invention, elements of the contemplated invention identified as Qualification Engine [1212], Enforcement Proxy [1214], AI Decisioning System [1216], Optimization Engine [1226], Objective Function [1228], Stability [1230] may be seen as modules which enable unified BQS coordination across modules, all pre-spend.

In an aspect of an embodiment of the present invention, elements of the contemplated invention identified as Token Core [1302], KMS [1316], Validation Gateway [1324], Lifecycle Manager [1336] may be seen as cryptographic modules for attestation and token lifecycle.

In an aspect of an embodiment of the present invention, elements of the contemplated invention identified as Event Collector [1402], Storage Layer [1412], Rule Engine [1416], Report Generator [1424], Retention Manager [1430] may be seen as Persistent modules maintaining immutable audit chain.

In an aspect of an embodiment of the present invention, elements of the contemplated invention identified as Middleware Hub [1502], Qualification Engine [1504], Hybrid AI Layer [1506], Proxy Gateway [1508], Tenant Plane [1510], Unity Framework [1518], Token Svc [1538], Audit Backbone [1540] may be seen as elements that integrate components of the contemplated system.

In an aspect of an embodiment of the present invention, elements of the contemplated invention identified as Routing Middleware [1602], Complexity Assessor [1604], Decision Module [1632], Model Coordinator [1642] may be seen as Model-selection modules within the core of the contemplated system.

In an aspect of an embodiment of the present invention, elements of the contemplated invention identified as Session Tracker [1702], Gesture Capture [1712], Gaze Tracking [1716], Attribution Matrix [1724], Performance Calculator [1734], Visualization Engine [1740] may be seen as analytics subsystem modules which are part of pre-spend user analysis.

In an aspect of an embodiment of the present invention, elements of the contemplated invention identified as Token Ledger [1802], Tier Calculator [1808], Bid Processor [1814], Coefficient Optimizer [1824], Token Integration [1828] may be seen as Token-based loyalty modules, pre-spend scoring.

In an aspect of an embodiment of the present invention, elements of the contemplated invention identified as Tenant Layer [2002], Privacy Engine [2014], Anomaly Detector [2018], Federated Infra [2020], Attribution Cohorter [2030], Signal Aggregator [2042], Audit System [2052] may be seen as pre-spend tenant-management components.

Aspects of embodiments of the present invention contemplate the use of non-transitory computer programmable product and computer-implemented methods for the implementation of the different processes outlined above. The same may be found installed on any or all the components discussed in this application including, without limitation, mobile device(s), registries, platforms, systems, etc.

Yet further aspects of embodiments of the present invention contemplate execution of computer code resident on devices, system of devices, and communication media such as wide area networks, the internet etc. and/or structures enabling the contemplated functions.

Although this present invention has been disclosed with reference to specific forms and embodiments, it will be evident that a considerable number of variations may be made without departing from the spirit and scope of the present invention. For example, steps may be reversed, equivalent elements/components may be substituted for those specifically disclosed, certain features of the present invention may be used independently of other features, different aspects of embodiments of the invention may be used across other aspects and/or embodiments—all without departing from the present invention as outlined above, in the appended figures, invention disclosure(s), and the accompanying claims.

1. A behavioral qualification middleware system for pre-spend waste prevention in digital advertising comprising:
a middleware interception layer positioned between demand-side platforms and programmatic advertising exchanges;
a behavioral qualification score (BQS) computation engine communicatively coupled to said middleware interception layer, wherein said BQS computation engine comprises a signal aggregation module and a weighted scoring module;
a closed-loop reconciliation system communicatively coupled to said BQS computation engine, wherein said closed-loop reconciliation system comprises engagement beacons and a reconciliation processor; and
a BQS Unity Framework module communicatively coupled to both said BQS computation engine and said closed-loop reconciliation system, wherein said BQS Unity Framework module is configured to receive learning signals from said closed-loop reconciliation system.

2. The system of claim 1, wherein said weighted scoring module of said BQS computation engine computes a unified BQS value, wherein said computation comprises applying a linear weighted sum.

3. The system of claim 1, wherein said weighted scoring module of said BQS computation engine computes a unified BQS value, wherein said computation comprises applying a nonlinear transformation.

4. The system of claim 1, wherein said weighted scoring module of said BQS computation engine computes a BQS value as a weighted combination, wherein said weighted combination comprises at least two behavioral signal types selected from: user engagement (U), model efficiency (M), enforcement strictness (E), and content relevance (C).

5. The system of claim 1, wherein said signal aggregation module of said BQS computation engine receives user engagement data (U) from an avatar-driven personalization system, wherein said avatar-driven personalization system is configured to perform one or more of:
a. track user entity behaviors within virtual environments using avatar representations as privacy-compliant proxies,
b. select advertisement content based on behavioral patterns and qualification scores,
c. adapt content presentation in real-time based on user interactions and feed engagement metrics back via learning signals.

6. The system of claim 1, wherein said signal aggregation module of said BQS computation engine receives user engagement data (U) from a loyalty-based programmatic bidding system, wherein said loyalty-based programmatic bidding system is configured to perform one or more of:
a. user categorization into loyalty tiers based on historical engagement patterns,
b. application of tier-based multipliers to base bids using adjustment coefficients dynamically updated through performance feedback,
c. integration of BQS values with loyalty-adjusted bids,
d. generation of cryptographic audit trails for bid decisions.

7. The system of claim 1, wherein said signal aggregation module of said BQS computation engine receives model efficiency data (M) from a hybrid AI decisioning system, wherein said hybrid AI decisioning system is configured to perform one or more of:
a. evaluate request complexity through analysis of context depth, data volume, and latency budgets,
b. route requests to one or more of: small language model inference pipelines, large language model inference pipelines, hybrid decision modules based on complexity assessment against dynamic thresholds,
c. track processing times and trigger fallback mechanisms and normalize outputs from all inference pipelines.

8. The system of claim 1, wherein said signal aggregation module of said BQS computation engine receives enforcement strictness data (E) from a fraud detection system, wherein said fraud detection system is configured to perform one or more of:
a. aggregate bid streams, user interactions, device fingerprints, and network patterns,
b. perform real-time anomaly detection on incoming data streams against statistical baselines,
c. identify complex fraud patterns through pattern correlation across temporal, geographic, and behavioral dimensions,
d. compute fraud probability scores using ensemble models,
e. execute automated blocking actions to prevent fraudulent requests.

9. The system of claim 1, wherein said signal aggregation module of said BQS computation engine receives content relevance data (C) from a contextual sponsorship matching system, wherein said contextual sponsorship matching system is configured to perform one or more of:
a. processing real-time venue data from sensors, event feeds, and audience monitors,
b. computing contextual relevance scores identifying optimal activation moments,
c. cross-referencing contextual opportunities with audience profiles under privacy compliance,
d. adapting content format and controlling synchronized delivery across multiple displays,
e. capturing audience reactions,
f. generating performance metrics fed via learning signals.

10. The system of claim 1, wherein said signal aggregation module of said BQS computation engine receives content relevance data (C) from an IoT-driven environmental adaptation system wherein said IoT-driven environmental adaptation system is configured to perform one or more of:
a. collect environmental data from sensor arrays comprising weather sensors, traffic monitors, ambient light detectors, and audio level meters,
b. process aggregated sensor data to identify optimal content strategies,
c. match environmental conditions with content variants through visibility checks, audience checks, and adjacency checks,
d. adapt display properties including brightness and contrast.

11. The system of claim 1, wherein said signal aggregation module of said BQS computation engine receives content relevance data (C) from a conflict avoidance system, wherein said conflict avoidance system is configured to perform one or more of:
a. extracting sponsor entity information including advertiser, campaign, and exclusivity parameters,
b. performing multi-dimensional conflict checking across category conflicts, temporal exclusivity, and geographic restrictions,
c. applying hierarchical priority resolution rules considering contract terms, bid values, and qualification scores,
d. implementing blocking decision,
e. implementing authorization decisions,
f. generating activation tokens,
g. creating cryptographic logs of conflict detection decisions.

12. The system of claim 1, further comprising a multi-tenant isolation architecture, wherein said middleware interception system maintains cryptographic isolation between tenant environments within said multi-tenant isolation architecture and wherein said multi-tenant isolation architecture is configured to perform one or more of:
a. manage tenant containers with isolated data stores, configuration repositories, and custom rule engines,
b. enforce strict boundaries preventing cross-tenant data access,
c. ensure cryptographic namespace separation using tokens for tenant data isolation,
d. dynamically distribute computed resources based on tenant service level agreements,
e. maintain separate audit trails per tenant while enabling platform-wide optimization through anonymized patterns.

13. The system of claim 1, wherein said middleware interception layer comprises an enforcement proxy which operates as a transparent middleware layer between demand-side platforms and advertising exchanges, wherein said enforcement proxy comprises one or more of:
a. an enterprise token service providing cryptographically secure tokens using asymmetric encryption with identity claims, permission scopes, and temporal validity,
b. a key management system handling key rotation, revocation lists, and emergency recovery,
c. a token validation gateway validating tokens with microsecond latency,
d. a comprehensive audit system capturing activities from all platform modules, processing events through structured logging, storing records in immutable storage using hash-chain verification, evaluating operations against regulatory requirements, generating automated alerts when violations are detected, and enabling third-party auditors to verify record integrity.

14. The system of claim 1, wherein said system components maintain end-to-end processing latency below 200 milliseconds within a 99th percentile.

15. The system of claim 1, wherein said middleware interception layer implements comprehensive failure handling mechanisms to maintain service continuity.

16. The system of claim 1, wherein said closed-loop reconciliation system is configured to compute Qualified Attribution Scores (QAS) measuring actual engagement quality through weighted signal aggregation with time-based decay factors, wherein said QAS validate BQS prediction accuracy and inform generation of learning signals.

17. The system of claim 5, wherein said avatar-driven personalization system comprises one or more of:
a. a virtual environment rendering module displaying virtual venues and positioning avatars within a three-dimensional space,
b. avatar representations tracking user entities as privacy-compliant proxies,
c. a user entity profile store maintaining behavioral attributes built from aggregated signals,
d. a personalization engine processing user profiles and applying matching rules,
e. a dynamic content selector matching BQS values with content variants,
f. virtual display surfaces rendering selected content,
g. a real-time adaptation controller monitoring interactions and feeding engagement metrics back via learning signals.

18. The system of claim 6, wherein said loyalty-based programmatic bidding system comprises one or more of:
a. a loyalty tier determination module performing user categorization,
b. a user loyalty database storing engagement metrics and affinity scores,
c. tiered segments categorizing users into new users, regular users, and brand advocates,
d. a base bid calculator receiving initial bid values,
e. a loyalty adjustment engine applying tier-based multipliers using adjustment coefficients,
f. a BQS Unity Integration Module performing score combination,
g. a bid validation gateway performing compliance checks,
h. a programmatic auction interface handling bid submission with cryptographic audit trails.

19. The system of claim 7, wherein said hybrid AI decisioning system comprises one or more of:
a. a routing middleware controller receiving incoming requests and initiating complexity assessment,
b. a complexity assessment module comprising: a context depth analyzer, data volume calculator, and latency budget evaluator generating normalized complexity scores,
c. a gating threshold comparator evaluating complexity scores against dynamic thresholds based on system load metrics and historical accuracy patterns,
d. a latency monitor tracking processing times and comparing against service level agreement requirements,
e. a fallback controller migrating execution between models or utilizing cached decision paths,
f. a model coordination layer normalizing outputs using normalization transforms,
g. a coordination engine computing or updating BQS based on routing efficiency.

20. The system of claim 8, wherein said fraud detection system comprises one or more of:
a. a comprehensive data collection layer aggregating bid streams, user interactions, device fingerprints, and network patterns,
b. a real-time stream processor performing initial anomaly detection,
c. machine learning classifiers identifying fraud patterns through pattern correlation analyzing temporal patterns, geographic patterns, and behavioral consistency,
d. a risk scoring module computing fraud probability scores using ensemble models,
e. automated blocking actions executing through an enforcement proxy,
f. a cryptographic audit generator creating tamper-proof records stored in an immutable ledger with hash chain verification,
g. a cross-tenant anomaly detector identifying fraud patterns using differential privacy and federated learning.

21. The system of claim 9, wherein said contextual sponsorship matching system comprises one or more of:
a. an event context analyzer processing real-time venue data including venue sensors, game state feeds, and crowd sentiment monitors,
b. a contextual relevance score generator computing relevance scores using algorithms identifying optimal activation moments,
c. a user entity aggregator collecting attendee information incorporating demographics, behavioral patterns, and engagement histories under k-anonymity groupings,
d. a sponsor matching engine cross-referencing contextual opportunities with audience profiles,
e. a content adaptation module adjusting content format for venue display networks,
f. a synchronized delivery controller controlling coordinated content delivery,
g. an engagement tracking system capturing audience reactions and generating performance metrics.

22. The system of claim 10, wherein said IoT-driven environmental adaptation system comprises one or more of:
a. a digital-out-of-home (DOOH) display unit serving as primary content delivery mechanism,
b. an integrated sensor array comprising weather sensors, traffic monitors, ambient light detectors, and audio level meters,
c. a local edge processor running inference models for immediate environmental classification,
d. a cloud content decisioning platform coordinating multiple DOOH units,
e. a secure API gateway protecting communications using tokens,
f. an environmental analysis engine processing aggregated sensor data,
g. content selection rules defining adaptation parameters,
h. a creative asset repository storing content variants optimized for different conditions,
i. a dynamic content selector matching conditions with content variants,
j. a rendering engine adapting display properties,
k. performance logs recording display events to an audit system.

23. The system of claim 11, wherein said conflict avoidance system comprises one or more of:
a. a request intake node receiving placement requests,
b. a sponsor identification module extracting sponsor entity information,
c. an exclusivity rules database containing conflict matrices defining incompatible combinations, category exclusions, temporal windows, and geographic restrictions,
d. a conflict detection engine performing parallel multi-dimensional checking through category conflicts, temporal exclusivity, and geographic restrictions modules,
e. a priority resolution module applying hierarchical rules considering contract terms, bid values, and loyalty scores,
f. an enforcement gateway implementing blocking or authorization decisions and generating activation tokens,
g. an immutable audit ledger creating cryptographic logs,
h. a feedback mechanism updating exclusivity rules.

24. A computer-implemented method for operation of a behavioral qualification middleware system for pre-spend waste prevention in digital advertising comprising executing, on at least one processor configured to perform a predefined set of basic operations in response to receiving a corresponding basic computer executable instruction selected from a predefined native instruction set of codes, steps of:
computing a unified BQS value by a behavioral qualification score (BQS) computation engine;
enforcing pre-spend qualification, by an enforcement proxy;
reconciling predicted qualifications by a closed-loop reconciliation system; and
optimizing system-wide performance by a BQS Unity Framework, wherein said computer-implemented method prevents advertising waste through coordinated pre-spend qualification performed at a middleware interception layer positioned between demand-side platforms and advertising exchanges.

25. The computer-implemented method of claim 24, wherein computing said unified BQS value comprises applying a linear weighted sum.

26. The computer-implemented method of claim 24, wherein computing said unified BQS value comprises applying a nonlinear transformation selected from one or more of: sigmoid scaling, geometric mean.

27. The computer-implemented method of claim 24, wherein said BQS computation engine applies weighted scoring algorithms to compute said unified BQS values as a weighted combination, wherein said weighted combination comprises at least two behavioral signal types selected from: user engagement (U), model efficiency (M), enforcement strictness (E), and content relevance (C).

28. The computer-implemented method of claim 24, wherein said computation by said BQS computation engine comprises receiving behavioral signals from user engagement systems, wherein said step of receiving behavioral signals comprises one or more of:
a. processing signals from an avatar-driven personalization system by tracking user entity behaviors,
b. monitoring user interactions, adjusting display parameters, and
c. feeding interaction outcomes back via learning signals.

29. The computer-implemented method of claim 24, wherein said computation by said BQS computation engine comprises receiving behavioral signals from loyalty platforms, wherein said step of receiving behavioral signals from loyalty platforms comprises one or more of:
a. processing signals from a loyalty-based programmatic bidding system by performing user categorization,
b. applying tier-based multipliers, integrating BQS values with loyalty-adjusted bids, and
c. generating cryptographic audit trails.

30. The computer-implemented method of claim 24, wherein said computation by said BQS computation engine comprises receiving model efficiency data from hybrid AI decisioning systems, wherein said step of receiving efficiency data from hybrid AI decisioning systems comprises one or more of: evaluating request complexity, routing requests to inference pipelines, tracking processing times, normalizing outputs, and applying threshold adjustment algorithms.

31. The computer-implemented method of claim 24, wherein said computation by said BQS computation engine comprises receiving enforcement strictness data from fraud detection systems, wherein said step of receiving enforcement strictness data from said fraud detection systems comprises one or more of: aggregating data streams, performing real-time anomaly detection, identifying complex fraud patterns, computing fraud probability scores, executing automated blocking actions, and maintaining cross-tenant fraud detection.

32. The computer-implemented method of claim 24, wherein said computation by said BQS computation engine comprises receiving content relevance data from contextual matching systems, wherein said step of receiving content relevance data from contextual matching systems comprises one or more of: processing real-time venue data, computing contextual relevance scores, cross-referencing opportunities with audience profiles, adapting content format, and capturing audience reactions.

33. The computer-implemented method of claim 24, wherein said computation by said BQS computation engine comprises receiving content relevance data from IoT-driven adaptation systems, wherein said step of receiving content relevance data from IoT-driven adaptation systems comprises one or more of: collecting environmental data, running inference models, processing aggregated sensor data, matching conditions with content variants, and adapting display properties.

34. The computer-implemented method of claim 24, wherein said computation by said BQS computation engine comprises receiving content relevance data from conflict avoidance systems, wherein said step of receiving content relevance data from conflict avoidance systems comprises one or more of: extracting sponsor entity information, performing multi-dimensional conflict checking, applying priority resolution rules, implementing blocking or authorization decisions, and creating cryptographic logs.

35. The computer-implemented method of claim 24, further comprising maintaining multi-tenant isolation, wherein said step of maintaining multi-tenant isolation comprises one or more of: managing tenant containers, enforcing strict boundaries, ensuring cryptographic namespace separation, dynamically distributing compute resources, and maintaining separate audit trails.

36. The computer-implemented method of claim 24, wherein operation of said enforcement proxy comprises one or more of: generating immutable audit records through capturing activities, processing events through structured logging, storing records using hash-chain verification, evaluating operations against regulatory requirements, generating automated alerts, producing scheduled reports, and enabling third-party auditors to verify record integrity.

37. The computer-implemented method of claim 24, wherein all steps of said computer-implemented method maintain end-to-end latency below 200 milliseconds within a 99th percentile.

38. The computer-implemented method of claim 24, wherein operation of said middleware system comprises one or more of: implementing comprehensive failure handling through applying cached values when anomalies are detected, routing to pre-computed pathways when latency is breached, adjusting thresholds when unavailability occurs, maintaining values within operational ranges, applying dampening factors, and logging failure events.

39. A computer program product comprising a non-transitory computer readable medium having computer executable instructions stored therein for operation of a behavioral qualification middleware system for pre-spend waste prevention in digital advertising comprising executing, on at least one processor configured to perform a predefined set of basic operations in response to receiving a corresponding basic computer executable instruction selected from a predefined native instruction set of codes, computer readable program code for:
computing a unified BQS value by a behavioral qualification score (BQS) computation engine;
enforcing pre-spend qualification, by an enforcement proxy;
reconciling predicted qualifications by a closed-loop reconciliation system; and
optimizing system-wide performance by a BQS Unity Framework, wherein said computer-implemented method prevents advertising waste through coordinated pre-spend qualification performed at a middleware interception layer positioned between demand-side platforms and advertising exchanges.

40. The computer program product of claim 39, wherein said computer readable program code for computing said unified BQS value comprises computer readable code for applying a linear weighted sum.

41. The computer program product of claim 39, wherein said computer readable program code for computing said unified BQS value comprises computer readable code for applying a nonlinear transformation selected from one or more of: sigmoid scaling, geometric mean.

42. The computer program product of claim 39, wherein said computer readable code for computing said unified BQS values comprises computer readable code for applying weighted scoring algorithms to compute said unified BQS values as a weighted combination, wherein said weighted combination comprises at least two behavioral signal types selected from: user engagement (U), model efficiency (M), enforcement strictness (E), and content relevance (C).

43. The computer program product of claim 39, wherein said computer readable code for computation by said BQS computation engine comprises computer readable code for receiving behavioral signals from user engagement systems, wherein said computer readable code for receiving behavioral signals comprises computer readable code for one or more of:
a. processing signals from an avatar-driven personalization system by tracking user entity behaviors,
b. monitoring user interactions, adjusting display parameters, and
c. feeding interaction outcomes back via learning signals.

44. The computer program product of claim 39, wherein said computer readable code for computation by said BQS computation engine comprises computer readable code for receiving behavioral signals from loyalty platforms, wherein said computer readable code for receiving behavioral signals from loyalty platforms comprises computer readable code for one or more of:
a. processing signals from a loyalty-based programmatic bidding system by performing user categorization,
b. applying tier-based multipliers, integrating BQS values with loyalty-adjusted bids, and
c. generating cryptographic audit trails.

45. The computer program product of claim 39, wherein said computer readable code for computation by said BQS computation engine comprises computer readable code for receiving model efficiency data from hybrid AI decisioning systems, wherein said computer readable code for receiving efficiency data from hybrid AI decisioning systems comprises computer readable code for one or more of: evaluating request complexity, routing requests to inference pipelines, tracking processing times, normalizing outputs, and applying threshold adjustment algorithms.

46. The computer program product of claim 39, wherein said computer readable code for computation by said BQS computation engine comprises computer readable code for receiving enforcement strictness data from fraud detection systems, wherein said computer readable code for receiving enforcement strictness data from said fraud detection systems comprises computer readable code for one or more of: aggregating data streams, performing real-time anomaly detection, identifying complex fraud patterns, computing fraud probability scores, executing automated blocking actions, and maintaining cross-tenant fraud detection.

47. The computer program product of claim 39, wherein said computer readable code for computation by said BQS computation engine comprises computer readable code for receiving content relevance data from contextual matching systems, wherein said computer readable code for receiving content relevance data from contextual matching systems comprises computer readable code for one or more of: processing real-time venue data, computing contextual relevance scores, cross-referencing opportunities with audience profiles, adapting content format, and capturing audience reactions.

48. The computer program product of claim 39, wherein said computer readable code for computation by said BQS computation engine comprises computer readable code for receiving content relevance data from IoT-driven adaptation systems, wherein said computer readable code for receiving content relevance data from IoT-driven adaptation systems comprises computer readable code for one or more of: collecting environmental data, running inference models, processing aggregated sensor data, matching conditions with content variants, and adapting display properties.

49. The computer program product of claim 39, wherein said computer readable code for computation by said BQS computation engine comprises computer readable code for receiving content relevance data from conflict avoidance systems, wherein said computer readable code for receiving content relevance data from conflict avoidance systems comprises computer readable code for one or more of: extracting sponsor entity information, performing multi-dimensional conflict checking, applying priority resolution rules, implementing blocking or authorization decisions, and creating cryptographic logs.

50. The computer program product of claim 39, further comprising computer readable code for maintaining multi-tenant isolation, wherein said computer readable code for maintaining multi-tenant isolation comprises computer readable code for one or more of: managing tenant containers, enforcing strict boundaries, ensuring cryptographic namespace separation, dynamically distributing compute resources, and maintaining separate audit trails.

51. The computer program product of claim 39, wherein computer readable code for operation of said enforcement proxy comprises computer readable code for one or more of: generating immutable audit records through capturing activities, processing events through structured logging, storing records using hash-chain verification, evaluating operations against regulatory requirements, generating automated alerts, producing scheduled reports, and enabling third-party auditors to verify record integrity.

52. The computer program product of claim 39, wherein all computer readable code for said computer program product comprise computer readable code for maintaining end-to-end latency below 200 milliseconds within a 99th percentile.

53. The computer program product of claim 39, wherein computer readable code for operation of said middleware system comprises computer readable code for one or more of: implementing comprehensive failure handling through applying cached values when anomalies are detected, routing to pre-computed pathways when latency is breached, adjusting thresholds when unavailability occurs, maintaining values within operational ranges, applying dampening factors, and logging failure events.

54. An advertising middleware apparatus comprising:
a processor;
a memory coupled to said processor;
a BQS computation module stored in said memory and executable by said processor to perform one or more of:
receive behavioral signals from one or more of: user engagement systems, loyalty platforms, hybrid AI decisioning systems, fraud detection systems, contextual matching systems, IoT-driven adaptation systems, and conflict avoidance systems;
compute unified behavioral qualification scores as a weighted combination employing adaptive weighting coefficients assigned to each signal type comprising user engagement (U), model efficiency (M), enforcement strictness (E), and content relevance (C), wherein said coefficients are constrained to sum to a normalized total;
normalize each input signal to a bounded range;
store computed scores in a distributed cache;
an enforcement module stored in said memory and executable by said processor to perform one or more of:
intercept bid requests between demand-side platforms and advertising exchanges;
retrieve pre-computed BQS values;
apply BQS threshold policies;
block unqualified requests before auction submission;
enhance qualified bid values proportional to BQS strength;
generate cryptographically signed authorization tokens;
a reconciliation module stored in said memory and executable by said processor to perform one or more of:
receive post-engagement data from beacons deployed across advertising channels;
compare actual engagement outcomes with predicted BQS values;
compute deviation metrics;
generate learning signals;
a BQS Unity Framework module stored in said memory and executable by said processor to:
receive learning signals from said reconciliation module;
adjust said weighting coefficients associated with each signal type (U, M, E, C);
propagate updated coefficients to said BQS computation module and all subsystems;
maintain convergent optimization through boundary condition enforcement.

55. The apparatus of claim 54, wherein said processor comprises multiple processing cores enabling parallel processing of one or more of: BQS computation inputs, concurrent enforcement policy evaluation, simultaneous reconciliation processing, and coordinated coefficient optimization.

56. The apparatus of claim 54, wherein said memory includes a high-speed cache layer optimized for BQS value storage and retrieval comprising: in-memory BQS caches, distributed BQS cache clusters, persistent BQS storage, and multi-tier cache hierarchies.

57. The apparatus of claim 54, further comprising a hardware security module coupled to said processor for performing one or more of: generating cryptographically signed authorization tokens, implementing key management with automated key rotation, providing token validation, enabling cross-system federation, and creating tamper-proof audit records.

58. The apparatus of claim 54, further comprising a network interface configured to perform one or more of: intercept bidstream traffic, protect communications using secure API gateways, coordinate distributed processing across availability zones, enable automatic failover, and support service mesh technology.

59. The apparatus of claim 54, further comprising an audit module stored in said memory and executable by said processor to perform one or more of: capture activities, process raw events through structured logging, store records in immutable storage, evaluate operations against regulatory requirements, generate automated alerts, produce scheduled reports, and enable third-party auditors to verify record integrity.

60. The apparatus of claim 54, wherein said enforcement module implements multi-tenant isolation through one or more of: cryptographic namespace separation, tenant isolation controllers, resource allocation managers, audit aggregation systems, and cross-tenant analytics.

61. A pre-spend advertising qualification middleware system comprising:
a behavioral qualification score (BQS) computation engine configured to perform one or more of:
receiving behavioral signals from multiple sources including at least user engagement data, model processing efficiency data, enforcement policy data, and contextual relevance data;
computing a unified BQS value as a weighted combination of the received behavioral signals with adaptive weighting coefficients that sum to unity;
normalizing each behavioral signal to a bounded numerical range;
storing computed BQS values in a distributed cache; and
an enforcement proxy middleware layer configured to perform one or more of:
intercepting bid requests at a middleware interception point positioned between demand-side platforms and programmatic advertising exchanges;
operating transparently to both demand-side platforms and advertising exchanges maintaining compatibility with existing programmatic infrastructure;
retrieving pre-computed BQS values associated with intercepted bid requests;
applying configurable qualification policies incorporating BQS threshold requirements, fraud risk signals, brand safety requirements, and sponsor conflict checks;
blocking bid requests that fail to meet qualification criteria before auction submission;
enhancing qualified bid values proportionally to BQS qualification strength;
generating cryptographically signed authorization tokens for qualified bid requests, wherein said enforcement proxy middleware layer prevents advertising waste through pre-spend qualification at a unified interception point before budget commitment.
